(19) United States
(12) Patent Application Publication
(10) Pub. No.: US 2026/0042224 A1
(43) Pub. Date: Feb. 12, 2026

(54) HEAD AND NECK ASSEMBLY FOR OF A HUMANOID ROBOT

(71) Applicant: Figure AI Inc., San Jose, CA (US)

(72) Inventors: Keyvan Yeganeh, San Jose, CA (US); Julien Lambert, San Jose, CA (US); Hao Wu, San Jose, CA (US); David McCall, San Jose, CA (US); Sydney Hardy, San Jose, CA (US)

(21) Appl. No.: 19/356,029

(22) Filed: Oct. 10, 2025

Related U.S. Application Data
(63) Continuation of application No. 18/919,263, filed on Oct. 17, 2024, now Pat. No. 12,365,094.
Application No. 18/919,263 is a continuation-in-part of application No. 18/914,800, filed on Oct. 14, 2024.
Application No. 18/914,800 is a continuation-in-part of application No. 18/904,332, filed on Oct. 2, 2024.
Application No. 18/919,263 is a continuation-in-part of application No. 29/935,680, filed on Apr. 3, 2024.
Application No. 29/935,680 is a continuation-in-part of application No. 29/928,748, filed on Feb. 15, 2024.
Application No. 29/928,748 is a continuation-in-part of application No. 29/889,764, filed on Apr. 17, 2023.
(60) Provisional application No. 63/626,030, filed on Feb. 21, 2024.
(60) Provisional application No. 63/626,035, filed on Feb. 27, 2024.
(60) Provisional application No. 63/626,028, filed on Feb. 27, 2024.
(60) Provisional application No. 63/561,316, filed on Mar. 5, 2024.
(60) Provisional application No. 63/564,741, filed on Mar. 13, 2024.
(60) Provisional application No. 63/626,034, filed on Mar. 13, 2024.
(60) Provisional application No. 63/566,595, filed on Mar. 18, 2024.
(60) Provisional application No. 63/573,226, filed on Apr. 2, 2024.
(60) Provisional application No. 63/573,528, filed on Apr. 3, 2024.
(60) Provisional application No. 63/634,697, filed on Apr. 16, 2024.
(60) Provisional application No. 63/626,037, filed on May 28, 2024.
(60) Provisional application No. 63/707,547, filed on Oct. 15, 2024.
(60) Provisional application No. 63/707,949, filed on Oct. 16, 2024.
(60) Provisional application No. 63/707,897, filed on Oct. 16, 2024.
(60) Provisional application No. 63/708,003, filed on Oct. 16, 2024.

(51) Int. Cl. B25J 11/00; B25J 9/00; B25J 19/00

(52) U.S. Cl. CPC B25J 11/0015; B25J 9/0009; B25J 19/00

(57) ABSTRACT

The disclosure presents a humanoid robot comprising an upper region (head, torso, arms with forearm assemblies, and end effectors), a lower region (legs), and a connecting central region. Each end effector features index, middle, ring, little finger, and thumb assemblies attached to a housing of said end effector. The housing includes interior wall extents that create spaces for tendon routing, where the first distance between the first and second wall extents is less than 45% of the second distance between the third and fourth wall extents. Tendons controlling finger movements pass between these wall extents. The robot incorporates a wrist assembly connecting the housing of the end effector to the forearm, actuators housed in the forearm that control the tendons, and a carpal tunnel-like structure that guides tendons from the forearm to the base of the housing, enabling precise hand movements without requiring actuators in the hand itself.

### CROSS-REFERENCE TO RELATED APPLICATIONS

This application is: (i) a continuation in part of U.S. patent application Ser. No. 18/914,800, filed Oct. 14, 2024, which is a continuation in part of U.S. patent application Ser. No. 18/904,332, filed Oct. 2, 2024, (ii) a continuation in part of U.S. Design patent application Ser. No. 29/935,680, filed Apr. 3, 2024, which is a continuation in part of U.S. Design patent application Ser. No. 29/928,748, filed Feb. 15, 2024, which is a continuation in part of U.S. Design patent application Ser. No. 29/889,764, filed Apr. 17, 2023, and (iii) claims priority under 35 U.S.C. § 119 (e) to U.S. Provisional Patent Application No. 63/626,035, filed Feb. 27, 2024, U.S. Provisional Patent Application No. 63/564,741, filed Mar. 13, 2024, U.S. Provisional Patent Application No. 63/626,034, filed Mar. 13, 2024, and U.S. Provisional Patent Application No. 63/626,037, filed May 28, 2024, U.S. Provisional Patent Application No. 63/626,030, filed Feb. 21, 2024, U.S. Provisional Patent Application No. 63/566,595, filed Mar. 18, 2024, U.S. Provisional Patent Application No. 63/626,028, filed Feb. 27, 2024, U.S. Provisional Patent Application No. 63/573,528, filed Apr. 3, 2024, U.S. Provisional Patent Application No. 63/561,316, filed Mar. 5, 2024, U.S. Provisional Patent Application No. 63/634,697, filed Apr. 16, 2024, U.S. Provisional Patent Application No. 63/573,226, filed Apr. 2, 2024, U.S. Provisional Patent Application No. 63/707,949, filed Oct. 16, 2024, U.S. Provisional Patent Application No. 63/707,897, filed Oct. 16, 2024, U.S. Provisional Patent Application No. 63/707,547, filed Oct. 16, 2024, U.S. Provisional Patent Application No. 63/708,003, filed Oct. 16, 2024, each of which is expressly incorporated by reference herein in its entirety.

### TECHNICAL FIELD

This disclosure relates to a head of a robot, specifically to a head for a humanoid robot.

### BACKGROUND

Humanoid robots are increasingly being developed for a wide range of applications, from industrial automation to personal assistance. For a humanoid robot to function effectively and safely, particularly in environments shared with humans, it must be able to perceive its surroundings, navigate complex spaces, and communicate its status and intent. The head assembly of a humanoid robot is a critical component, as it typically houses the primary sensor suites for perception, displays for human-robot interaction, and antennas for wireless communication. However, designing a head for a functional, general-purpose humanoid robot presents significant challenges that are not addressed by conventional robotic systems. Existing designs often suffer from several limitations. For instance, the placement and configuration of sensors on many robots can result in significant blind spots, limiting the robot's situational awareness and its ability to perform tasks that require a comprehensive field of view, such as navigating cluttered spaces or monitoring its own limb positions. Furthermore, human-robot interaction remains a key challenge. Some robotic heads are purely functional and lack effective means to communicate status to nearby humans, making collaboration difficult and potentially unsafe. Other designs attempt to mimic human facial features to convey information, but these can be mechanically complex, prone to damage, and may create an unsettling appearance for human observers. There is a need for a design that can clearly convey information, such as operational status, battery life, or current tasks, without resorting to overly anthropomorphic features.

Durability is another major concern, especially for robots intended for industrial or commercial use. Designs that integrate displays and sensors directly into the exterior surface without adequate protection are vulnerable to impact. Damage to these integrated components can be costly and time-consuming to repair, leading to significant operational downtime. A more robust and modular design is needed where critical components are protected and easily replaceable. Finally, reliable, high-bandwidth connectivity is essential for modern robots, which may rely on remote processing or communication with other systems. Integrating multiple antennas for technologies like 5G and Wi-Fi into a compact head assembly without causing signal interference or compromising the robot's aesthetic and functional design is a non-trivial engineering problem. Therefore, there is a need for an improved head and neck assembly for a humanoid robot that overcomes these limitations by providing comprehensive sensor coverage, clear and intuitive communication methods, enhanced durability for real-world applications, and robust wireless connectivity, all integrated into a cohesive, anthropomorphic form.

### SUMMARY

The presently disclosed subject matter is directed to a robot having a transverse plane and a sagittal plane. The robot comprises an upper region including: (i) a torso, (ii) a pair of arm assemblies coupled to the torso, wherein each arm assembly includes an end effector, and (iii) a head and neck assembly coupled to the torso and having a neck portion and a head portion coupled to the neck portion. While the upper region of the robot is in a neutral state and the head portion is in a forward-facing orientation, the head portion includes a head housing with a front shell, wherein the front shell includes an outer surface. The head portion includes a forward-facing display positioned within the head housing behind the front shell. The head portion includes a first sensor positioned above the display, wherein the first sensor includes: (i) a first extent positioned rearward of the outer surface of the front shell, and (ii) a first lens. The head portion includes a second sensor positioned below the display, wherein the second sensor includes: (i) a second extent positioned rearward of the outer surface of the front shell, and (ii) a second lens. The first lens and the second lens are aligned along the sagittal plane.

In some embodiments, the head portion further includes an electronics frame to which at least one sensor of a group consisting of the first sensor and the second sensor is mounted, wherein the electronics frame includes a respective front portion and a respective rear portion. The head portion includes a lower support frame distinct from the electronics frame and including: (i) a respective front portion, (ii) a respective rear portion, and (iii) an extent forming an external surface of the head portion on a lateral side of the head. The front portion of the lower support frame is arranged below the front portion of the electronics frame and the rear portion of the lower support frame is arranged below the rear portion of the electronics frame, and wherein the extent of the lower support frame includes a recessed portion.

The presently disclosed subject matter is directed to a robot having a transverse plane, a coronal plane, and a sagittal plane. The robot comprises an upper region including: (i) a torso, (ii) a pair of arm assemblies coupled to the torso, wherein each arm assembly includes an end effector, and (iii) a head and neck assembly coupled to the torso and having a neck portion and a head portion coupled to the neck portion. While the upper region of the robot is in a neutral state and the head portion is in a forward-facing orientation, the head portion includes a head housing with a front shell wherein the front shell includes an outer surface. The head portion includes a front display visible from a front viewing position that is along the sagittal plane forward of the robot and at a height corresponding to the front display, wherein the front display is positioned within the head housing and rearward of an extent of the front shell. The head portion includes a first sensor positioned above the first display and at least partially within the head housing. The head portion includes a left side display visible from a left-side viewing position that is along the coronal plane leftward of the robot and at a height corresponding to the left side display, wherein the left side display is positioned at least partially within the head housing. The head portion includes a right side display visible from a right-side viewing position that is along the coronal plane rightward of the robot and at a height corresponding to the right side display, wherein the right side display is positioned at least partially within the head housing.

The presently disclosed subject matter is directed to a robot having a transverse plane and a sagittal plane. The robot comprises an upper region including: (i) a torso, (ii) a pair of arm assemblies coupled to the torso, wherein each arm assembly includes an end effector, and (iii) a head and neck assembly coupled to the torso and having a neck portion and a head portion coupled to the neck portion. While the upper region of the robot is in a neutral state and the head portion is in a forward-facing orientation, the head and neck portion includes a front shell that includes a portion with a curvilinear exterior surface. The head and neck portion includes a first forward-facing sensor including: (i) a respective extent positioned within the head portion, and (ii) a respective sensor axis oriented at a non-zero angle to a first horizontal plane parallel to the transverse plane. The head and neck portion includes a rearward-facing sensor including: (i) a respective extent positioned within the head and neck assembly, and (ii) a respective sensor axis oriented at a non-zero angle to a second horizontal plane parallel to the transverse plane. The respective sensor axis of the first forward-facing sensor extends forward through the curvilinear exterior surface of the front shell portion, and the respective sensor axis of the rearward-facing sensor extends rearward and the rearward extension of the respective sensor axis of the rearward-facing sensor does not extend through the front shell.

In some embodiments, the head and neck portion further includes a second forward-facing sensor including: (i) a respective extent positioned within the head portion, and (ii) a respective sensor axis oriented at a non-zero angle to a third horizontal plane parallel to the transverse plane, wherein the respective sensor axis of the first forward-facing sensor extends forward and downward and the respective sensor axis of the second forward-facing sensor extends forward and downward.

The presently disclosed subject matter is directed to a head for a humanoid robot. The head comprises a housing having a frontal shield and a support frame, the frontal shield being formed as a separate piece from displays positioned behind the frontal shield and extending from a chin region to a parietal region of the head. The head comprises an electronics assembly positioned within the housing and including a display assembly having a front display with a curved display surface that is curved in at least one direction and positioned at an angle relative to a sagittal plane, and a sensor assembly having a plurality of cameras including an upper camera, a lower camera, and a rear camera that are vertically aligned in the sagittal plane when the head is in an upright position. The head comprises an internal support assembly configured to mount the electronics assembly within the housing, the internal support assembly including an electronics mount having a plurality of display openings and a plurality of sensor openings.

The presently disclosed subject matter is directed to a method of manufacturing a head for a humanoid robot. The method comprises injection molding a housing component using polycarbonate resin at a temperature of 280-320° C. under pressure of 70-140 MPa. The method comprises overmolding a frontal shield onto the housing component using acrylic resin at a temperature of 200-300° C. under pressure of 50-100 MPa to form a protective shield that is separate from displays to be positioned behind the shield. The method comprises polishing the frontal shield using a multi-axis robotic arm with progressively finer abrasive materials including a coarse polishing stage with 400-600 grit particles, an intermediate polishing stage with 800-1200 grit particles, and a fine polishing stage with 1500-2000 grit particles.

In some embodiments, the robot's head portion features a front shell with first and second forward-facing apertures aligned with first and second lenses, respectively. This front shell can be partially overmolded onto an internal electronics frame, which underlies less than the entirety of the shell. This electronics frame serves as a mounting point for various components, including the first and second sensors, which are not mounted to a common printed circuit board or directly to the front shell itself. The frame is arranged to obscure a majority of these sensors from external view. In other embodiments, the assembly includes a separate lower support frame that forms an external surface with an air intake vent, used by a heat management system to draw air into the head's interior. A frontal shield, made from a transparent material with a substantially uniform thickness of at least 1 mm and a dioptric power of less than 0.25 diopters, may also be present. Manufacturing methods for this shield can include injection molding with specific mold temperatures (80-120° C.) and conformal cooling, plasma treatment to enhance bonding during overmolding, and the application of optical coatings like anti-reflective or scratch-resistant layers.

The head and neck portion integrates a variety of sensors and displays. In addition to the forward-facing sensors, some embodiments include a top sensor oriented in an upward-facing direction, side sensors on the lateral sides, and a rearward-facing sensor which may be identical to the forward-facing one. The display assembly may comprise a curvilinear front display and planar left and right-side displays. These side displays can be arranged symmetrically but not parallel to the sagittal plane, with a majority of their surface positioned higher than the front display. While the front display and first sensor may be coupled to the electronics frame, the side displays may not be. The electronics mount itself can be modular, with a main section for front-facing components and separate housings for side displays and sensors.

In other embodiments, various components are integrated for communication and user interaction. A plurality of antennas, including a potential curvilinear antenna mounted to the electronics frame, are obscured from external view and are not directly coupled to an inner surface of the head housing. Indicator lights may be positioned in a recessed portion, such as the auricular region or on a lateral side below a sensor, to visually indicate robot status. Furthermore, a speaker may be included in the head and neck portion, and a side-facing display can be positioned inwards from an adjacent outer surface of the front shell.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 2-3A and the corresponding rotational axes of said actuators;

FIG. 4 is a block diagram of sensors for the humanoid robot of FIGS. 2-3B;

FIG. 5 is a block diagram of a communication interface for the humanoid robot of FIGS. 2-3B;

FIG. 6 is a first perspective view of the head and neck assembly of the robot of FIGS. 1-2 showing the head and neck assembly having: (i) a neck portion and (ii) a head portion;

FIG. 7 is a second perspective view of the head of FIG. 6;

FIG. 8 is a front view of the head and neck assembly of FIG. 6, which shows the head electronics assembly includes an upper/front camera, a lower/chin camera, and a frontal display;

FIG. 9 is a rear view of the head and neck assembly of FIG. 6, which shows the head electronics assembly includes a rear camera;

FIG. 10 is a left side view of the head and neck assembly of FIG. 6, which shows the head electronics assembly includes a side camera and a side display;

FIG. 11 is a right-side view of the head and neck assembly of FIG. 6, wherein regions of a human head have been superimposed over the head of the robot;

FIG. 12 is a top view of the head and neck assembly of FIG. 6, which shows the head electronics assembly includes a top camera;

FIG. 13 is a perspective view of the head portion included in the head and neck assembly of FIG. 6, wherein the housing is substantially transparent to show that the head electronics assembly includes: (i) a sensor assembly that includes the upper/front, lower/chin, top and rear cameras, (ii) a display assembly that includes a frontal display, and left and right displays, (iii) an antenna assembly, (iv) indicator lights, (v) a PCB and associated electronics, and (vi) other electronics;

FIG. 14 is a left side view of the head of FIG. 13;

FIG. 15 is a top view of the head of FIG. 13;

FIG. 16 is an exploded view of the head of FIG. 13;

FIG. 17 is a cross-sectional view of the head and neck assembly taken along line 17-17 of FIG. 8;

FIG. 18 is a cross-sectional view of the head and neck assembly taken along line 18-18 of FIG. 10;

FIG. 19 is a left side view of the head portion included in the head and neck assembly of FIG. 6, which shows the head includes (i) a housing, (ii) an internal support assembly, and (iii) an electronics assembly;

FIG. 20 is a side view of the electronics mount included in the head of FIG. 19;

FIG. 21 is a side view of the electronics mount of FIG. 20;

FIG. 22 is a perspective view of the shell included in the head of FIG. 19;

FIG. 23 is a side view of the shell of FIG. 22;

FIG. 24 is a side view of the support frame included in the head of FIG. 19;

FIG. 25 is a cross-sectional view of the support frame taken along line 25-25 of FIG. 24;

FIG. 26 is a zoomed-in view of the support frame of FIG. 25;

FIG. 27 is a perspective view of the support frame of FIG. 24;

FIG. 28 is a front view of the support frame of FIG. 24;

FIG. 29 is a perspective view of a display assembly included in the electronic assembly of the head and neck assembly of FIG. 6, wherein said display assembly includes a front display, a left side display, and a right side display;

FIG. 30 is a front view of the display assembly of FIG. 29;

FIG. 31 is a bottom view of the display assembly of FIG. 29;

FIG. 32 is a side view of the display assembly of FIG. 29;

FIG. 33 is a top view of the display assembly of FIG. 29;

FIG. 34 is a top perspective view of a majority of a sensor assembly and a PCB included in the electronics assembly of the head and neck assembly of FIG. 6, wherein said sensor assembly includes a plurality of cameras having (i) an upper/front camera, (ii) a lower/chin camera, (iii) a left side camera, (iv) a right side camera, (v) a top camera, and (vi) a rear camera;

FIG. 35 is a perspective view of the plurality of cameras included in the sensor assembly of FIG. 34;

FIG. 36 is a side view of the plurality of cameras of FIG. 35;

FIG. 37 is a perspective view of one of the cameras included in the plurality of cameras of FIG. 35;

FIG. 38 is a front view of the plurality of cameras of FIG. 35;

FIG. 39A-39B are top view of the robot of FIGS. 1-2 showing the fields of view of the cameras included in the plurality of cameras of FIG. 35;

FIG. 40 is a perspective view of the robot of FIGS. 1-2 showing the blind spots of the cameras included in the plurality of cameras of FIG. 35;

FIG. 41 is a perspective view of an antenna assembly and the PCB included in the electronics assembly of the head and neck assembly of FIG. 6, wherein said antenna assembly includes a plurality of antennas;

FIG. 42 is a perspective view of the head and neck assembly of FIG. 6, wherein a portion of the head portion has been made transparent to show the positions of the antennas included in the antenna assembly;

FIG. 43 is a front view of the head and neck assembly of FIG. 42;

FIG. 44 is a side view of the head and neck assembly of FIG. 42;

FIG. 45 is a side view of another embodiment of a head portion included in the robot of FIGS. 1-2 showing display housings of the side screens form a part of the curved surface to resemble a human head;

FIG. 46 is a front view of the head portion of FIG. 45;

FIG. 47 is a rear view of the head portion of FIG. 45;

FIG. 48 is a bottom view of the head portion of FIG. 45;

FIG. 49 is a cross-sectional view of the head portion taken along line 49-49 of FIG. 48;

FIG. 50 is a cross-sectional view of the head portion taken along line 50-50 of FIG. 46;

FIG. 51 is a side view of the head portion of FIG. 45;

FIG. 52 is a perspective view of the head portion included in the head and neck assembly of FIG. 6, wherein the housing is substantially transparent to show that the head electronics assembly includes: (i) a sensor assembly that includes the upper/front, lower/chin, top and rear cameras, (ii) a display assembly that includes a frontal display, and left and right displays, (iii) an antenna assembly, (iv) indicator lights, (v) a PCB and associated electronics, and (vi) other electronics;

FIG. 53 is a left side view of the head of FIG. 52; and

FIG. 54 is a top view of the head of FIG. 52.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

The disclosed humanoid robot 1 includes a head and neck assembly coupled to a torso and having an overall shape that generally resembles a human head. The head and neck assembly includes a head portion that does not include large flat surfaces (e.g., opposed sides of a head 10.1, or is not in the shape of: (a) cube, (b) hexagonal prism, or (c) pentagonal prism). Instead, almost all the surfaces of the head are curvilinear or have substantial curvilinear aspects or segments. While the overall head shape is designed to resemble a human head 10.1, the disclosed head lacks pronounced human facial structures (cheeks, eye peripheral protrusions, a mouth, or other moving structures).

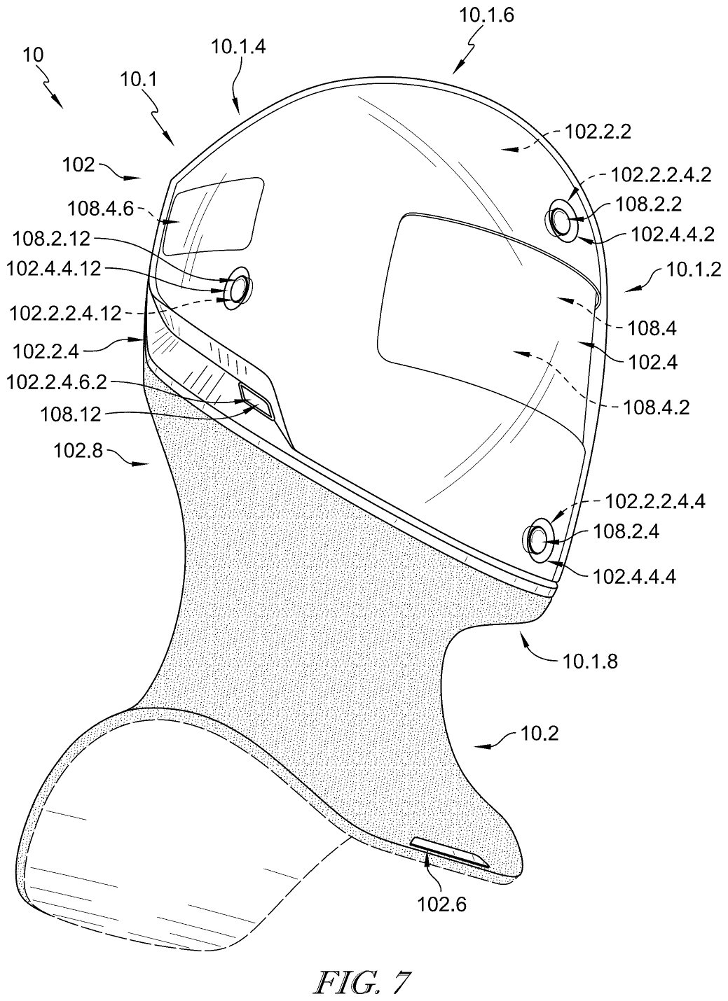

The frontal and crown regions of the head are covered by a large freeform shell or shield wherein the curvature of the shell varies horizontally and laterally across the head. The freeform nature, size, and construction of the head allows the shell to be formed as a separate and distinct piece from the displays that are positioned behind the shell. This positional relationship allows the shell to protect the display and electronics contained in the head from damage, which provides a substantial benefit over conventional robot heads that lack this feature. For example, certain tasks (e.g., moving and cutting sheet metal) that the robot may perform on the factory floor may damage or break a display that is not protected behind a shell. Additionally, a damaged shell may be cheaper and easier to replace than a damaged display. As shown in the Figures (e.g., FIG. 7), the shell: (i) extends rearward of the auricular region 10F, and into the occipital region 10E, (ii) extends to the chin region 10M, and (iii) does not extend below a jaw line. In other words, the shell does not stop short or before the auricular region 10F and does not contain an outer perimeter that contains multiple recesses designed to receive an extent of the electronics assembly (e.g., light emitters).

Unlike conventional robot heads, the disclosed head includes a main or primary display that is curved in at least one direction and is positioned on an angle relative to the transverse plane or a horizontal reference plane. The curved nature of the main display allows for the inclusion of a larger display with a larger surface area within the head 10.1, which increases the amount of information that can be shown on the main display. The larger main display provides a benefit over conventional robot heads that lack this feature because those conventional robots must either forgo displaying as much information (while not altering the size of the information) or increase the size of their head (which causes a number of other issues, including increased material costs and assembly costs). The main display may be configured to display robot status, sensor data, and/or other relevant information to nearby human beings. However, the main display is not configured to display human-like facial features (eyes, nose, mouth, etc.) or expressions, but instead is designed to use generic blocks or shapes. In addition to the main display, the head portion also includes two displays that are positioned on the sides of the robot head. Said side displays can be configured to show indicia that are indicative of the robot's number, battery life, current task, current state, etc.

The electronics assembly of the disclosed head portion may include an illumination assembly having at least one light emitter, and preferably a plurality of light emitting assemblies are positioned adjacent to a lower edge of the shell. The light emitters enable the robot 1 to communicate with humans without using the main display or the side displays that are disposed behind the shell, wherein said light emitters act as or are configured to act as an indicator light. Typically, the light emitters (and in this configuration, indicator lights) can communicate information about the humanoid robot 1 to nearby humans by: (i) emitting light having different wavelengths, wherein said emitted light may be perceived by a nearby human as having different color light, and/or (ii) utilize illumination sequences, durations, and/or brightness. For example, the indicator lights may be used to communicate the working state (e.g., yellow-600 nm), idle state (e.g., green-550 nm), charging state (e.g., blinking or white), error state (e.g., red-665 nm), thinking (e.g., blue-470 nm), or other general states. This is beneficial because it can limit the information that needs to be shown on the displays. Also, the light emitters use less battery power than the displays and may be able to relay information more quickly to the human, robot, or machine. Alternatively, the indicator lights can signal an operator to immediately take note of a more complex condition or information that is comprehensively shown on the display to ensure that an operator properly assesses that complex condition or information for the humanoid robot 1. It should be understood that in other embodiments, illumination assembly may: (i) emit a light that surrounds the periphery of the shell, (ii) emit a light that surrounds the rear edge of the shell, (iii) include one or more emitter positioned in other robot parts (e.g., torso, knee, leg, arm, hand etc.)

Unlike conventional robot heads, the disclosed head includes a plurality of sensors to provide a fuller field of view of the environment surrounding the robot and help minimize blind spots. The first sensor is positioned within the robot's lower frontal region or forehead region 10B₂, while at least a majority of the second sensor is positioned within the robot's chin or mental region 10M. Additionally, the robot's head has a third sensor positioned on the rear of the head or in the occipital region 10E and a fourth sensor positioned on top of the head or in the rear parietal region 10A₁. The position of the first sensor: (i) enables a larger display to be utilized within the head 10.1, and (ii) allows the robot to see into a bin that is placed on a high shelf. Including the second sensor enables the robot to see what it is carrying (including looking into a bin) without using the first sensor. This is beneficial over conventional robots that lack the second sensor because said conventional robots must bend and turn their neck more to obtain the data captured from said second sensor. The position of the third sensor provides the robot with additional information of the environment behind it to help with situational awareness and localization of the robot. Similarly, the fourth camera is positioned on the top of the head to assist with localization of the robot. None of the sensors are positioned where a human's eyes would typically be located, nor on either side of the robot's head.

The upper, lower, top, and rear sensors in the head are all vertically aligned in the sagittal plane and are directly coupled to a computing device (e.g. processor) that can be located in the head of the robot, wherein said computing device is running a custom-built algorithm to integrate the data from the sensor assemblies (e.g., cameras) into stereo vision or to extract 3D information from the collected data. The vertical camera arrangement allows freedom to minimize the space required by the cameras; thus, allowing more room for other electronics within the head. For example, the placement of the sensors can recover at least 10% of the space that was required by commercially available and prepackaged 3D/depth cameras (e.g. RealSense by Intel) stereo vision sensors. In other words, the robot lacks commercially available and prepackaged 3D/depth cameras that include horizontally spaced cameras. In addition to recovering said space by omitting said commercially available and prepackaged 3D/depth cameras, the vertical arrangement of the sensor assemblies with the custom-built algorithms reduces heat generation, removes supply issues, reduces latency, and reduces power consumption.

The head of the robot also includes antennas designed to allow for data transfer into and out of the robot. Specifically, the robot can include wireless communication modules (e.g., cellular, Wi-Fi, Bluetooth, WiMAX, HomeRF, Z-Wave, Zigbee, THREAD, RFID, NFC, and/or etc.) that are connected to said antennas. For example, said robot may include a 5G cellular radio coupled to one or more of the antennas and a Wi-Fi radio (e.g., 5 GHz or 2.4 GHz) coupled to another antenna. Although Wi-Fi transmission can be prone to packet loss, a secondary protocol can enhance reliability. In various embodiments, a plurality of 5G cellular radios can be used for wireless communication to maximize bandwidth and help ensure connectivity. The 5G cellular radios can be positioned in the torso and wired via the neck to the antennas within the head.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head 10.1, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

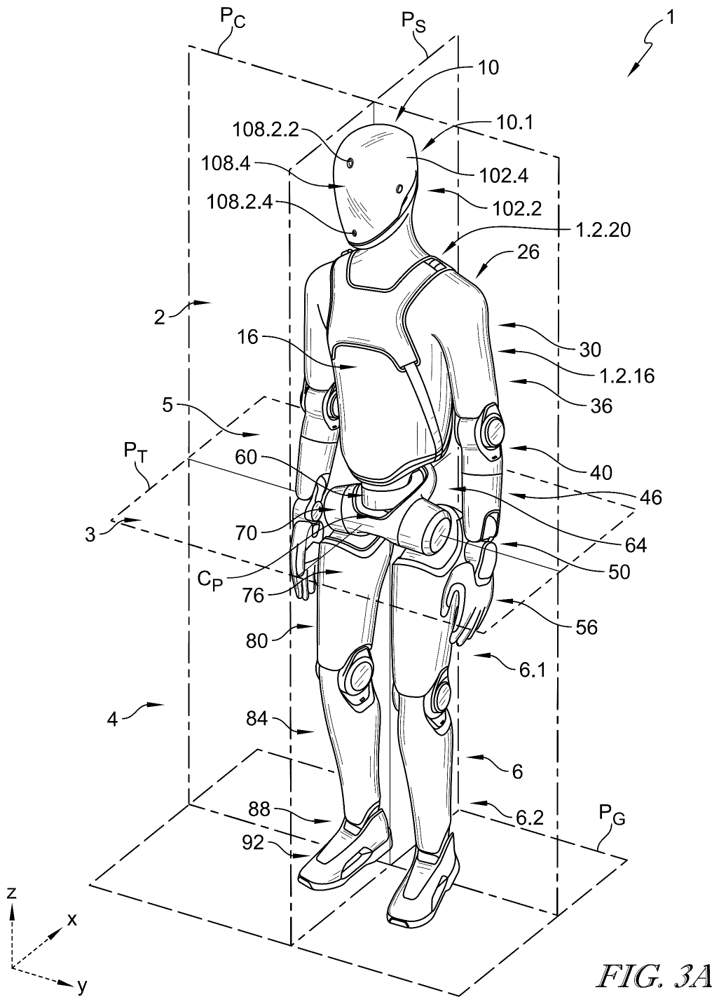

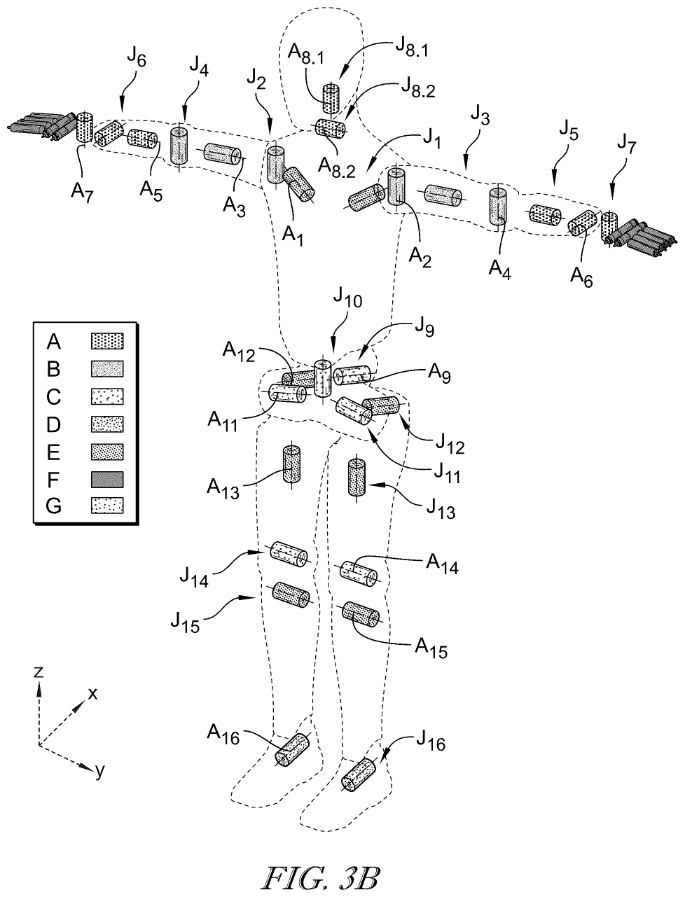

Neutral State: a state where the robot is standing upright on a horizontal support surface (PG) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (Ps) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (Ps) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (Pc) is a vertical plane that contains the rotational axes An of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes An of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

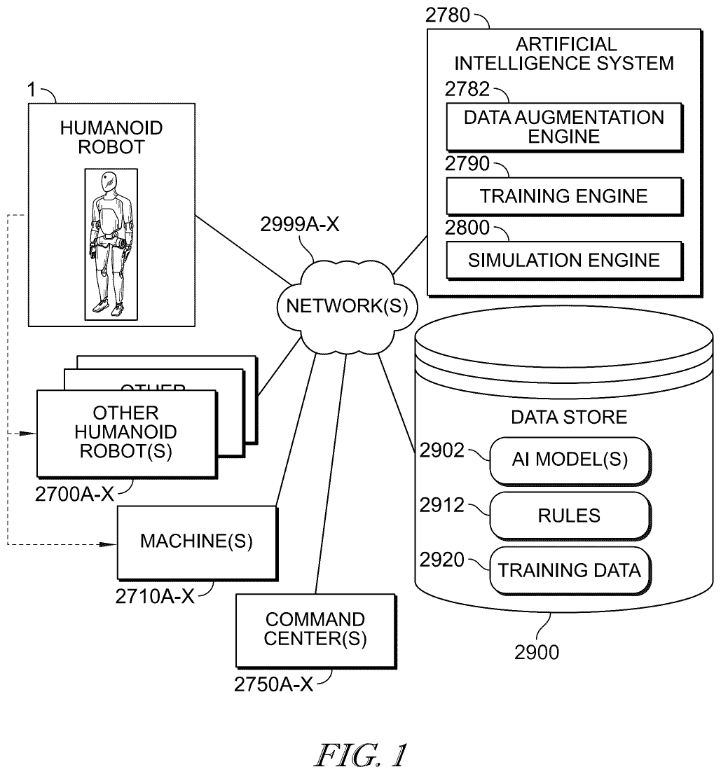

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

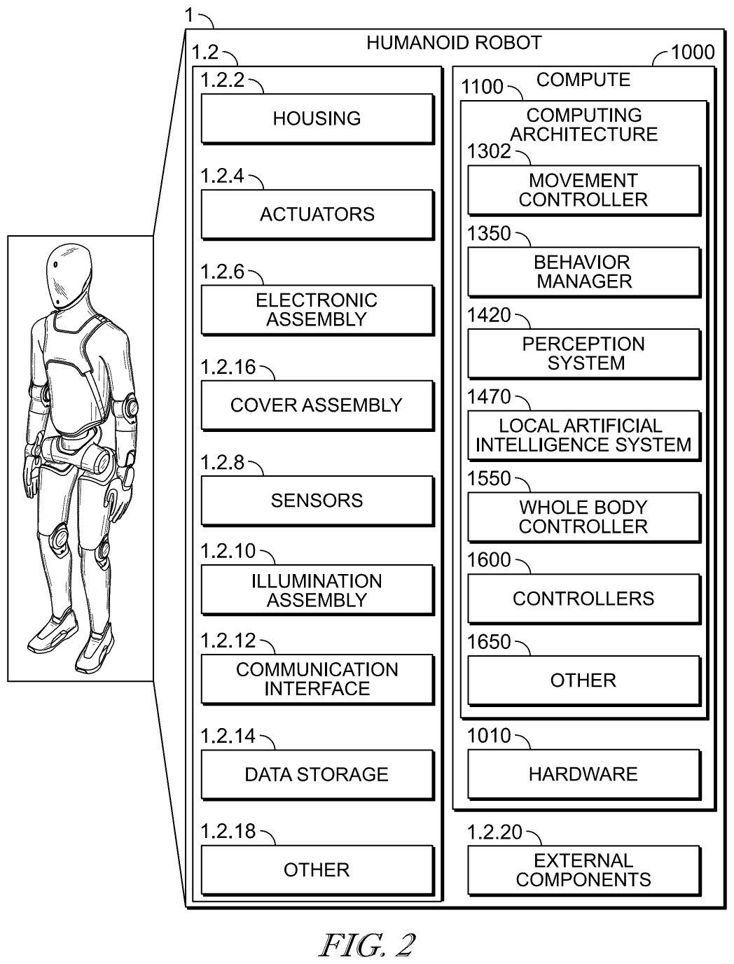

FIG. 2 is a block diagram of a humanoid robot 1 that includes a variety of architectures and other components that may include: (i) a mechanical/electrical architecture 1.2 that includes housings 1.2.2, actuators 1.2.4, an electronic assembly 1.2.6, sensors 1.2.8, a communication interface 1.2.12, an illumination assembly 1.2.10, data storage 1.2.14, an exterior covering assembly 1.2.16, external components 1.2.20, other components 1.2.18, and (ii) a compute module 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are often insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head portion 10.1 is characterized by an absence of large flat surfaces (e.g., the head portion 10.1 is not a cube or prism) and the head is also not formed with significant cylindrical features or perfect circles. Instead, almost all exterior surfaces of the head portion 10.1 are curvilinear or contain substantial curvilinear aspects, which presents a generally egg-shaped appearance when viewed from the front or top.

Structurally, the head portion 10.1 is symmetrical about the sagittal plane Ps but is asymmetrical about the Z-Y and X-Y planes that intersect the head and are parallel to the coronal plane (Pc) and the transverse plane (P_{T}), respectively. The width (parallel to the y-axis) and depth (parallel to the x-axis) of the head portion 10.1 change constantly from top to bottom, reaching a maximum dimension in the temple region, which is located at approximately 30-50% of the head's height from its top end.

The head portion 10.1 itself may house a range of components, such as high-resolution cameras, microphones, and displays, all of which are contained within an impact-resistant polymer housing 102. This housing 102 includes a large, freeform (i.e., not conforming to a regular or formal structure or shape) frontal shell 102.4 that covers the frontal and crown regions of the head portion 10.1. The term freeform signifies that the shield does not conform to a regular or formal geometric structure or shape. The frontal shell 102.4 is formed as a separate and distinct piece from the displays positioned behind it, thereby protecting the displays and internal electronics from damage. This separation provides a significant advantage during the performance of industrial tasks, as a damaged frontal shell 102.4 is substantially cheaper and easier to replace than a damaged display. The frontal shell 102.4 extends rearward beyond an auricular region into an occipital region 10E and extends down to a chin region 10M, but it does not extend below a jaw line.

Cameras embedded within the head portion 10.1 may include RGB, depth-sensing, thermal imaging capabilities, and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head portion 10.1 may serve as user interfaces, providing visual feedback or conveying expressions to improve communication and user engagement. Unlike the heads of conventional robots, the disclosed head portion 10.1 includes a main display 108.4.2 that is curved in at least one direction and is positioned at an angle relative to a sagittal plane. This curved design permits the inclusion of a larger display with a greater surface area compared to a flat screen, which increases the amount of information that can be conveyed, such as robot status, sensor data, and operational alerts. This information is displayed using generic blocks or shapes rather than anthropomorphic features like eyes or a mouth. In addition to the main display 108.4.2, two side-facing displays are included to show indicia such as the identification number/serial number, battery life, current task, any safety indicia, and/or any other information associated with the humanoid robot 1.

Further, an extent of an illumination assembly 1.2.10, which comprises a plurality of light emitters 108.12, is positioned adjacent to an edge (e.g., lower) of the frontal shell 102.4. These light emitters 108.12 may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays and may relay information more rapidly.

Additionally, the head portion 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck portion 10.2 to the antennas in the head portion 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head portion 10.1 about axis A_{8.1}, which is a vertical (yaw) axis when the robot is in the neutral state, and a head nod actuator (J8.2) 140, which enables rotation of the head portion 10.1 about the axis A_{8.2}, which is a horizontal axis when the robot is in the neutral state. Together, these two actuators may provide two degrees of freedom for the head portion 10.1, allowing it to perform movements that emulate natural human head motions. The head twist actuator (J8.1) 120 may be positioned within the head and neck assembly 10, while the head nod actuator (J8.2) 140 may be located at the base of the neck portion 10.2. The head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head portion 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head portion 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head portion 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms. Additionally, variations of the head portion 10.1 may include modular head designs that allow for the quick customization or replacement of sensory and communication components. These modular designs may facilitate easy upgrades or modifications to the capabilities of the humanoid robot 1 without extensive changes to the overall head and neck assembly 10. Furthermore, advanced control algorithms may be implemented to enable more natural, biomimetic head movements, potentially incorporating machine learning techniques to adapt and refine the motion patterns of the head portion 10.1 based on interaction data and environmental feedback. The head and neck assembly 10 will be discussed in further detail below.

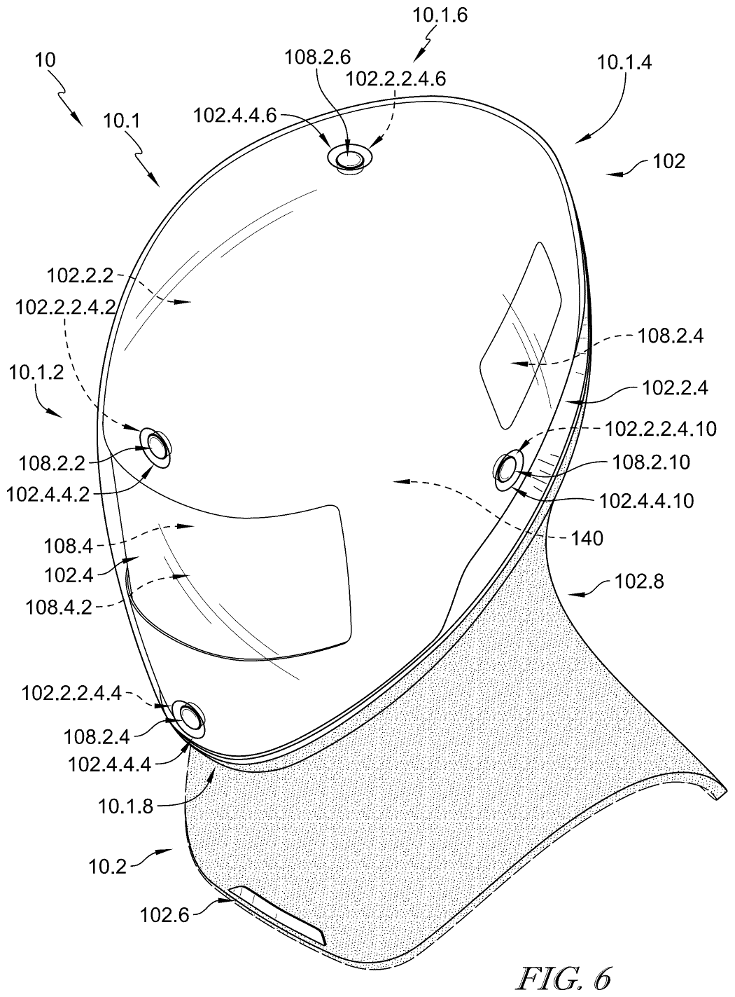

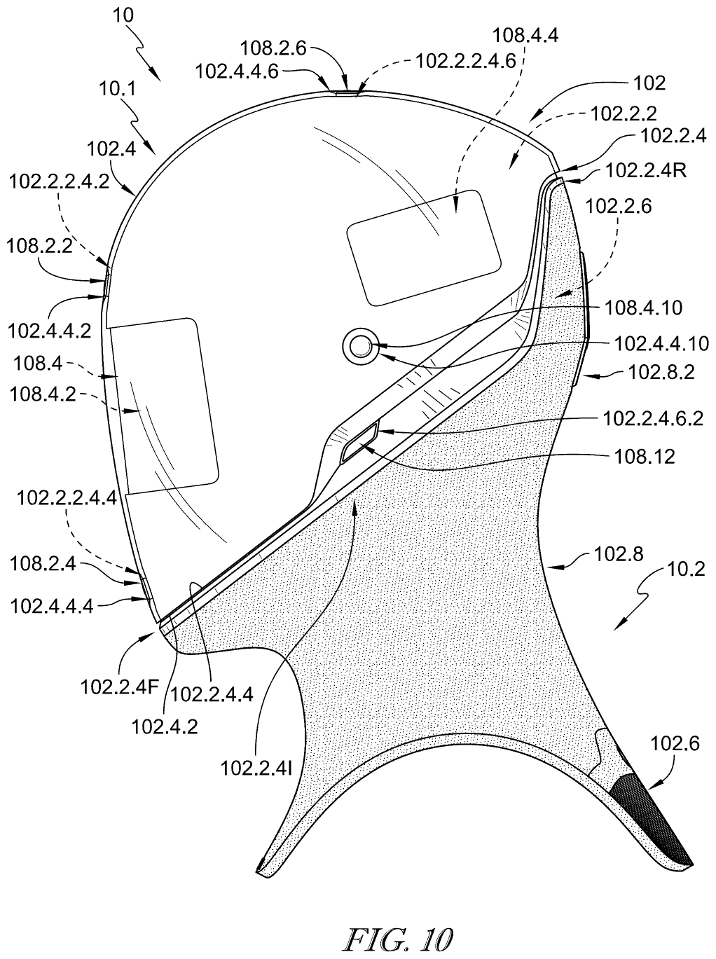

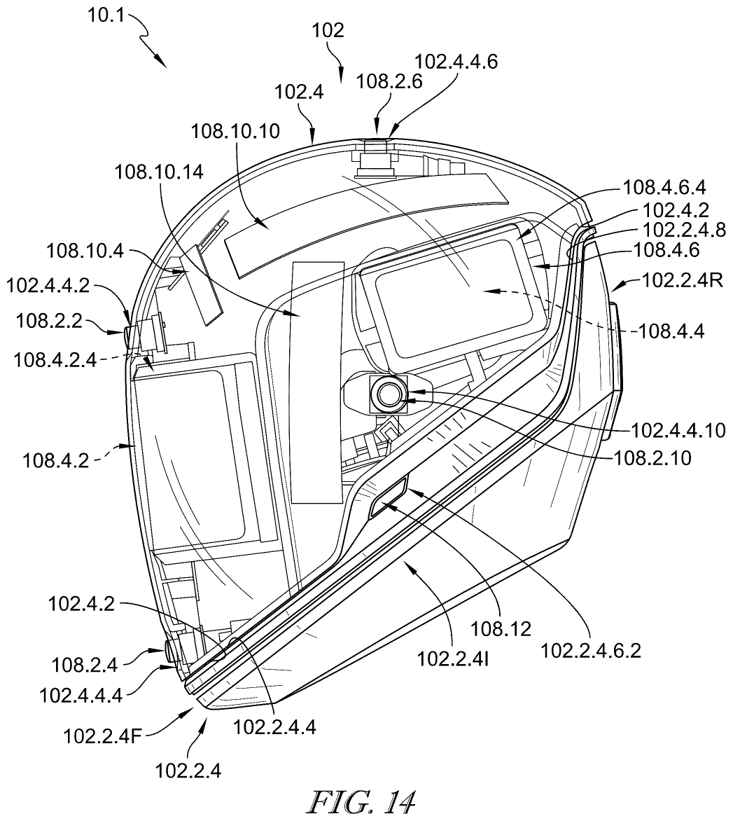

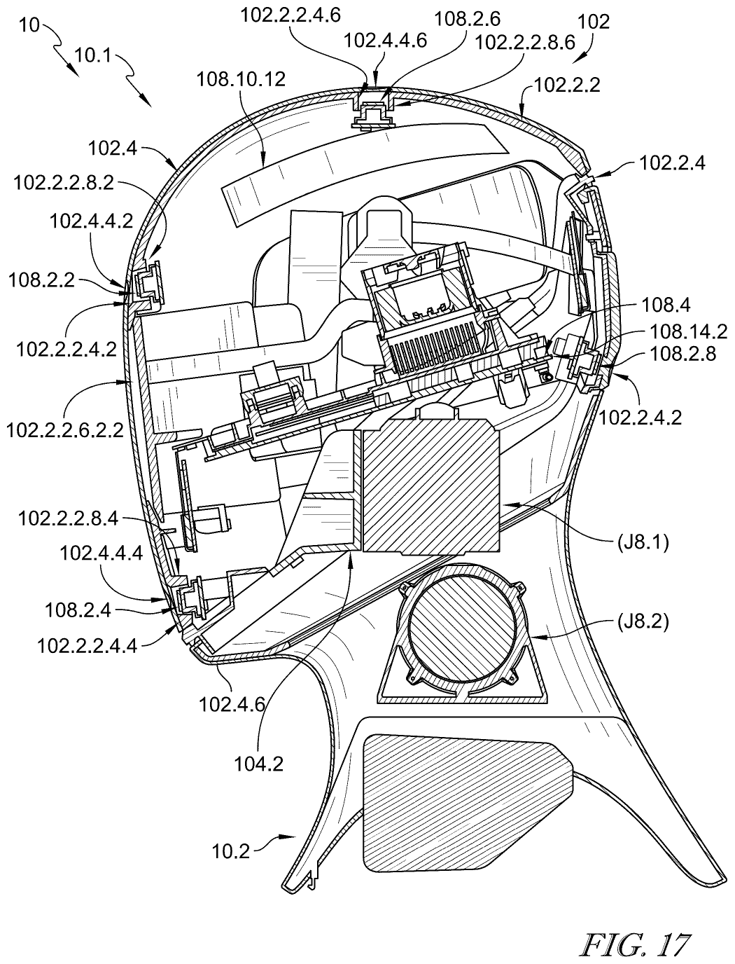

As shown in FIGS. 6-19, the head and neck assembly 10 of the humanoid robot 1 includes: (i) a head portion 10.1, (ii) a neck portion 10.2, (iii) a head twist actuator (J8.1) 120, and (iv) a head nod actuator (J8.2) 140. The head portion 10.1 and neck portion 10.2 are shaped to resemble the general shape of a human head and neck. The head portion 10.1 and the neck portion 10.2 are also configured to house and protect the head twist actuator (J8.1) 120 and the head nod actuator (J8.2) 140.

a. Head Portion

The head portion 10.1 of the robot 1 has an exterior surface that provides said head portion 10.1 with an overall shape that is similar to the shape of a human head. In some embodiments, the head portion 10.1 is formed with no, or minimal, flat surfaces and is generally egg-shaped when viewed from the front and/or the top. The head portion 10.1 of the robot 1 changes constantly in width from top to bottom, wherein the width of the head portion 10.1 increases from a top or scalp end to a temple region where the head is widest. The temple region generally corresponds to an eye level of a human, or is at a location that is about 30-50% of a height of the head portion 10.1 from the top end. The width of the head portion 10.1 then decreases from the temple region to a lower or chin region 10M. In this way, the head portion 10.1 of the robot 1 is asymmetrical about a first plane passing through a center or centroid C of the head portion 10.1 equidistant from the top end and the lower end. The head portion 10.1 of the robot is symmetrical about a second plane perpendicular to the first plane and passing through the center or centroid C of the head portion 10.1. In other embodiments, the head may be symmetrical about a first plane and asymmetrical about a second plane.

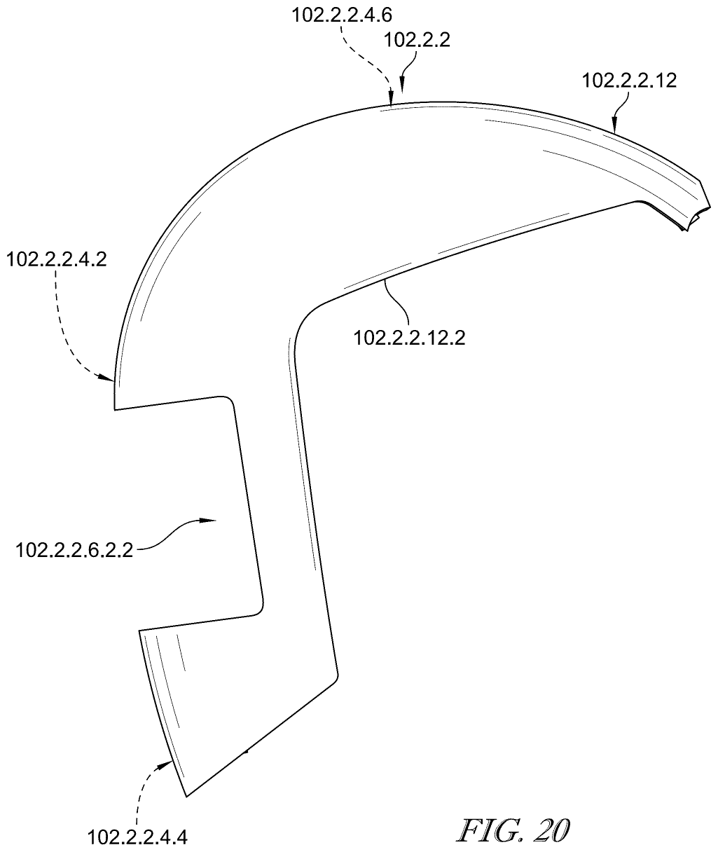

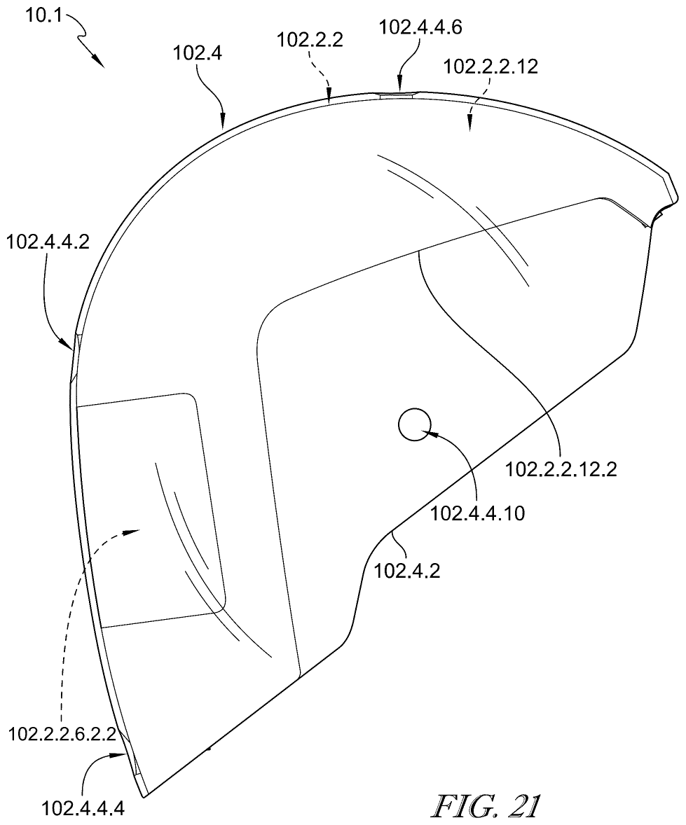

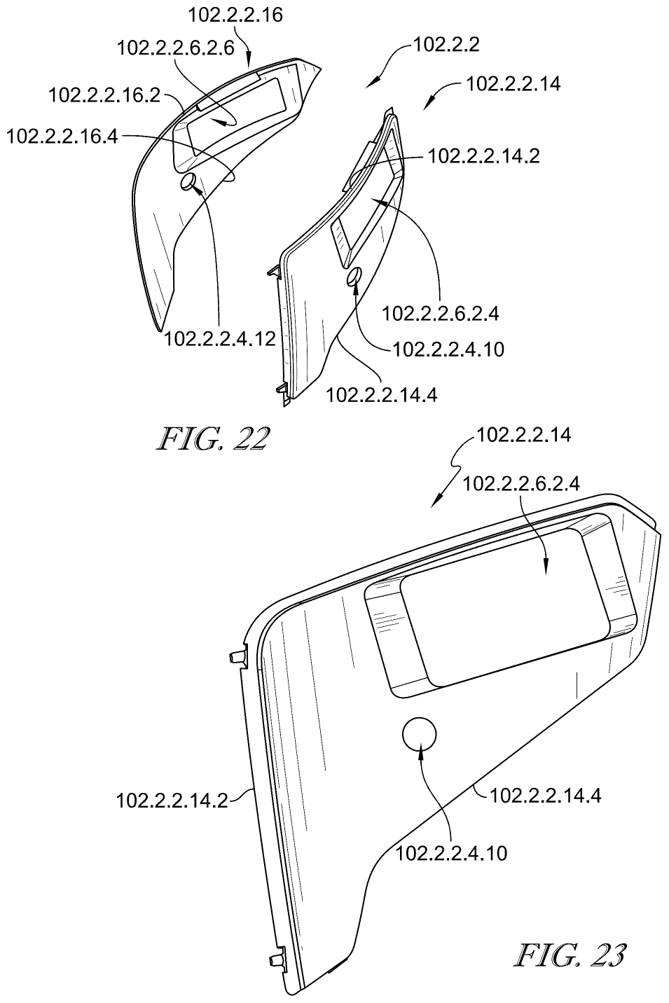

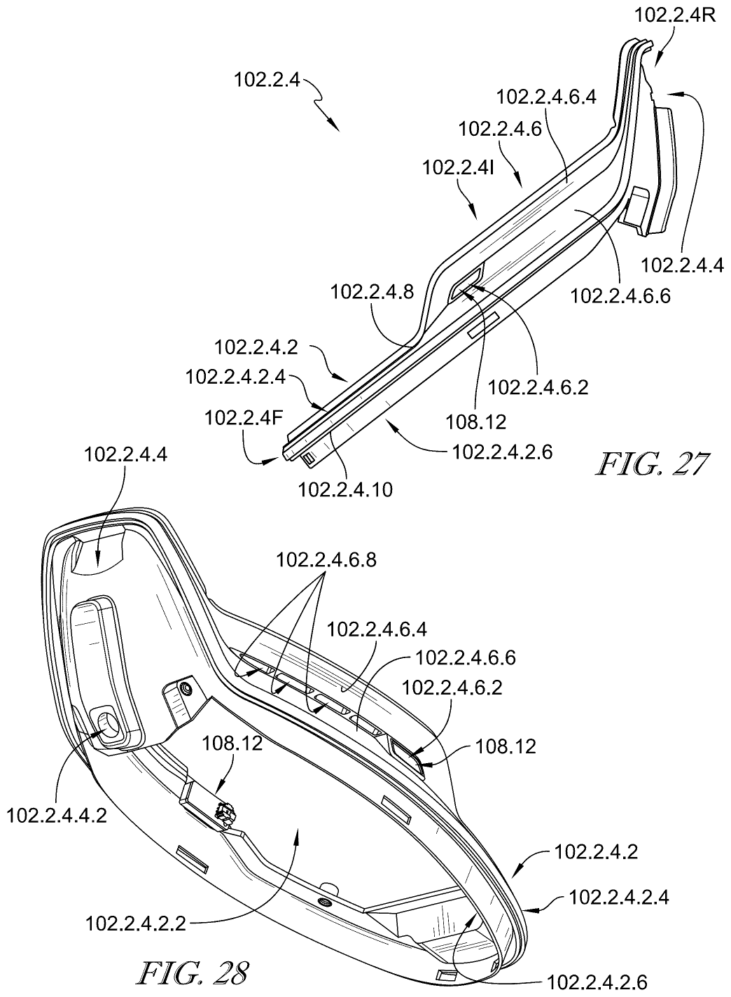

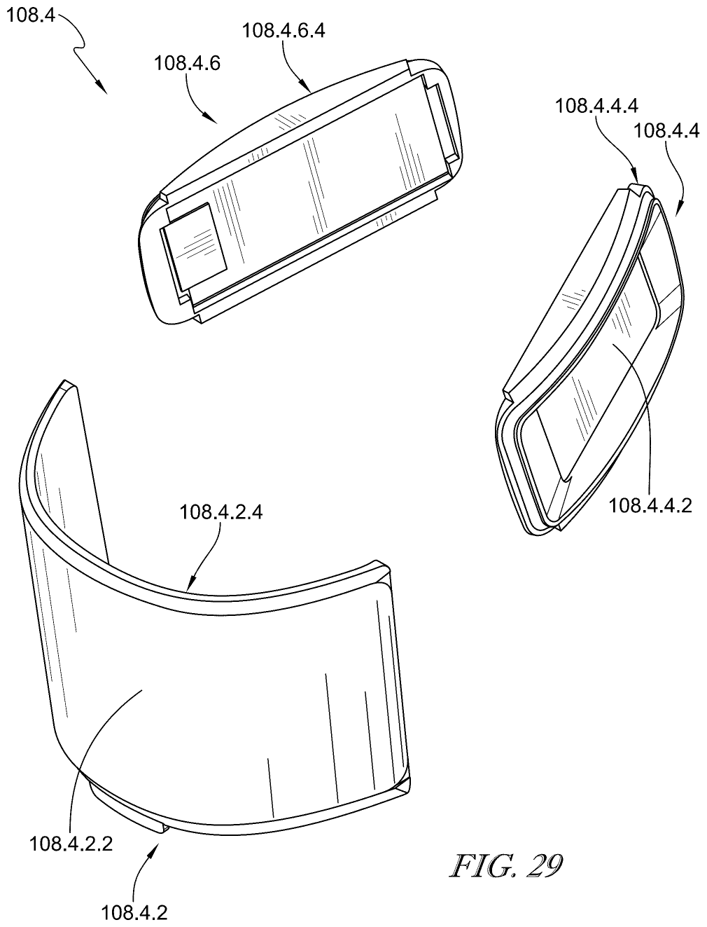

As shown in FIGS. 6-28, the head portion 10.1 of the head and neck assembly 10 includes: (i) a housing 102, (ii) an internal support assembly 104, and (iii) an electronics assembly 108. The housing 102 defines the overall shape of the head portion 10.1. The housing 102 is configured to contain and protect the internal support assembly 104 and the electronics assembly 108. The internal support assembly 104 is designed to securely mount and position the electronics assembly 108 within the head portion 10.1 of the robot 1.

i. Head Regions

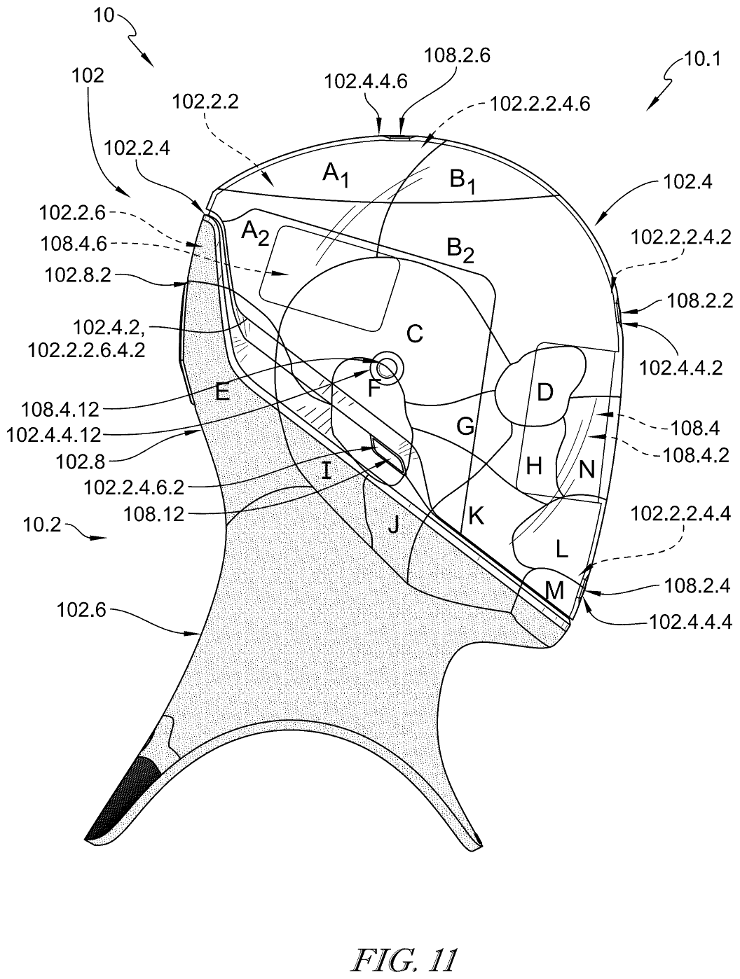

The head 10.1 has a neurocranial portion and a viscerocranial portion as shown in FIGS. 7 and 11. The neurocranial portion includes parietal regions 10A1, 10A2, frontal regions 10B1, 10B2, an auricular region 10F, a temporal region 10C, and an occipital region 10E. The viscerocranial portion includes an orbital region 10D, an infraorbital region 10H, a buccal region 10K, a parotid or parotideomasseteric region 10J, a zygomatic region 10G, a nasal region 10N, an oral region 10L, a mental region 10M, and a mastoid region 10I.

ii. Housing

As shown in FIGS. 6-28, the housing 102 is configured to have a form resembling the general shape of a human head. The housing 102 includes: (i) a frontal shiled, also referred to as an upper shell, shell, skull, or display covering 102.4, and (ii) a support frame, also referred to as a jaw member or rear/lower support frame 102.2.4, as shown in FIGS. 6-28. In other embodiments, the head housing 102 may have more components assembled together to contain and protect the components within the head portion 10.1. For example, the housing 102 may be made from more than two components (e.g., between 2 and 100). The modular design allows for individual components to be replaced without replacement of the entire housing 102. The housing 102 may be manufactured using processes such as injection molding or 3D printing and may include any known polymer material or other material. Examples include urethanes, PMMA, ABS, nylons, polyamides, polycarbonate (PC), polypropylene (PP), high-density polyethylene (HDPE), polystyrene (PS), polyvinyl chloride (PVC), thermoplastic elastomers (TPE), polyethylene terephthalate (PET), polybutylene terephthalate (PBT), polyoxymethylene (POM or acetal), epoxy resins, silicone rubber, polyimides (PI), acrylics, polyethylene (PE), liquid crystal polymers (LCP), phenolic resins, glass-filled nylons, carbon fiber reinforced plastics (CFRP), glass fiber reinforced plastics (GFRP), thermoplastic polyurethane (TPU), metal-plastic hybrids, biodegradable plastics (e.g., PLA), conductive polymers (e.g., PANI), any combination thereof, or any other similar material.

As shown in FIGS. 6-28, a depth of the head of the robot 1 is defined by a combination of both the shield 102.4 and the support frame 102.2.4. The depth includes a maximum depth at a location that is about equal to the temple region and that extends between a front or facial region of the head portion 10.1 to an occipital region 10E of the head portion 10.1. A front end 10.1.2 is provided by the shield 102.4 and a rear end 10.1.4 is provided by the support frame 102.2.4. The depth of the head portion 10.1 changes constantly from a top end 10.1.6 to a lower end 10.1.8. The depth increases from the top end 10.1.6 to the maximum depth and then decreases from the maximum depth to the lower end 10.1.8.

The head portion 10.1 of the robot 1 is symmetrical about the sagittal plane (Ps) but is asymmetrical about Z-Y and X-Y planes that (i) extend through the center or centroid C of the head portion 10.1, (ii) intersect the head portion 10.1, and (iii) are parallel to the coronal plane (Pc) and the transverse plane (PT), respectively. The center C is spaced at equal distances from: (i) the top end 10.1.6 and the bottom end 10.1.8, (ii) the front end 10.1.2 and the rear end 10.1.4, and (iii) the lateral or left/right sides of the head portion 10.1. In other embodiments, the head portion 10.1 may be symmetrical about: (i) all planes, (ii) three of the planes, (iii) two of the planes, (iv) one of the planes, or (v) none of the planes.

### 1. Front Shell

The front shell, also referred to as a front/upper shield, shell, visor, skull or display covering 102.4, is configured to cover, encase, surround, or overlay the internal support assembly 104 and the electronics assembly 108, as shown in FIGS. 6-28. The shield 102.4 may be made from a transparent or semi-transparent material so that displays 108.4.2, 108.4.4, 108.4.6 mounted in the internal support assembly 104 may be viewed therethrough. In other embodiments, the shield 102.4 may be transparent in some regions and not transparent in other regions.

Further, shield 102.4 may be coated, etched, or formed with a plurality of layers in a manner that improves durability, increases sensor accuracy, filters one or more specific wavelengths, reduces glare, enhances appearance, reduces fogging, makes the shield 102.4 easier to clean, or protects it from cleaning products. It should be understood that this disclosure is not limited to just the information that is disclosed within any incorporated applications but instead should include any compositions, shapes, layer numbers, and compositions of layers that are known in the art or are obvious in light of what is known in the art.

The shield 102.4 or an extent of the shield 102.4 may have a substantially uniform thickness, which may be equal to or greater than 1 mm and preferably greater than 2 mm. Additionally, the shield 102.4 may be optically correct and may not be a corrective lens. As such, the shield 102.4 has a dioptric power of less than 0.25 diopters, preferably less than 0.12 diopters, and most preferably less than 0.06 diopters, to ensure an undistorted view of the internal displays. The shield 102.4 may have a reverse or negative pantoscopic tilt, a forward or positive pantoscopic tilt, or no pantoscopic tilt relative to the coronal plane (Pc).

Accordingly, the shield 102.4 may be made from or may include polycarbonate (PC), acrylic (PMMA), Trivex, nylon, Gorilla Glass (aluminosilicate glass), thermoplastic polyurethane (TPU), high-grade optical glass, CR-39, polyethylene terephthalate (PET), polystyrene, fused silica (quartz glass), borosilicate glass, polyurethane, cellulose acetate, polyvinyl chloride (PVC), cellulose acetate butyrate (CAB), polyvinyl butyral (PVB), optical-grade resin, sapphire glass, polyetherimide (PEI), Lexan, thermoset plastics, other anti-scratch coated plastics, or any other similar material that is known in the art. Also, the shield 102.4 may be manufactured via injection molding, 3D printing, or overmolded onto an electronics mount 102.2.2. Wherein said overmolded shield 102.4 may be manufactured using a multi-part mold design, multiple injection shots, or other molding techniques (e.g., gas-assisted injection molding, liquid injection molding, thermoforming, and/or reaction injection molding). Further, said molding technique, mold design, and shot configuration may be determined using mold flow analysis and/or simulation.

As shown in FIGS. 6-23, the shield 102.4 may include a curved surface and be configured to cover the electronics mount 102.2.2 and couple to the support frame 102.2.4 at the rim 102.2.2.6.4. The shield 102.4 is shaped to resemble the form of the head portion 10.1, providing a substantially continuous surface between the sections of the housing 102. The curvature of the shield 102.4 may vary and have different curvatures (i.e. radii and arcs) at different positions along the shield 102.4. Although the illustrative embodiment shows the shield 102.4 is sized to match or substantially match the electronics mount 102.2.2, the shield 102.4 may occupy any portion or ratio of the robot's head and may have any configuration. The shield may: (i) wrap from the front of the head into the side regions of the head portion 10.1, (ii) extend into the chin area or cover the entire chin area, and (iii) may have a non-uniform rear edge. The disclosed shield may be curved in two directions (e.g., vertically and horizontally) or may be a freeform design that may include multiple curves.

As shown in FIG. 11, the disclosed shield 102.4 (i) extends from the chin or mental region 10M of the robot's head portion 10.1 to the parietal region 10A₂ of the robot's head portion 10.1 and (ii) wraps around the sides up to or past the ear or auricular region 10F of the robot's head portion 10.1. The shield 102.4 does not extend into the occipital region 10E or the mastoid region 10I of the robot's head portion 10.1 but does extend partway into the parotid or parotideomasseteric region 10J and buccal region 10K of the robot's head portion 10.1 as shown in FIG. 11. In other embodiments, the entire head may be a shield, the shield may not extend as far up as or past the auricular region, the shield may not extend into the parietal region 10A₂, or the shield may extend into the parietal region 10A₁, but not the parietal region 10A₂. Additionally, the disclosed shield 102.4 may occupy between 90% and 25% of the head portion 10.1 and may be curved in at least two directions (e.g., vertically and horizontally). In some embodiments, the shield 102.4 and the display may be integrated into a single component or may be formed from a plurality of components.

The shield 102.4 includes sensor apertures 102.4.4.2, 102.4.4.4, 102.4.4.6, 102.4.4.10, 102.4.4.12, which are configured to align with sensor openings 102.2.2.4.2, 102.2.2.4.4, 102.2.2.4.6, 102.2.2.4.10, 102.2.2.4.12 in the electronics mount 102.2.2. The formation of the combination of the sensor apertures 102.4.4.2, 102.4.4.4, 102.4.4.6, 102.4.4.10, 102.4.4.12 and sensor openings 102.2.2.4.2, 102.2.2.4.4, 102.2.2.4.6, 102.2.2.4.10, 102.2.2.4.12 enables the lenses 108.2.2L, 108.2.4L, 108.2.6L, 108.2.10L, 108.2.12L of the upper camera 108.2.2, the lower camera 108.2.4, the top camera 108.2.6, the left camera 108.2.10, and the right camera 108.2.12 to be unobstructed. This configuration reduces potential distortion of the images captured by the cameras 108.2.2, 108.2.4, 108.2.6, 108.2.10, 108.2.12, which in turn reduces computational processing, lowers battery usage, and minimizes heat generation from the image signal processor.

The shield 102.4 may have the same or a different curvature than the displays 108.4.2, 108.4.4, 108.4.6 at the respective locations of these displays 108.4.2, 108.4.4, 108.4.6 so that the shield 102.4 is optically correct. This provides a clearer, crisper, and more accurate view of the displays 108.4.2, 108.4.4, 108.4.6. The optically correct shield 102.4 mitigates distortions, aberrations, and visual artifacts, providing viewers of the displays 108.4.2, 108.4.4, 108.4.6 with an unobstructed and accurate view of the displays 108.4.2, 108.4.4, 108.4.6, while still protecting the displays 108.4.2, 108.4.4, 108.4.6 and other electronic components within the head portion 10.1.

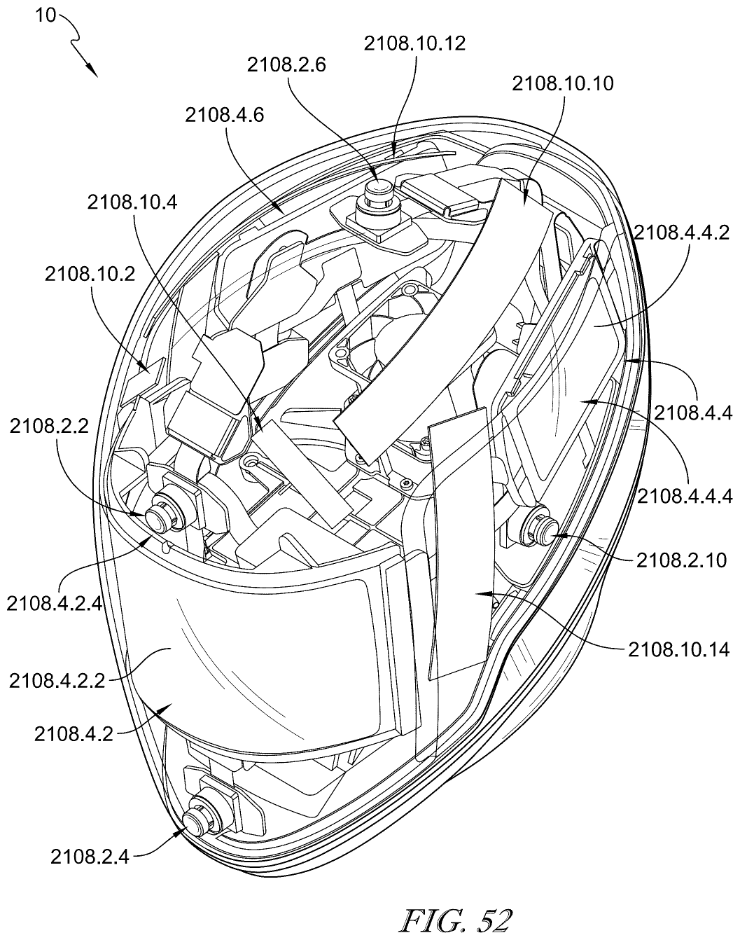

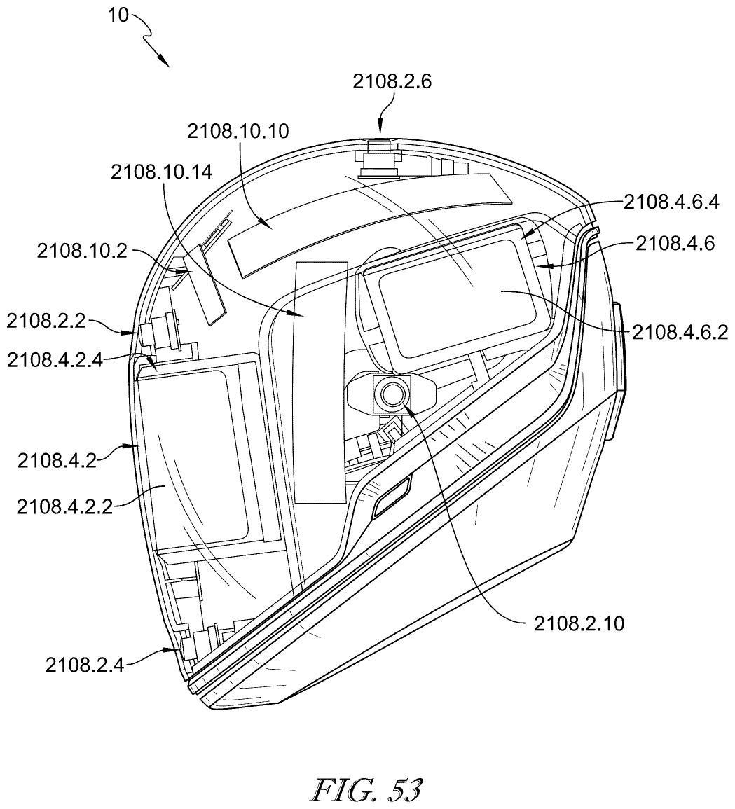

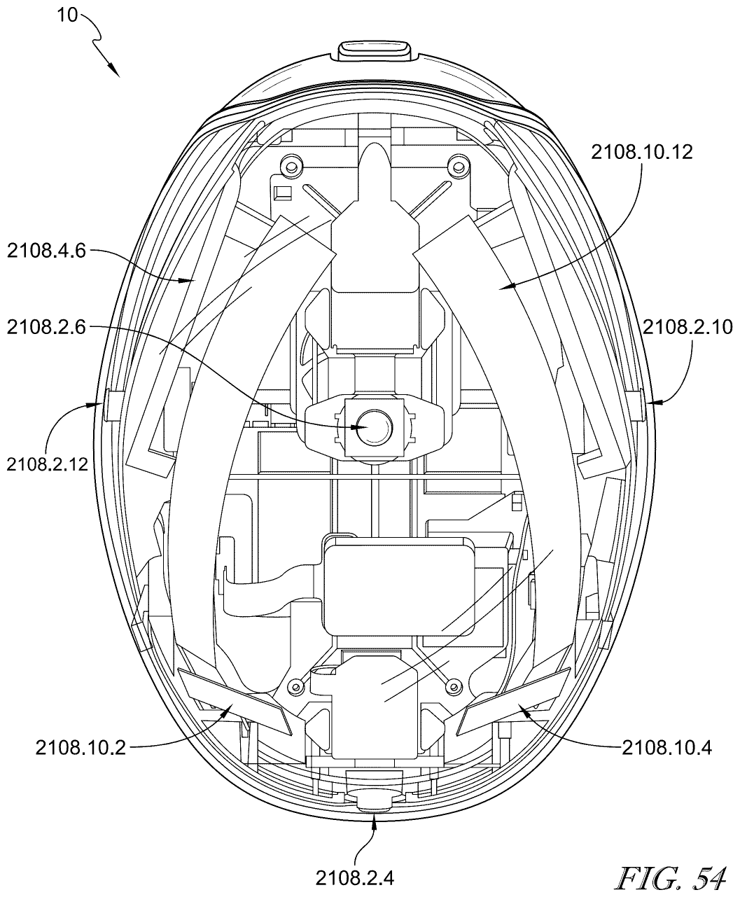

In another embodiment of the shield 2102.4, the sensor apertures are omitted such that the camera sensors 2108.2.2, 2108.2.4, 2108.2.6, 2108.2.10, 2108.2.12 are positioned behind the shield 2102.4 as shown in FIGS. 52-54. The internal support assembly still has sensor openings 102.2.2.4.2, 102.2.2.4.4, 102.2.2.4.6, 102.2.2.4.10, 102.2.2.4.12 for the camera sensors 2108.2.2, 2108.2.4, 2108.2.6, 2108.2.10, 2108.2.12, but the shield 2102.4 extends thereover. In this way, the camera sensors 2108.2.2, 2108.2.4, 2108.2.6, 2108.2.10, 2108.2.12 are hidden from view. In some embodiments, the shield 2102.4 may have sensor apertures for at least one of the camera sensors, but may extend over the other camera sensors.

### 2. Support Frame

The support frame 102.2.4, also referred to as a jaw member or rear/lower support frame 102.2.4, defines (i) a rear portion of the head portion 10.1 (e.g., an extent of the parietal region 10A and the occipital region 10E) and is designed to couple the head actuator assembly (J8.1, J8.2) and (ii) a neck cover to the head portion 10.1. The support frame 102.2.4 is also designed to support the internal support assembly within the head portion 10.1. The support frame 102.2.4 has an upper edge 102.2.4.8 that: (i) extends rearward from the chin region 10M along a jaw line towards the occipital regions 10E of the head portion 10.1, and (ii) complements the lower edge 102.4.2 of the shield 102.4. The support frame 102.2.4 also has a lower edge 102.2.4.10 that: (i) extends rearward from the chin region 10M along a jaw line towards the occipital regions 10E of the head portion 10.1, and (ii) complements the upper edge 102.2.6.4 of the upper securement member 102.2.6 of the neck portion 10.2.

To complement said lower edge of the shield 102.4, the support frame 102.2.4 includes a frontal extent 102.2.4F, an intermediate extent 102.2.41, and a rear extent 102.2.4R as shown in FIGS. 6-24. The frontal extent 102.2.4F is arranged below a front extent of the electronics mount 102.2.2, the intermediate extent 102.2.41 is substantially parallel with the frontal extent 102.2.4F (but not co-linear with), and the rear extent 102.2.4R has a slope that is significantly greater than the slope associated with the frontal extent 102.2.4F or intermediate extent 102.2.41. In other words, the frontal extent 102.2.4F has a first slope in the first position, the intermediate portion 102.2.41 has a second slope that is approximately equal to the first slope and is offset from said frontal extent 102.2.4F, and the rear extent 102.2.4R has a third slope that is greater than the first and second slopes. In other embodiments, the upper edge 102.2.4.8 of the support frame 102.2.4 may include more extents (e.g., between 4 and 30) or fewer extents (e.g., between 1 and 2). Further, the slopes of the extents may be different.

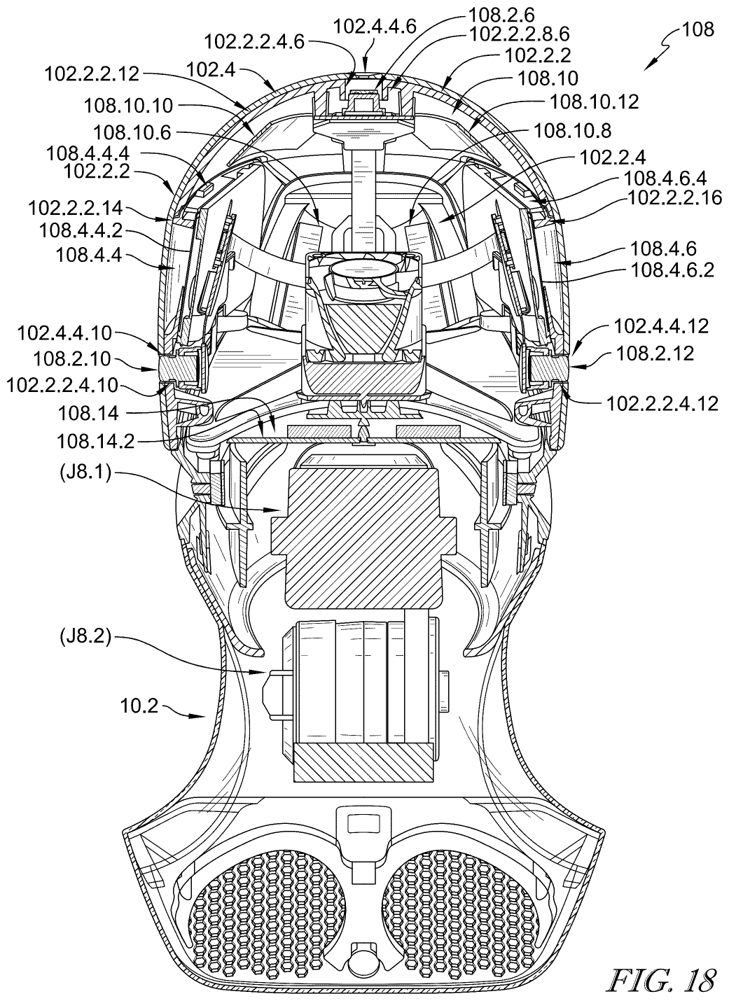

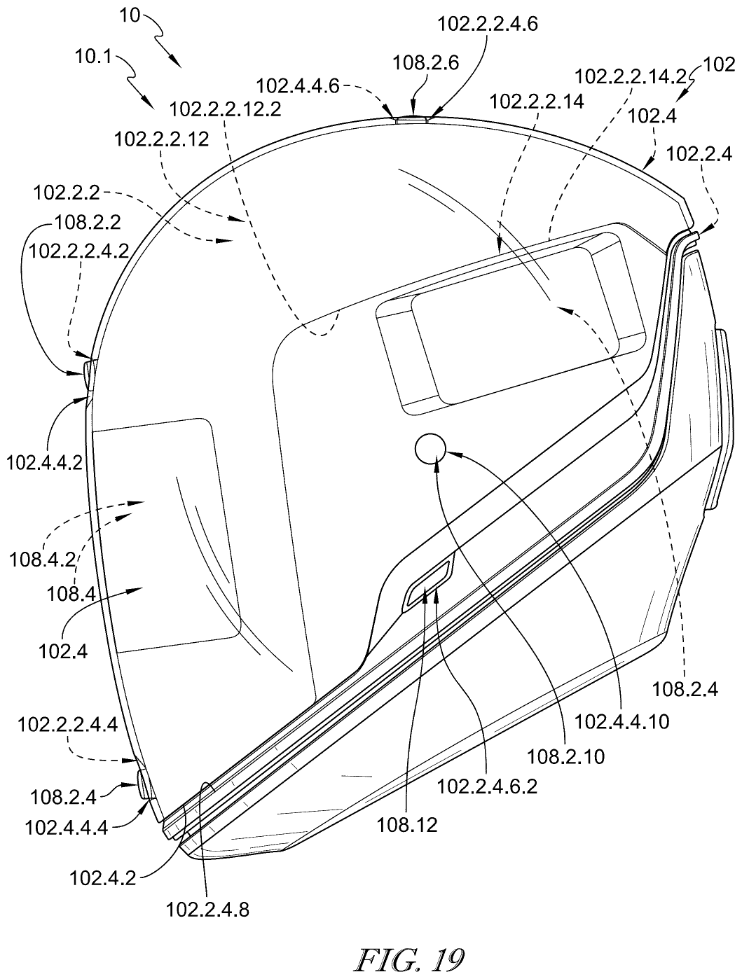

As shown in FIGS. 6-24, because the intermediate extent 102.2.41 of the upper edge 102.2.4.8 is offset from a line that is co-linear with and extends rearward from the frontal extent 102.2.4F of the upper edge 102.2.4.8, a lateral space is provided between the upper edge 102.2.4.8 of the support frame 102.2.4 and the lower edge 102.4.2 of the shield 102.4. Said lateral space extends rearward from the front of the auricular region 10F, through an extent of the mastoid region 10I, and into the occipital region 10E. The lateral space is not flush with the exterior surface of the shield 102.4. Instead, said lateral space includes a “V-shaped” recess as shown in FIG. 19. Said “V-shaped” recess includes an aperture that is formed in an upper extent of said “V-shaped” recess, wherein the aperture is designed to allow air to flow into the head portion 10.1 in order to cool said head portion 10.1. Said aperture is best seen in FIGS. 18 and 19. In addition to said aperture, a light emitter 108.12, that will be discussed in greater detail below, is also positioned within the “V-shaped” recess.

As discussed above, the support frame 102.2.4 not only includes an extent (e.g., the frontal extent 102.2.4F) that is positioned within the chin or mental region 10M, but it also includes a substantial extent (e.g., the rear extent 102.2.4R) that is positioned in the occipital region 10E. By positioning an extent of said support frame 102.2.4 in the occipital region 10E, the support frame 102.2.4: (i) reduces the size of the shield 102.4, which reduces the number of curves contained in the shield 102.4 and thereby reducing the complexity of manufacturing the shield 102.4, (ii) enables the rear camera 108.2.8 to be positioned in the support frame 102.2.4, (iii) increases ease of assembly, and (iv) increases the amount of non-transparent material that is included in the head housing 102. It should be understood that in alternative embodiments, the size of the support frame 102.2.4 may be increased to extend into the zygomatic region 10G or extend further into the temporal region 10C, parotideomasseteric region 10J, and parietal region 10A2.

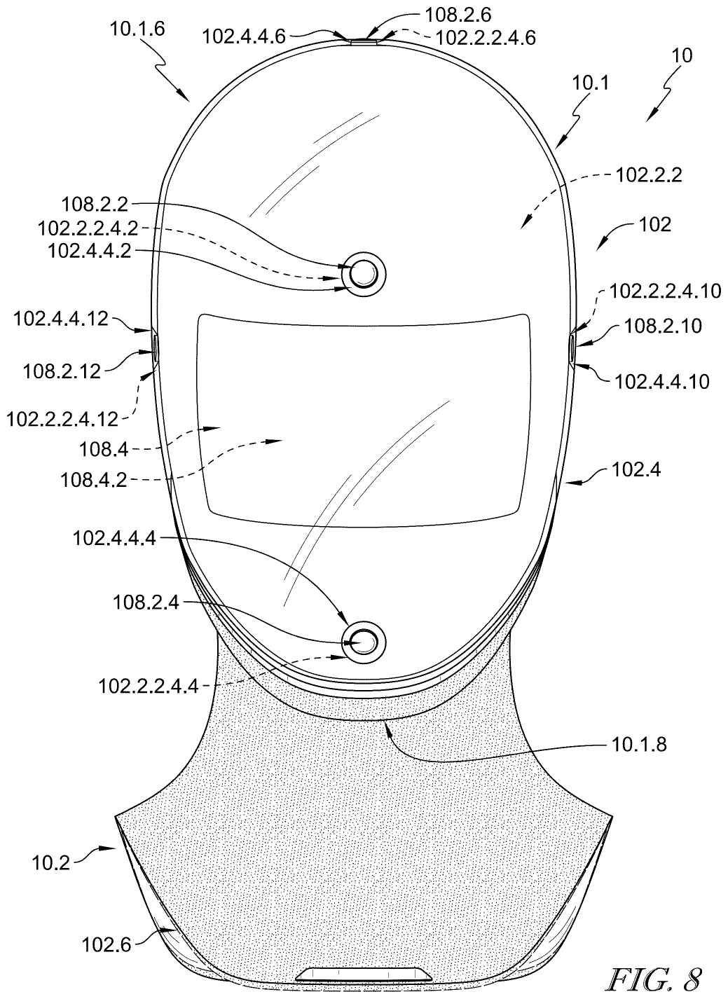

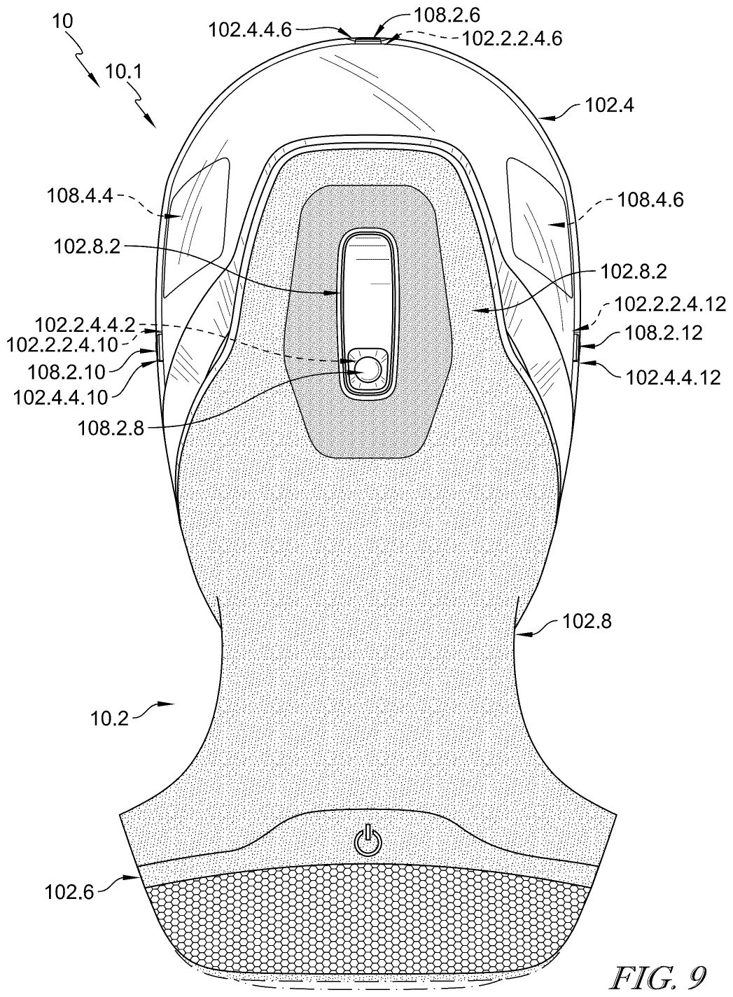

The support frame 102.2.4 is configured to include an opening 102.2.4.4.2 for at least one sensor (e.g., rear camera 108.2.8) of the electronics assembly 108 and an opening 102.2.4.6.2 for at least one indicator light 108.12. The sensor opening 102.2.4.4.2 in the support frame 102.2.4 is also vertically aligned in the sagittal plane (Ps) of the robot 1 (and the head portion 10.1) when the robot 1 (or the head portion 10.1) is in a natural or original upright position, as shown in FIGS. 8-9. In particular, the upper sensor opening 102.2.2.4.2, the lower sensor opening 102.2.2.4.4, the top sensor opening 102.2.2.4.6, and the rear sensor opening 102.2.4.4.2 are horizontally centered in the head portion 10.1. The indicator opening 102.2.4.6.2 is located in the auricular region 10F of the head portion 10.1.

The support frame 102.2.4 may be made from materials such as silicone elastomers, thermoplastic polyurethane (TPU), shape-memory polymers (SMPS), polydimethylsiloxane (PDMS), polyurethane, liquid silicone rubber (LSR), urethane rubber, vinyl (PVC) skin, soft thermoplastic elastomers (TPE), elastomeric alloys, acrylonitrile butadiene styrene (ABS) blends, high-density polyethylene (HDPE) blends, conductive polymers, carbon nanotube-infused elastomers, magnetic shape-memory alloys, electroactive polymers (EAPS), styrene-butadiene rubber (SBR), thermoplastic vulcanizates (TPV), polyurea elastomers, medical-grade synthetic skin materials, thermoplastic olefins (TPO), fluoroelastomers, chloroprene rubber, ethylene propylene diene monomer (EPDM) rubber, polyacrylamide hydrogels, polycaprolactone (PCL), photocurable resins, elastomeric composites, phosphorescent elastomers, thermochromic materials, electrostrictive polymers, piezoelectric polymers, superelastic alloys, microcellular foams, hyperelastic materials, viscoelastic gels, nanocomposite elastomers, fabrics, metal, other similar plastics or polymers, any combination of the above, and/or any other similar material known in the art. The support frame 102.2.4 may be manufactured using any known method, including: molding, such as injection or dip molding, casting, 3D printing (additive manufacturing), dip molding and coating, spray coating, lamination and layering, electrospinning, sculpting and machining, thermoforming, any combination of the above, and/or any other known method.

As shown in FIGS. 24-28, the support frame 102.2.4 includes: (i) a frame base member 102.2.4.2, (ii) a back frame plate 102.2.4.4, and (iii) left and right frame walls 102.2.4.6. The frame base member 102.2.4.2 extends around the front, rear, left, and right extents of the head portion 10.1 to form an opening 102.2.4.2.2. The back frame plate 102.2.4.4 extends from a portion of the frame base member 102.2.4.2 and defines a majority of the rear extent 102.2.4R of the support frame 102.2.4. The left and right frame walls 102.2.4.6 extend upwardly from the frame base member 102.2.4.2 on the left and right extents of the head portion 10.1 at or near the intermediate extent 102.2.41 of the support frame 102.2.4. The frame base member 102.2.4.2 and the left and right frame walls 102.2.4.6 cooperate to define the upper edge 102.2.4.8 of the support frame 102.2.4, while the frame base member 102.2.4.2 defines the entirety of the lower edge 102.2.4.10 as shown in FIGS. 24-28.

The frame base member 102.2.4.2 is formed to include: (i) an outer rim section 102.2.4.2.4 and (ii) a mounting section 102.2.4.2.6 as shown in FIGS. 24-28. The outer rim section 102.2.4.2.4 extends around the front, rear, left, and right extents of the head portion 10.1 to form an opening 102.2.4.2.2. The outer rim section 102.2.4.2.4 is visible when the upper securement member 102.2.6 of the neck portion 10.2 is attached to the support frame 102.2.4. The mounting section 102.2.4.2.6 extends downward from at least a portion of the outer rim section 102.2.4.2.4 and provides the attachment for the upper securement member 102.2.6 of the neck portion 10.2.

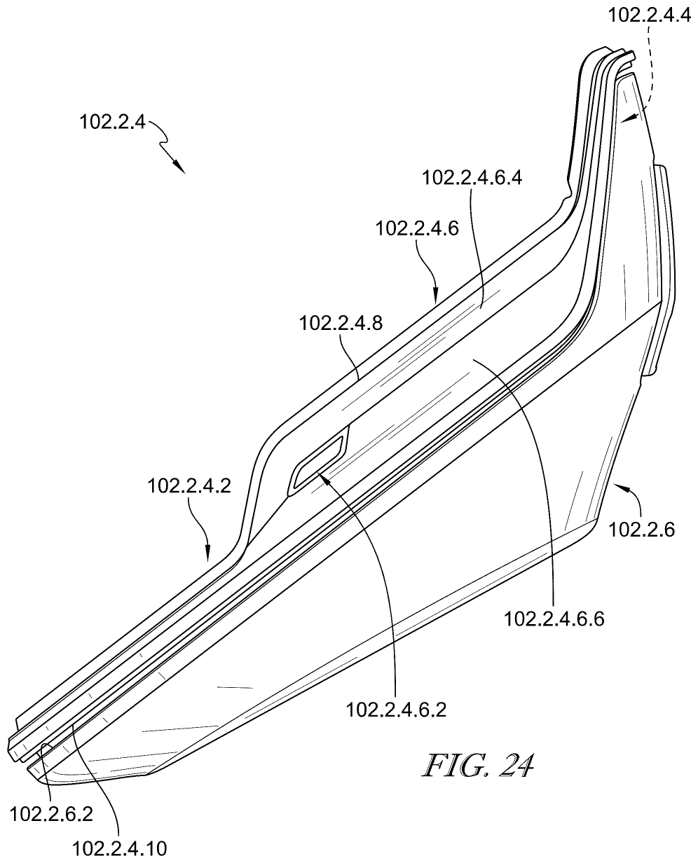

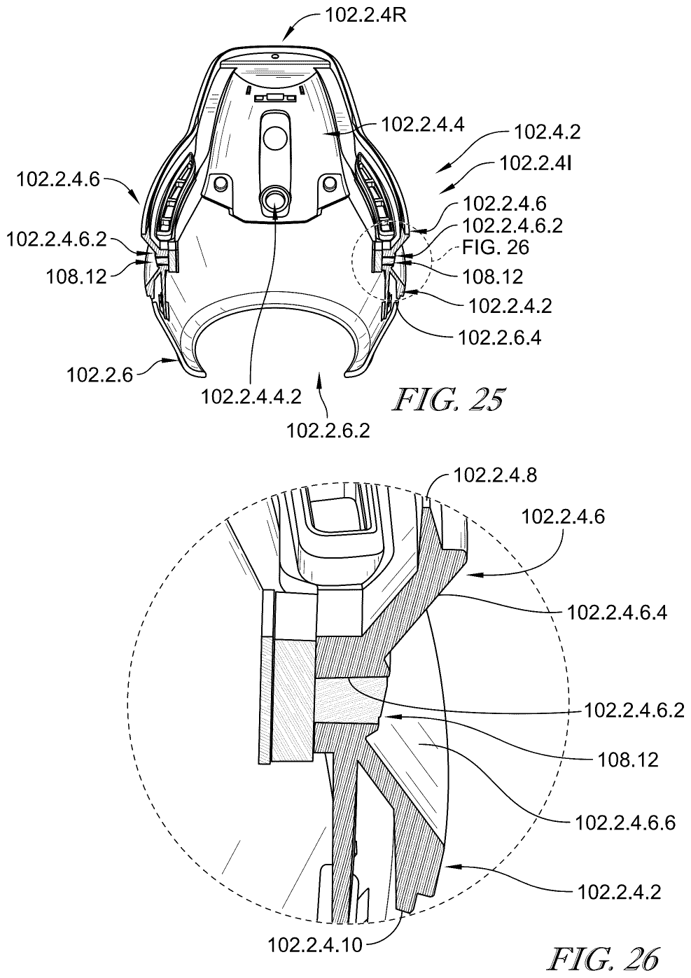

The back frame plate 102.2.4.4 is formed to define the sensor opening 102.2.4.4.2 as shown in FIGS. 25 and 27. The back plate 102.2.4.4 is shaped to define the rear extent 10.1.4 of the head portion 10.1. The upper securement member 102.2.6 of the neck portion 10.2 extends over and covers a majority of the back plate 102.2.4.4. As a result, a majority of the back plate 102.2.4.4 is not visible when the upper securement member 102.2.6 of the neck portion 10.2 is coupled to the support member 102.2.4. A portion of the back frame plate 102.2.4.4 formed to include the sensor opening 102.2.4.4.2 remains uncovered.

Each of the left and right frame walls 102.2.4.6 is formed to define the respective indicator opening 102.2.4.6.2 as shown in FIGS. 24-28. Each frame wall 102.2.4.6 has angled surfaces 102.2.4.6.4, 102.2.4.6.6 to allow space for vent openings 102.4.6.8. The angled surface 102.2.4.6.6 extends from the frame base member 102.2.4.2 and the other angled surface 102.2.4.6.4 extends from the surface 102.2.4.6.6 in an opposite direction to form the contour in the frame wall 102.2.4.6. The respective light emitter 108.12 is coupled to the left and right frame walls 102.2.4.6 as shown in FIGS. 24-28.

iii. Internal Support Assembly

As shown in FIGS. 6-28, the internal support assembly 104 includes: (i) an electronics mount or frame 102.2.2, (ii) a PCB mounting member 104.4, and (iii) an actuator mounting member 104.2. In other embodiments, the PCB mounting member 104.4 and the actuator mounting member 104.2 may be formed as one integrated component. Alternatively, said PCB mounting member 104.4 and the actuator mounting member 104.2 may be integrally formed with the support frame 102.2.4.

### 1. Electronics Mount

The electronics mount 102.2.2 is configured to cover, surround, or overlie a majority of the electronics assembly 108. As shown in FIGS. 6-28, the electronics mount 102.2.2 extends: (i) from a crown region (A1 and B1) of the head portion 10.1 to the chin region 10M, (ii) into the auricular region 10F, (iii) into the occipital region 10E, and (iv) into the lower extent of the parietal region 10A2. Like the shield 102.4, the electronics mount 102.2.2 is shaped with a curved surface to resemble a human head. In fact, the shape, radii, and curvature associated with the electronics mount 102.2.2 substantially match the shape, radii, and curvature associated with the shield 102.4, which is shown in FIGS. 6-28. This design enables the electronics mount 102.2.2 to act as a skull or a supporting member for the shield 102.4, which beneficially enables a thinner shield to be used than the shield that would have to be used if the mount 102.2.2 had a different configuration, provides rigid mounting locations for the cameras and antennas, and enables the displays to be positioned as close as possible to the shield 102.4.

As best shown in FIGS. 6-23, the electronics mount 102.2.2 has an angled and stepped lower edge 102.2.2.6.4.2 that: (i) starts in the lower parietal region 10A2 and above the occipital region 10E, (ii) continues sloping downward and forwardly as it passes through the occipital region 10E, mastoid region 10I, parotideomasseteric region 10J, and buccal region 10K, and (iii) ends in the chin region 10M. In particular, as shown in FIGS. 6-28, the electronics mount 102.2.2 has an angled and stepped lower edge 102.2.2.6.4.2 that extends at an angle relative to horizontal when the robot is in a normal vertical position, where the sagittal and coronal planes of the head are aligned with the sagittal and coronal planes (Ps, Pc) of the robot 1. The lower edge 102.2.2.6.4.2 is configured to interface with the support frame 102.2.4.

The electronics mount 102.2.2 is configured to include: (i) a plurality of display openings (e.g., for a front or forward-facing display 108.4.2, a right side display 108.4.4, and a left side display 108.4.6) that are configured to receive an extent of the displays that are contained in the electronics assembly 108, (ii) a plurality of sensor openings (e.g., for an upper camera 108.2.2, a lower camera 108.2.4, and a top camera 108.2.6) that are designed to receive at least one sensor of the electronics assembly 108, and (iii) mounts for the sensors and displays (e.g., sensor mounts 102.2.2.8.2, 102.2.2.8.4, 102.2.2.8.6 and display mounts 102.2.2.10) of the electronics assembly 108. In particular and as shown in FIGS. 6-28, the: (i) plurality of display openings formed in the electronics mount 102.2.2 includes three display openings 102.2.2.6.2.2, 102.2.2.6.2.4, 102.2.2.6.2.6 and (ii) the plurality of sensor openings formed in the electronics mount 102.2.2 includes five sensor openings 102.2.2.4.2, 102.2.2.4.4, 102.2.2.4.6, 102.2.2.4.10, 102.2.2.4.12. In other embodiments, the electronics mount 102.2.2 may include more or fewer openings depending on the number of displays and sensors. For example, the sensor openings 102.2.2.4.10, 102.2.2.4.12 on the left and right sides of the head portion 10.1 may be omitted.

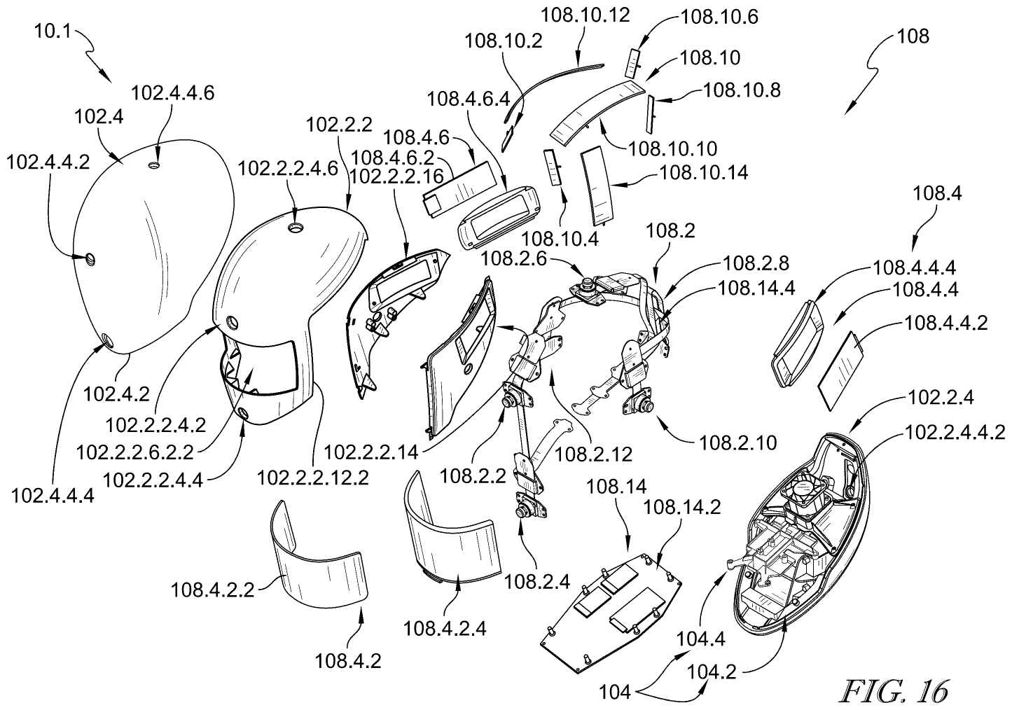

The display openings in the electronics mount 102.2.2 include: (i) a front display opening 102.2.2.6.2.2 located in or near the orbital region 10D, the nasal region 10N, and the oral region 10L of the head portion 10.1, (ii) a first side display opening 102.2.2.6.2.4 located in or near the parietal region 10A2 and the temporal region 10C of the head on the right side of the head portion 10.1, and (iii) a second side display opening 102.2.2.6.2.6 located in or near the parietal region 10A2 and the temporal region 10C of the head on the left side of the head portion 10.1 opposite the first side display opening 102.2.2.6.2.4 as shown in FIG. 16. The front display opening 102.2.2.6.2.2 takes up some or most of the orbital, nasal, and oral regions 10D, 10N, 10L of the head such that the front display 108.4.2 is the front face of the robot's head portion 10.1. In other embodiments, the front display opening 102.2.2.6.2.2 may take up (i) the orbital region 10D only, (ii) the orbital and nasal regions 10D, 10N, or (iii) the orbital and nasal regions 10D, 10N and part of the frontal region 10B1, 10B2. The side display openings 102.2.2.6.2.4, 102.2.2.6.2.6 are located above the auricular region 10F of the head.

As shown in FIGS. 16-23, the electronics mount 102.2.2 has sensor mounts 102.2.2.8.2, 102.2.2.8.4, 102.2.2.8.6, 102.2.2.8.10, 102.2.2.8.12 and at least one display mount 102.2.2.10 to properly position the sensors 108.2.2, 108.2.4, 108.2.6 and displays 108.4.2, 108.4.4, 108.4.6 within the sensor and display openings in the electronics mount 102.2.2. In other embodiments, the sensors and displays may be mounted to a PCB mounting member 104.4 instead of the electronics mount 102.2.2. The sensor mounts 102.2.2.8.2, 102.2.2.8.4, 102.2.2.8.6, 102.2.2.8.10, 102.2.2.8.12 are located in the respective regions of the sensor openings 102.2.2.4.2, 102.2.2.4.4, 102.2.2.4.6, 102.2.2.4.10, 102.2.2.4.12. The display mount 102.2.2.10 is below the front display 108.4.2.

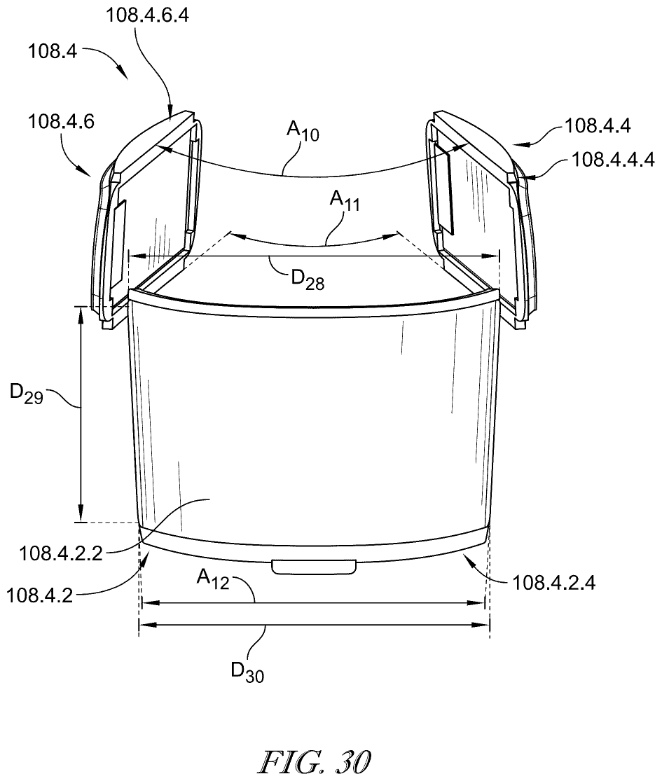

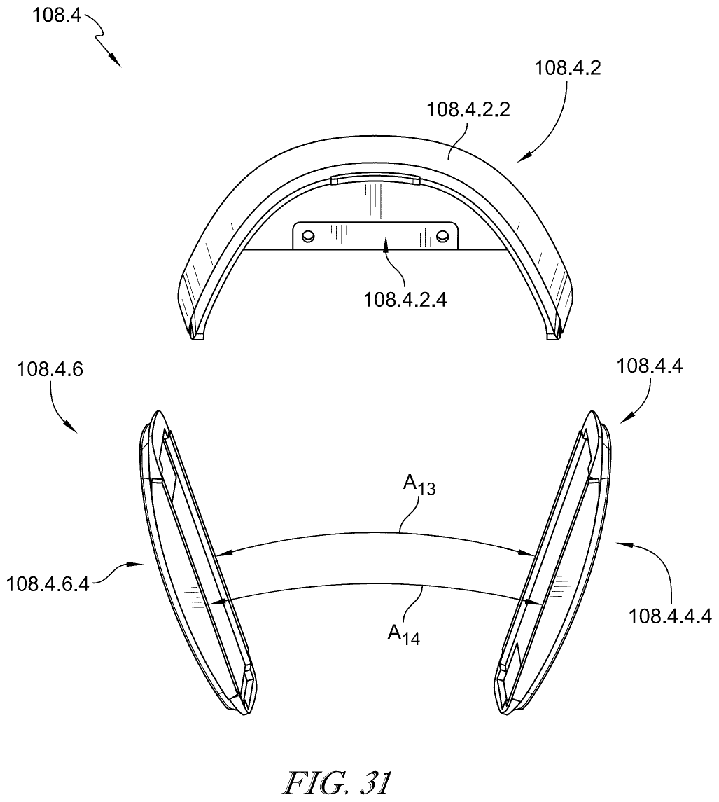

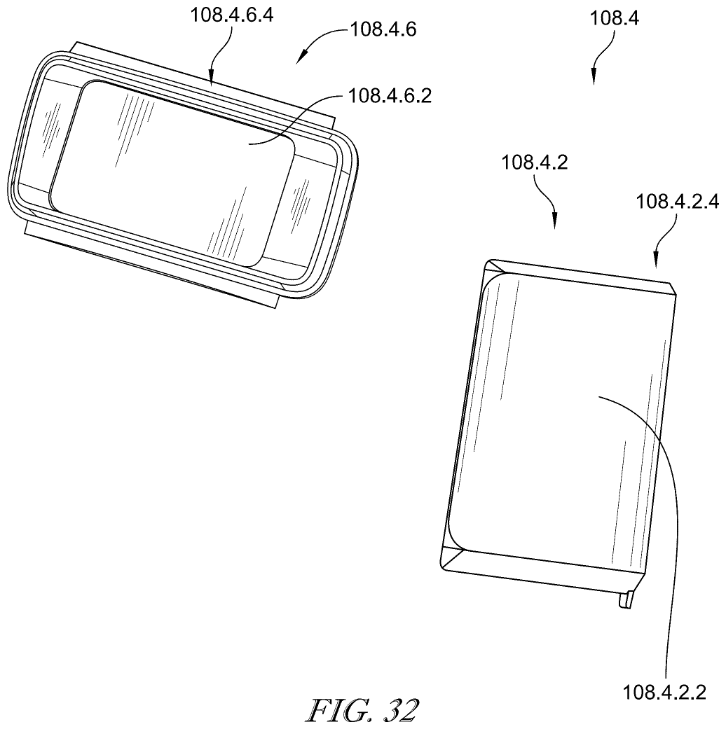

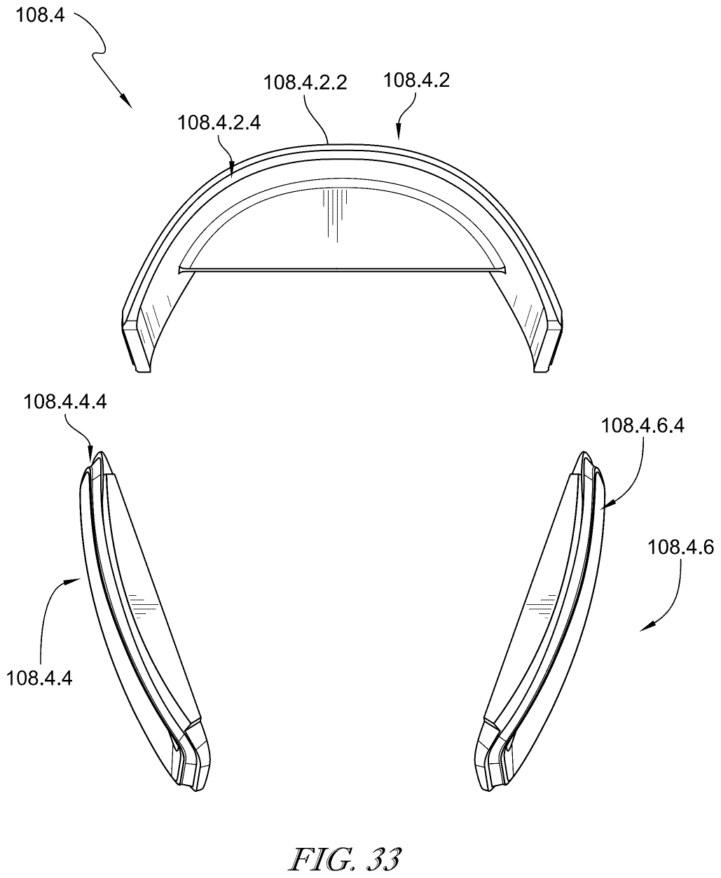

As shown in FIGS. 29-33, the front display 108.4.2 may be substantially rectangular and may have a curvilinear screen. The opening 102.2.2.6.2.2 for the front display 108.4.2 formed in the electronics mount 102.2.2 may be shaped with contours around said display opening 102.2.2.6.2.2 to receive the curved shape of the display 108.4.2 without obstructing the view. The electronics mount 102.2.2 may taper and/or include additional contours between the display opening 102.2.2.6.2.2 and the rim 102.2.2.6.4. The side displays 108.4.4, 108.4.6 may be rectangular with no curvature such that the left and right-side displays 108.4.4, 108.4.6 are planar as shown in FIGS. 29-33. Alternatively, the side displays 108.4.4, 108.4.6 may have a curvature like the front display 108.4.2 to match or mimic the shape/curvature of the head portion 10.1; however, the curvature may be less than the curvature of the front display 108.4.2. The openings 102.2.2.6.2.4, 102.2.2.6.2.6 for displays 108.4.4, 108.4.6 formed in the electronics mount 102.2.2 may be shaped with contours around said display openings to receive the displays without obstructing the view.

The sensor openings in the electronics mount 102.2.2 include: (i) an upper sensor opening 102.2.2.4.2 located in or near the frontal region 10B2 of the head portion 10.1, (ii) a lower sensor opening 102.2.2.4.4 located in or near the oral region 10L and the mental region 10M of the head portion 10.1, (iii) a top sensor opening 102.2.2.4.6 located on the top of the head portion 10.1 in or near the parietal region 10A1, 10A2 of the head portion 10.1, (iv) a left-side sensor opening 102.2.2.4.10 located on a left side of the head portion 10.1 in or near the temporal region 10C or the auricular region 10F of the head portion 10.1, and (v) a right-side sensor opening 102.2.2.4.12 located on a right side of the head portion 10.1 in or near the temporal region 10C or the auricular region 10F of the head portion 10.1 as shown in FIGS. 6-28. The upper, lower, and top sensor openings 102.2.2.4.2, 102.2.2.4.4, 102.2.2.4.6 in the electronics mount 102.2.2 are vertically aligned in the sagittal plane (Ps) of the robot (and the head portion 10.1) when the robot (or head portion 10.1) is in a natural or original upright position, as shown in FIGS. 6-28. In particular, the upper, lower, and top sensor openings 102.2.2.4.2, 102.2.2.4.4, 102.2.2.4.6 are horizontally centered in the head portion 10.1, but are not vertically centered in the head. Instead, said upper and lower sensor openings 102.2.2.4.2, 102.2.2.4.4, are vertically positioned relative to the center of the head or moved towards the chin portion (i.e., the mental region 10M) of said head portion 10.1, while said top opening 102.2.2.4.6 is at the top of the head. The left-side and right-side sensor openings 102.2.2.4.10, 102.2.2.4.12 in the electronics mount 102.2.2 are substantially aligned in the coronal plane (Pc) of the robot (and the head portion 10.1) when the robot (or head portion 10.1) is in a natural or original upright position as shown in FIGS. 6-28.

As discussed above, the electronics mount 102.2.2 may be opaque or may have regions that are opaque to help hide the electronics within the head housing 102. Additionally, the electronics mount 102.2.2 may be injection molded or 3D printed and may include any known polymer material or other material, including urethanes, PMMA, ABS, nylons, polyamides, polycarbonate (PC), polypropylene (PP), high-density polyethylene (HDPE), polystyrene (PS), polyvinyl chloride (PVC), thermoplastic elastomers (TPE), polyethylene terephthalate (PET), polybutylene terephthalate (PBT), polyoxymethylene (POM or acetal), epoxy resins, silicone rubber, polyimides (PI), acrylics, polyethylene (PE), liquid crystal polymers (LCP), phenolic resins, glass-filled nylons, carbon fiber reinforced plastics (CFRP), glass fiber reinforced plastics (GFRP), thermoplastic polyurethane (TPU), metal-plastic hybrids, biodegradable plastics (e.g., PLA), conductive polymers (e.g., PANI), any combination thereof, or any other similar material. Further, it should be noted that the electronics mount 102.2.2 may include nuts or threaded fasteners that are molded or secured within the electronics mount 102.2.2 during the formation of said electronics mount 102.2.2.

As shown in FIGS. 16-23, the electronics mount 102.2.2 is modular and subdivided into multiple pieces. The electronics mount 102.2.2 includes: (i) a main section 102.2.2.12 and (ii) display housing sections 102.2.2.14, 102.2.2.16 as shown in FIGS. 16-23. The main section 102.2.2.12 of the electronics mount 102.2.2 extends: (i) from a crown region (A1 and B1) of the head portion 10.1 to the chin region 10M, (ii) around the auricular region 10F, (iii) around the occipital region 10E, and (iv) around the lower extent of the parietal region 10A2. In other words, the main section 102.2.2.12 does not form part of the rear shape of the head. Rather, the display housing sections 102.2.2.14, 102.2.2.16 form or extend into the auricular region 10F, the occipital region 10E, and the lower extent of the parietal region 10A2. Together the different sections enable the electronics mount 102.2.2 to act as a skull or a supporting member for the shield 102.4. In other embodiments, the electronics mount 102.2.2 may be subdivided into more or fewer pieces.

As shown in FIGS. 16-23, the edges of the different sections 102.2.2.12, 102.2.2.14, 102.2.2.16 of the electronics mount 102.2.2 cooperate to form the lower edge 102.2.2.6.4.2 that is configured to interface with the support frame 102.2.4. The main section 102.2.2.12 has edges 102.2.2.12.2 that each interface with an edge 102.2.2.14.2, 102.2.2.16.2 of the corresponding display housing section 102.2.2.14, 102.2.2.16. Each of the edges 102.2.2.12.2 of the main section 102.2.2.12 (i) start in the lower parietal region 10A2 and above the occipital region 10E, (ii) continues sloping downward and forwardly as it passes through the forehead region 10B₂ and/or the temporal region 10C, (iii) extends downward from the forehead region 10B₂ and passes through the temporal region 10C, the zygomatic region 10G, the buccal region 10K, (iv) then continues extending downward and forwardly from the buccal region 10K, and (v) ends in the chin region 10M. The edges 102.2.2.14.4, 102.2.2.16.4 of the display housing sections 102.2.2.14, 102.2.2.16 cooperate with the edges 102.2.2.12.2 of the main section 102.2.2.12. The edges 102.2.2.14.4, 102.2.2.16.4 (i) start in the lower parietal region 10A2 and above the occipital region 10E, (ii) continues sloping downward and forwardly as it passes through the occipital region 10E, the auricular region 10F, the mastoid region 10I, the parotideomasseteric region 10J, the buccal region 10K, and (iii) ends in the chin region 10M.

The main section 102.2.2.12 of the electronics mount 102.2.2 is configured to include: (i) the front display opening 102.2.2.6.2.2 located in or near the orbital region 10D, the nasal region 10N, and the oral region 10L of the head portion 10.1 that is configured to receive an extent of the front display 108.4.2 in the electronics assembly, (ii) the upper, lower, and top sensor openings 102.2.2.4.2, 102.2.2.4.4, 102.2.2.4.6 that are designed to receive at least one sensor of the electronics assembly 108, and (iii) mounts for the sensors and displays (e.g., sensor mounts 102.2.2.8.2, 102.2.2.8.4, 102.2.2.8.6 and display mounts 102.2.2.10) of the electronics assembly. The display housing sections 102.2.2.14, 102.2.2.16 of the electronics mount 102.2.2 are each configured to include: (i) the display opening 102.2.2.6.2.4, 102.2.2.6.2.6 that is configured to receive an extent of a display that is contained in the electronics assembly and (ii) the left-side and right-side sensor openings 102.2.2.4.10, 102.2.2.4.12 that are configured to receive at least one sensor of the electronics assembly 108. The display surfaces 108.4.4.2, 108.4.6.2 of the left and right-side displays 108.4.4, 108.4.6 may be flat or planar. In other embodiments, said side displays 108.4.4, 108.4.6 may have a convex curvature that conforms with the curvature of the housing sections 102.2.2.14, 102.2.2.16.

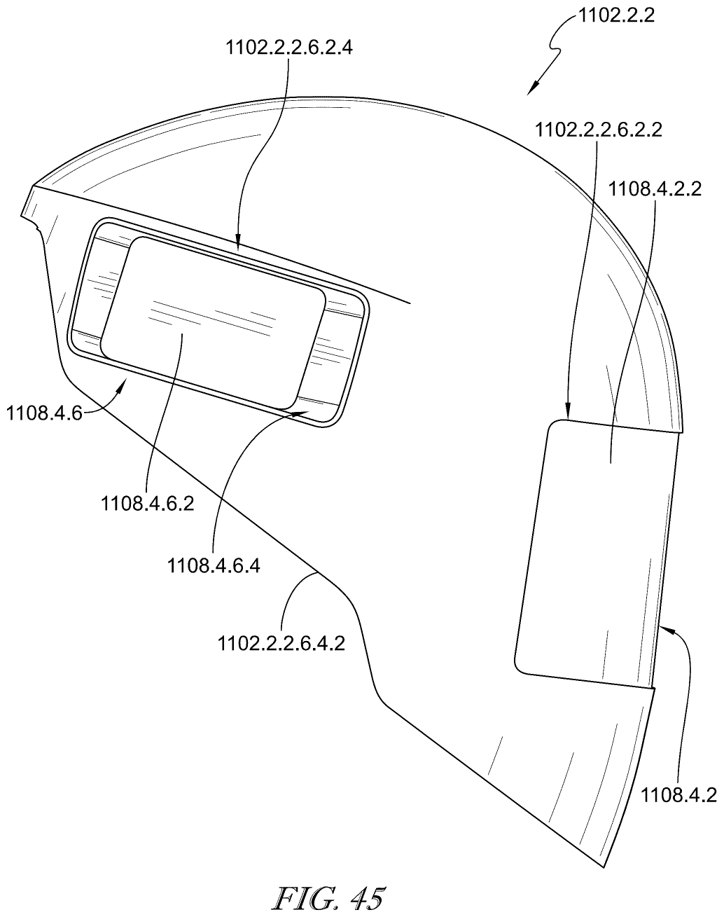

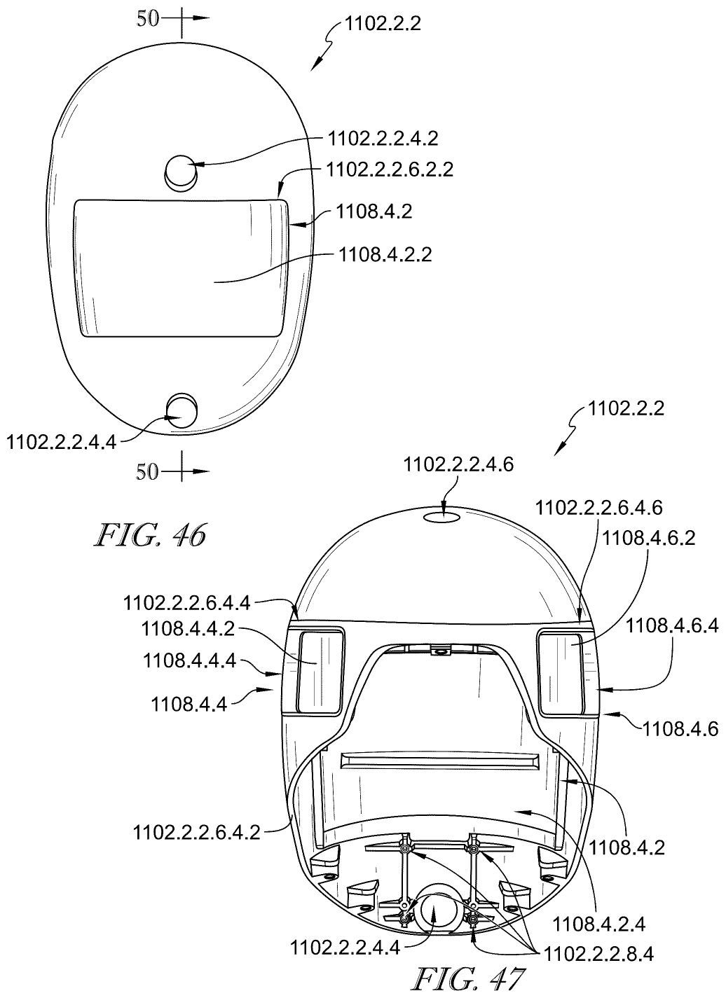

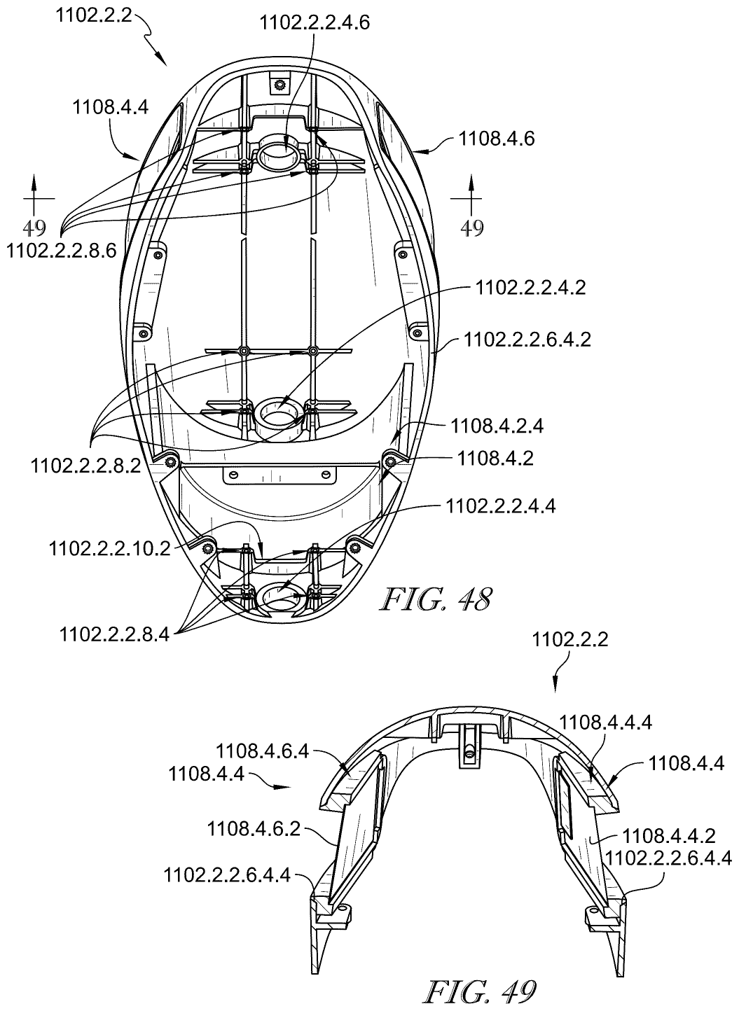

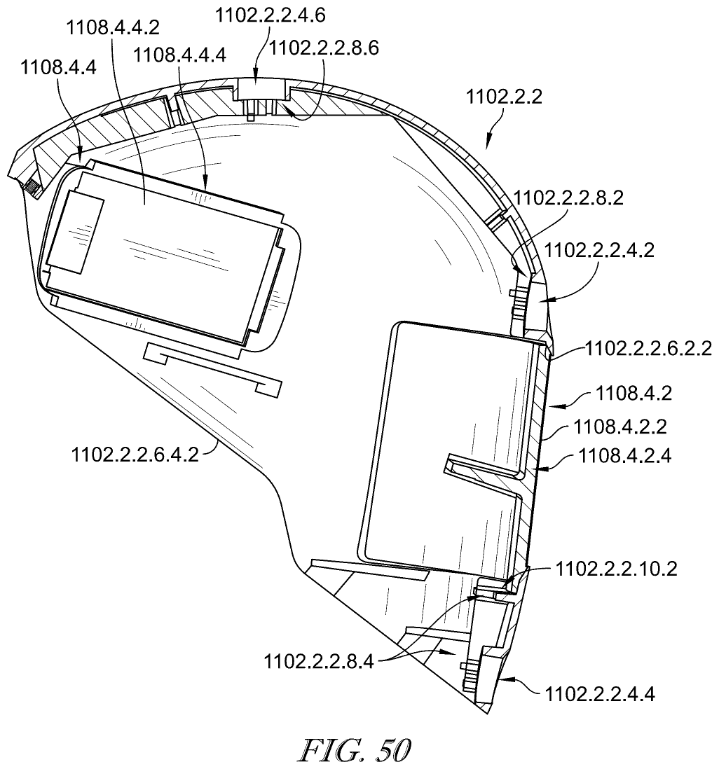

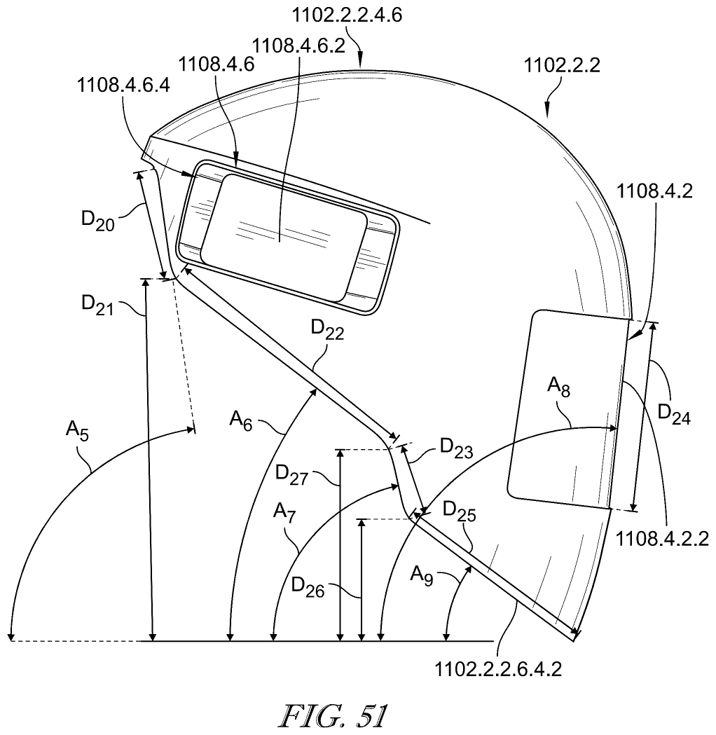

As shown in FIGS. 45-51, another embodiment of the electronics mount 1102.2.2 is a single piece component. The single piece electronics mount 1102.2.2 is configured to include: (i) a plurality of display openings 102.2.2.6.2.2, 102.2.2.6.2.4, 102.2.2.6.2.6 for the displays (e.g., front display 1108.4.2, right side display 1108.4.4, left side display 1108.4.6), (ii) a plurality of sensor openings 102.2.2.4.2, 102.2.2.4.4, 102.2.2.4.6, 102.2.2.4.10, 102.2.2.4.12 for the sensors (e.g., upper camera 108.2.2, lower camera 108.2.4, top camera 108.2.6, left-side camera 108.2.10, and right-side camera 108.2.12), and (iii) mounts for the sensors and displays (e.g., sensor mounts 102.2.2.8.2, 102.2.2.8.4, 102.2.2.8.6 and display mounts 102.2.2.10) of the electronics assembly 108. The electronics mount 1102.2.2 also defines the entire angled and stepped lower edge 102.2.2.6.4.2 that: (i) starts in the lower parietal region 10A2 and above the occipital region 10E, (ii) continues sloping downward and forwardly as it passes through the occipital region 10E, mastoid region 10I, parotideomasseteric region 10J, and buccal region 10K, and (iii) ends in the chin region 10M.

### 2. Other Mounting Members

Other mounting members that are coupled to the electronics mount 102.2.2 and/or the support frame 102.2.4 include: (i) the PCB mounting member 104.4, and (ii) the actuator mounting member 104.2. The actuator mounting member or actuator coupler 104.2 provides structural support connecting the head portion 10.1 to the torso 16 and couples the actuators to the support frame 102.2.4 to enable the actuators to move the head portion 10.1. The PCB mounting member 104.4 is coupled to the support frame 102.2.4 and includes a plurality of mounting surfaces and coupling features configured to couple the components of the electronics assembly 108 and the housing 102. The PCB mounting member 104.4 and the components coupled thereto are configured to move as a unit as actuator J8.2 moves, including during a twist movement driven by actuator J8.1.

iv. Electronics Assembly

The electronics assembly 108 contained in the head portion 10.1 may include: (i) a sensor assembly 108.2, (ii) a display assembly 108.4, (iii) an antenna assembly 108.10, (iv) an illumination assembly that includes at least one, and preferably a plurality of light emitters 108.12, and (v) other electronics (e.g., IMU, RFID reader, location sensors (e.g., Global Positioning System (“GPS”), GLONASS, Galileo, QZSS, and/or iBeacon), etc.), and/or PCBs for connecting said electronics.

As shown in at least FIG. 19, the components of the electronics assembly 108 may be mounted to the PCB mounting member 104.4. Alternatively, or additionally, some of the components of the electronics assembly 108 may be mounted to the electronics mount 102.2.2. For example, the sensors may be mounted to the electronics mount 102.2.2 to align the sensors with the respective sensor openings 102.2.2.4.2, 102.2.2.4.4, 102.2.2.4.6, 102.2.2.4.10, 102.2.2.4.12. As noted above, the housing 102 is configured to enclose the electronics assembly 108 without interfering with the transmission or reception of signals. For example, the housing 102 does not obscure, or may be designed to minimize interference with, the transmission of signals in and out of the head portion 10.1.

### 1. Sensor Assembly

The sensor assembly 108.2 may include one or more cameras, temperature sensors, pressure sensors, force sensors, inductive sensors, capacitive sensors, ultrasonic sensors, infrared sensors, proximity sensors, microphones, gas sensors, light sensors (photodiodes, phototransistors), UV sensors, time-of-flight sensors, LiDAR sensors, optical flow sensors, RFID readers, laser rangefinders, 3D depth cameras, or any combination of these sensors or other known sensors. In the illustrative example, the sensor assembly 108.2 includes an upper camera 108.2.2, a lower camera 108.2.4, a top camera 108.2.6, a rear camera 108.2.8, a left-side camera 108.2.10, and a right-side camera 108.2.12 coupled to the internal support assembly at respective mounting positions.

For example, the upper camera 108.2.2 may be positioned above the front display 108.4.2, and the lower camera 108.2.4 may be positioned below the front display 108.4.2, with both directed in a substantially forward direction. The left-side camera 108.2.10 may be positioned below and forward of the left-side display 108.4.6 and the right-side camera 108.2.12 may be positioned below and forward of the right-side display 108.4.4. The top camera 108.2.6 may be positioned at or near the top of the head portion 10.1, facing in a substantially upward direction. The rear camera 108.2.8 may be positioned on the rear of the head portion 10.1, facing in a substantially rearward direction opposite the forward direction.

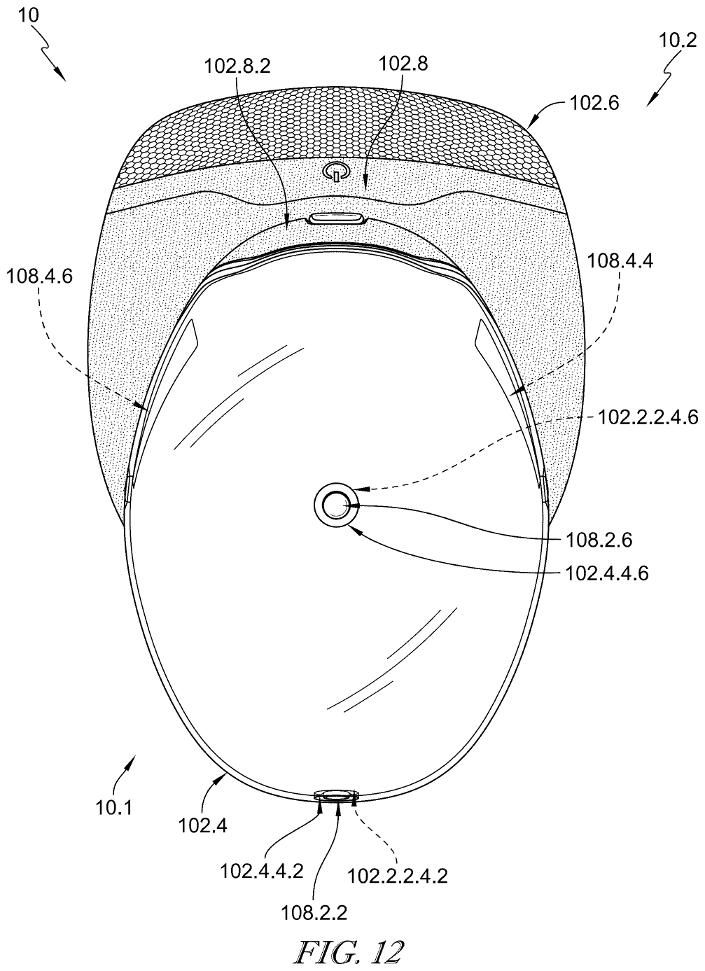

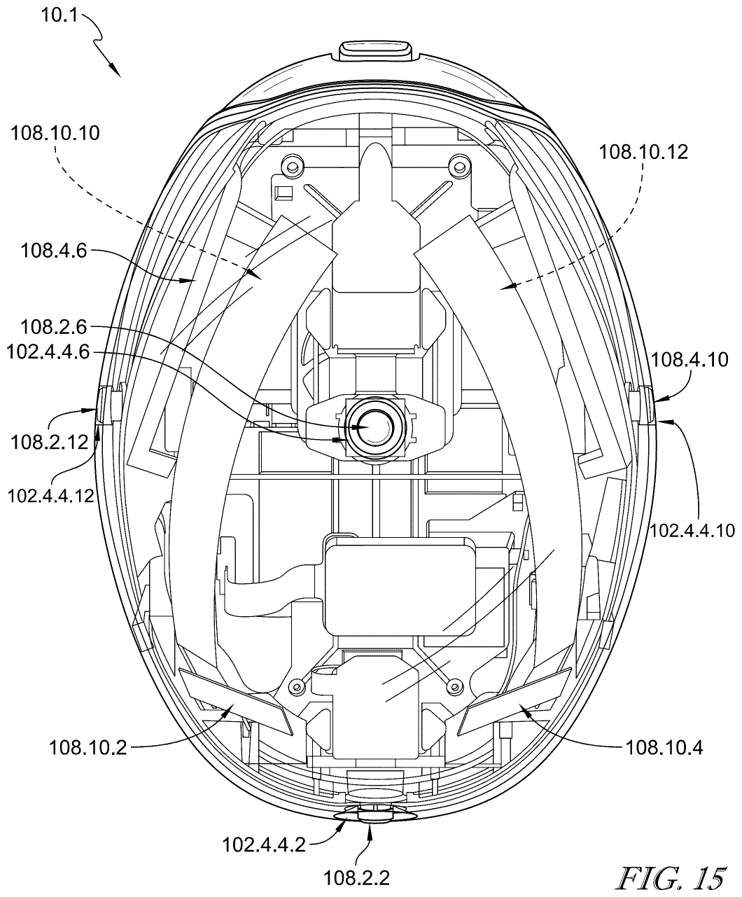

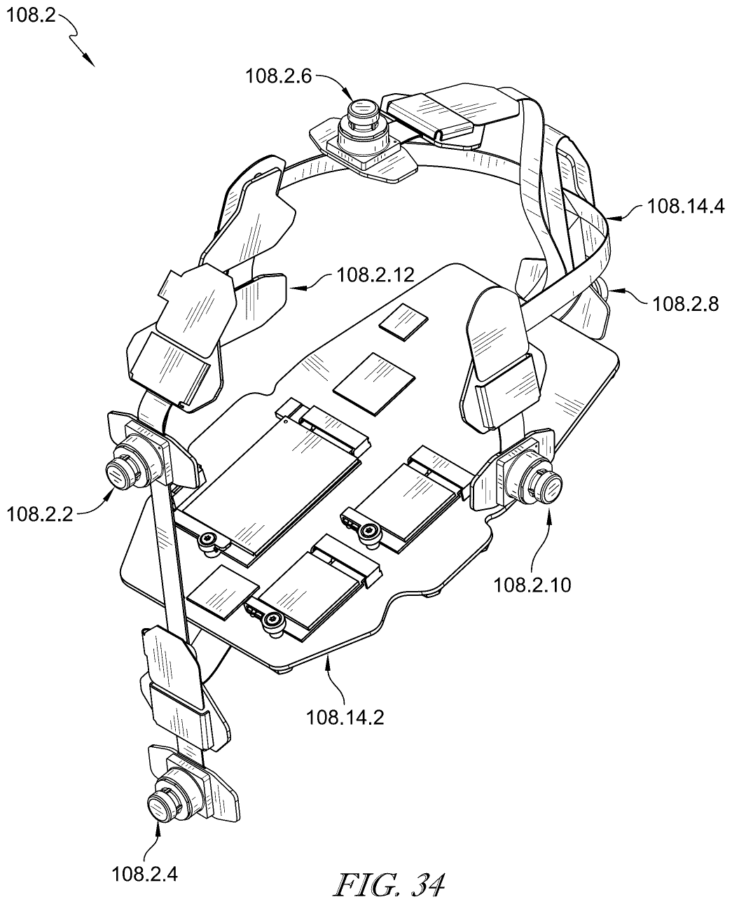

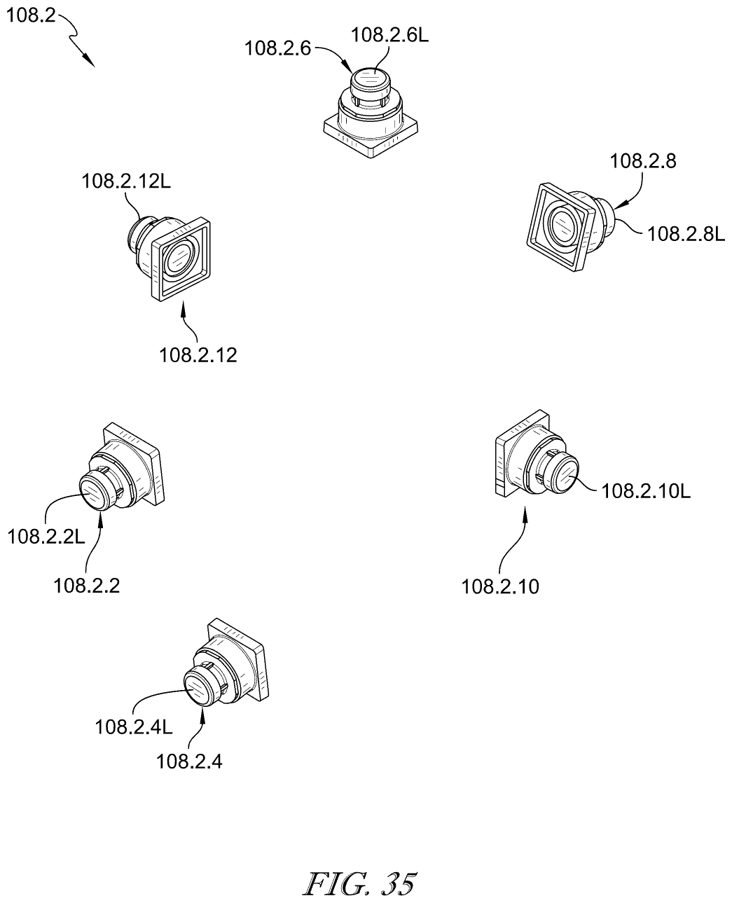

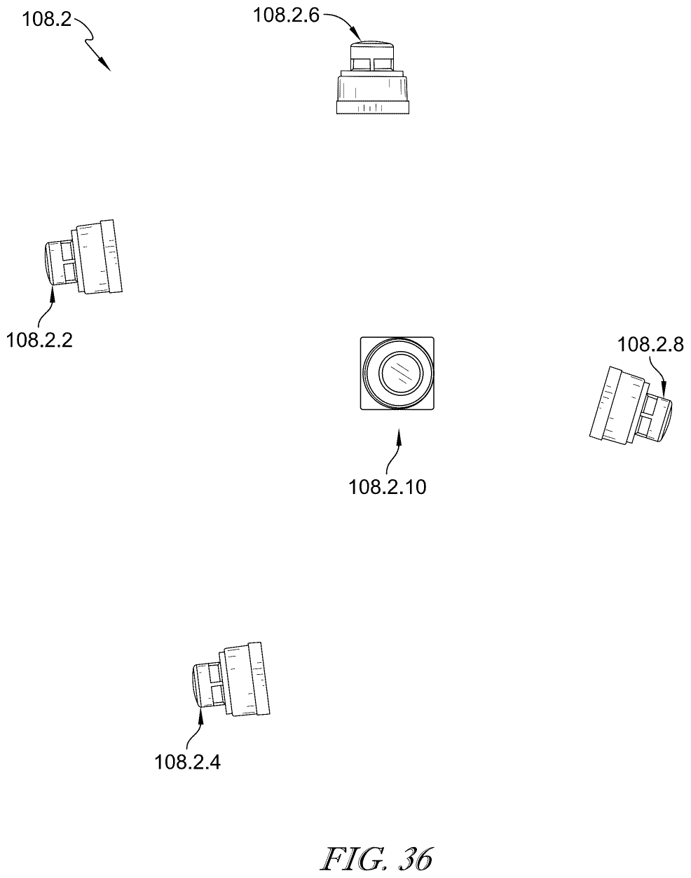

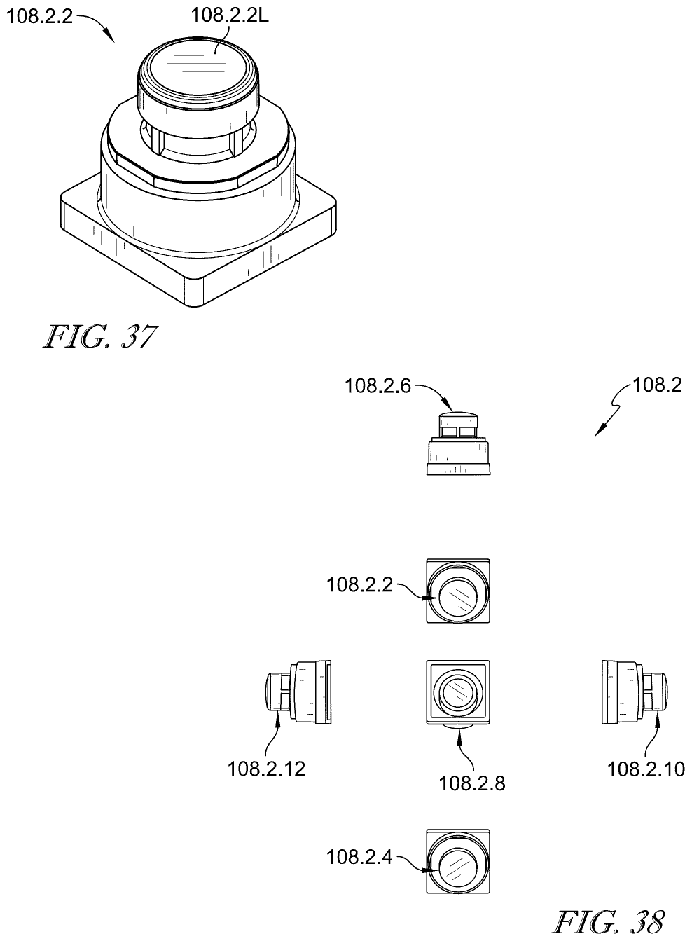

As shown in FIGS. 34-38, the upper camera 108.2.2, the lower camera 108.2.4, and the rear camera 108.2.8 may be arranged in a vertical orientation. The upper, lower, and rear cameras 108.2.2, 108.2.4, 108.2.8 may be placed at the same angle relative to the horizontal plane or transverse plane (P_{T}) in some embodiments. In other embodiments, the upper, lower, and rear cameras 108.2.2, 108.2.4, 108.2.8 may be placed at different angles relative to the horizontal plane or transverse plane (P_{T}). For example, the upper and lower cameras 108.2.2, 108.2.4 may be positioned at a slight downward angle of about 6.0 to about 9.0 degrees, or about 6.7 to about 8.2 degrees with respect to the horizontal plane or transverse plane (P_{T}). the rear camera 108.2.8 may be positioned at a downward angle of about 14 to about 22 degrees, or about 14.4 to about 21.6 degrees with respect to the horizontal plane or transverse plane (PT). The top camera 108.2.6 may be arranged in the horizontal plane or transverse plane (PT) as shown in FIGS. 12 and 15.

The lenses 108.2.2L, 108.2.4L, 108.2.6L, 108.2.10L, 108.2.12L of each of the upper, lower, top, left-side and right-side cameras 108.2.2, 108.2.4, 108.2.6, 108.2.10, 108.2.12 can be received within the respective sensor openings 102.2.2.4.2, 102.2.2.4.4, 102.2.2.4.6, 102.2.2.4.10, 102.2.2.4.12 of the electronics mount 102.2.2. The lens 108.2.8L of the rear camera 108.2.8 can be received within the respective sensor opening 102.2.4.4.2 of the support frame 102.2.4.

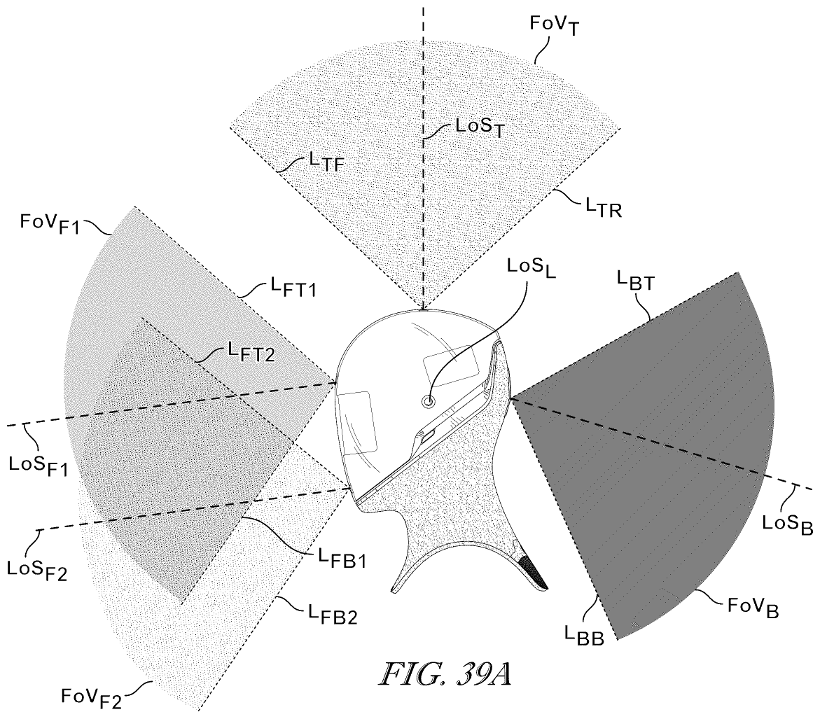

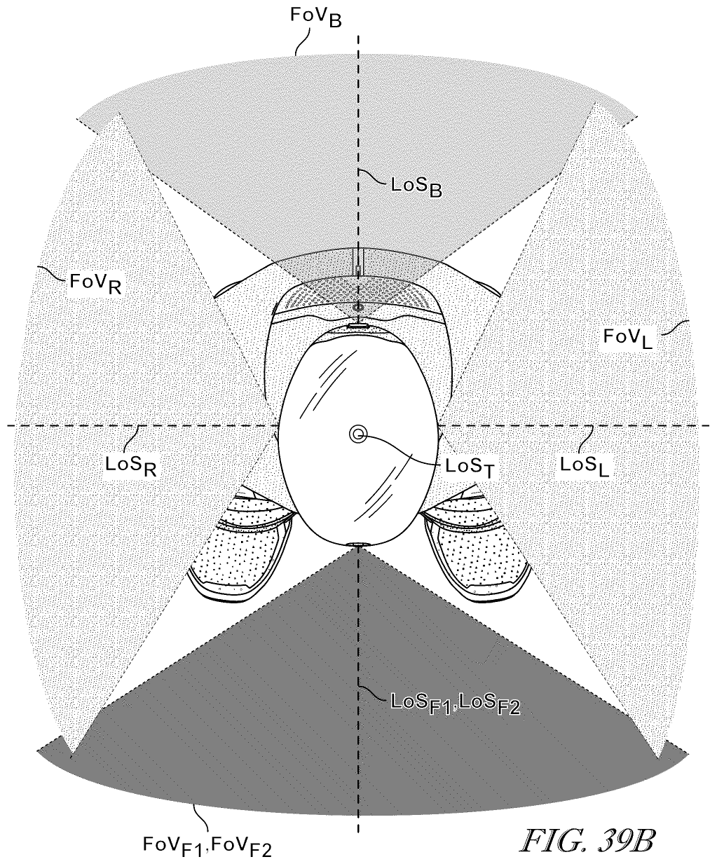

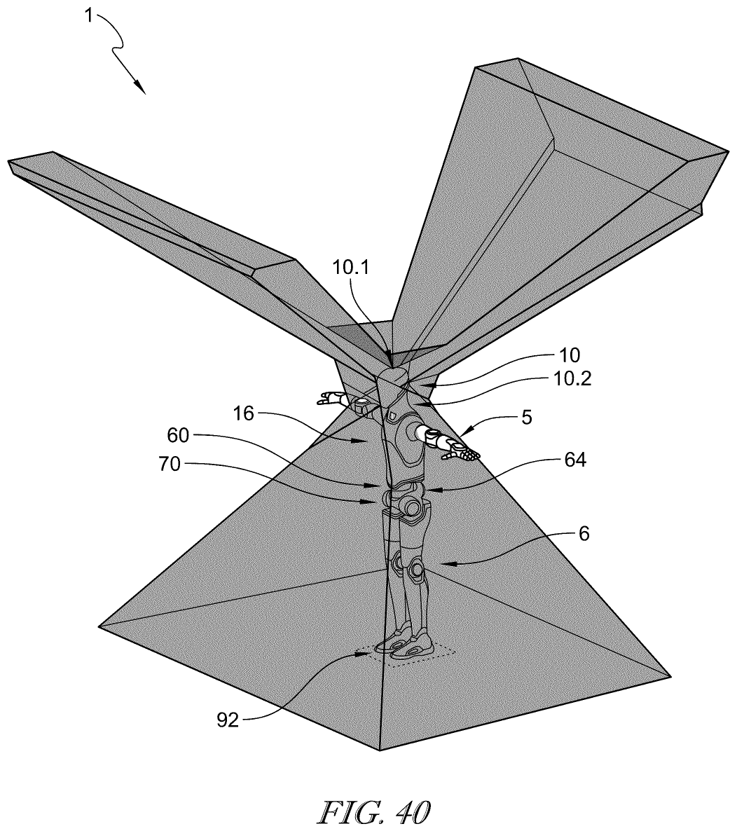

The upper and lower cameras 108.2.2, 108.2.4 are primarily for tasks, providing a field of view in front of the robot, while the rear camera 108.2.8 is primarily for situational awareness and localization of the robot 1, providing a field of view behind the robot. The top camera 108.2.6, the left-side camera 108.2.10, and the right-side camera 108.2.12 also assist with localization of the robot 1. The cameras 108.2.2, 108.2.4, 108.2.6, 108.2.8, 108.2.10, 108.2.12 are not 360-degree cameras and have restricted fields of view as shown in FIG. 39. Examples of the fields of view of the upper camera 108.2.2, the lower camera 108.2.4, the top camera 108.2.6, the rear camera 108.2.8, the left-side camera 108.2.10, and the right-side camera 108.2.12 are shown in FIG. 39. Examples of the blind spots of the upper camera 108.2.2, the lower camera 108.2.4, the top camera 108.2.6, the rear camera 108.2.8, the left-side camera 108.2.10, and the right-side camera 108.2.12 are shown in FIG. 40.

The positions of the cameras 108.2.2, 108.2.4, 108.2.6, 108.2.8, 108.2.10, 108.2.12 may be altered to provide a fuller field of view and minimize blind spots. For example, the angles of the upper camera 108.2.2, the lower camera 108.2.4, the top camera 108.2.6, and the rear camera 108.2.8 may be adjusted to provide a fuller field of view and minimize blind spots or dead space. The angles of the left-side camera 108.2.10 and the right-side camera 108.2.12 may be adjusted to provide a fuller field of view and help minimize blind spots or dead space. Positioning the camera sensors 108.2.2, 108.2.4, 108.2.6, 108.2.8, 108.2.10, 108.2.12 on the robot's head 10.1 also allows for movement of the sensors 108.2.2, 108.2.4, 108.2.6, 108.2.8, 108.2.10, 108.2.12 for better viewing with less movement of the overall robot 1. By moving the robot's head 10.1 up and down and rotating the head 10.1 left and right, the target image within the fields of view of the cameras 108.2.2, 108.2.4, 108.2.6, 108.2.8, 108.2.10, 108.2.12 is changed and provides a larger, derivative field of view from the sensor assembly 108.2.

Positioning the camera sensors on the robot's head portion 10.1 also allows for movement of the sensors for better viewing with less movement of the overall robot 1. By moving the robot's head portion 10.1 up and down and rotating the head portion 10.1 left and right, the target image within the fields of view of the cameras is changed and provides a larger, derivative field of view from the sensor assembly 108.2. The robot 1 may move its head up and down by bending at the neck to adjust the orientation of the cameras 108.2.2, 108.2.4, 108.2.6, 108.2.8, 108.2.10, 108.2.12. For example, the neck is able to bend up and down about +25 degrees, which allows the upper and lower cameras 108.2.2, 108.2.4 to view 200 mm in front of the robot's feet 92 and allows the rear camera 108.2.8 to view 400 mm behind the robot's feet 92. About 20 degrees of torso lean in the forward direction allows the upper and lower cameras 108.2.2, 108.2.4 to view the feet 92. The positions of the cameras 108.2.2, 108.2.4, 108.2.8 thus provide a closer or better view of the robot's feet 92 compared to cameras mounted to the torso 16 of the robot 1, because the fields of view of the upper and lower cameras 108.2.2, 108.2.4 are not entirely blocked by the robot's legs 6. The fields of view of cameras in the torso are completely blocked by the robot's thighs, while the fields of view of the upper and lower cameras 108.2.2, 108.2.4 are not.

The robot 1 may turn its head portion 10.1 left and right to adjust the orientation of the cameras 108.2.2, 108.2.4, 108.2.8, 108.2.10, 108.2.12. However, rotating the head portion 10.1 from left to right does not adjust the orientation of the top camera 108.2.6. The images or video recorded by the cameras 108.2.2, 108.2.4, 108.2.6, 108.2.8 may be combined or stitched together to produce a larger overall field of view from the sensor assembly 108.2.

A custom-built algorithm may be used to integrate the data from the vertically arranged upper, lower, top, rear, left-side, and right-side cameras 108.2.2, 108.2.4, 108.2.6, 108.2.8, 108.2.10, 108.2.12. Due to the fisheye lenses that are installed with the cameras 108.2.2, 108.2.4, 108.2.6, 108.2.8, 108.2.10, 108.2.12, the field of view of the robot 1 is increased over conventional lenses. However, the use of the fisheye lenses causes the image to be warped or distorted near the periphery of said image. This being said, the distortion of the image can be corrected or partially corrected by the custom-built algorithm to help increase data extraction in these regions. In other embodiments, the fisheye lenses that are currently shown in the figures may be replaced with other lens types (e.g., standard or non-fisheye lens).

Although upper, lower, top, rear, left-side, and right-side cameras 108.2.2, 108.2.4, 108.2.6, 108.2.8, 108.2.10, 108.2.12 are shown as illustrative examples, other sensors may be relied on and coupled to the internal mounting frame in a similar manner to ensure proper directional positioning for respective detection, sensing, or signal reception. Said sensors may include: (i) scan camera(s), (ii) monochrome camera(s), (iii) color camera(s), (iv) CMOS camera(s), (v) CCD sensor(s) or camera(s) that include CCD sensor(s), (vi) camera(s) or sensor(s) that have rolling shutter or global shutter, (vii) other types of 2D digital camera(s), (viii) other types of 3D digital camera(s), (ix) camera(s) or sensor(s) that are capable of stereo vision, structured light, and laser triangulation, (x) sonar camera(s) or ultrasonic camera(s), (xi) infrared sensor(s) and/or infrared camera(s), (xii) radar sensor(s), (xiii) LiDAR, (xiv) other structured light sensors, camera(s), or technologies, (xv) dot projecting camera(s) or sensor(s), (xvi) Time-of-Flight (ToF) cameras, (xvii) hyperspectral cameras, (xviii) multispectral cameras, (xix) thermal imaging cameras, (xx) high-speed cameras, (xxi) panoramic cameras, (xxii) omnidirectional cameras, (xxiii) polarization cameras, (xxiv) plenoptic (light field) cameras, (xxv) depth-sensing cameras, (xxvi) ultraviolet (UV) cameras, (xxvii) single-photon avalanche diode (SPAD) cameras, (xxviii) electron-multiplying CCD (EMCCD) cameras, (xxix) short-wave infrared (SWIR) cameras, (xxx) medium-wave infrared (MWIR) cameras, (xxxi) long-wave infrared (LWIR) cameras, (xxxii) quantum dot cameras, (xxxiii) microbolometer cameras, (xxxiv) holographic cameras, (xxxv) optical coherence tomography (OCT) cameras, (xxxvi) spectral imaging cameras, (xxxvii) phase contrast cameras, (xxxviii) interferometric cameras, (xxxix) fiber optic cameras, (xl) terahertz cameras, (xli) millimeter-wave cameras, (xlii) acoustic cameras, (xliii) biometric cameras (e.g., iris recognition cameras), (xliv) artificial compound eye cameras, (xlv) volumetric capture cameras, (xlvi) computational photography cameras, (xlvii) smartphone cameras with advanced sensors, (xlviii) augmented reality (AR) and virtual reality (VR) cameras, (xlix) streak cameras, (1) burst-mode cameras, (li) LiFi (Light Fidelity) cameras, or any combination of the above or any other known camera or sensor. For example, said camera may have a megapixel resolution of between 0.4 MP to 20 MP, may record video at 5.6 FPS to 286 FPS, may have a CMOS sensor, pixel size may range from 2.4 μm to 6.9 μm, may utilize Starvis rolling shutter technology, can operate in 55 degree C. ambient air temperatures, and may have any other properties, technologies, or features that are discussed within U.S. Pat. Nos. 11,402,726, 11,599,009, 11,333,954, or 11,600,010, all of which are incorporated herein by reference. It should be understood that the cameras are typically configured as video cameras but may have an alternative configuration, such as an image camera.

The information from each of the upper, lower, top, rear, left-side, and right-side cameras 108.2.2, 108.2.4, 108.2.6, 108.2.8, 108.2.10, 108.2.12 may be used alone or in combination with the information from the other cameras 108.2.2, 108.2.4, 108.2.6, 108.2.8, 108.2.10, 108.2.12 and/or sensors included on the robot 1 to aid in the control of the robot 1. The information from the upper, lower, top, rear, left-side, and right-side cameras 108.2.2, 108.2.4, 108.2.6, 108.2.8, 108.2.10, 108.2.12 may be used to help the robot 1 navigate or locomote on different terrain, localize to different environments and plan routes, and sense and avoid obstacles. The upper, lower, top, rear, left-side, and right-side cameras 108.2.2, 108.2.4, 108.2.6, 108.2.8, 108.2.10, 108.2.12 may be utilized in similar ways or methods. that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated herein by reference. Other dimensions of said sensor assembly 108.2 are described in the figures and in the below tables. It should also be understood that additional embodiments or alterations to said sensor assembly 108.2 will be discussed below and said embodiments may be partially or fully combined with any of the above described embodiments.

### 2. Display Assembly

The display assembly 108.4 may include one or more displays. The displays may use any known technology or feature including, but not limited to: LCD, LED, OLED, LPD, IMOD, QDLED, mLED, AMOLED, SED, FED, plasma, electronic paper or EPD, MicroLED, quantum dot display, LED backlit LCD, WLCD, OLCD, transparent OLED, PMOLED, capacitive touchdisplay, resistive touchdisplay, monochrome, color, or any combination of the above, or any other known technology or display feature. In the illustrative example, the display assembly 108.4 includes a front display 108.4.2, a left-side display 108.4.6, and a right-side display 108.4.4 as shown in FIGS. 29-33. In other embodiments, the display assembly 108.4 may include fewer or a greater number of displays.

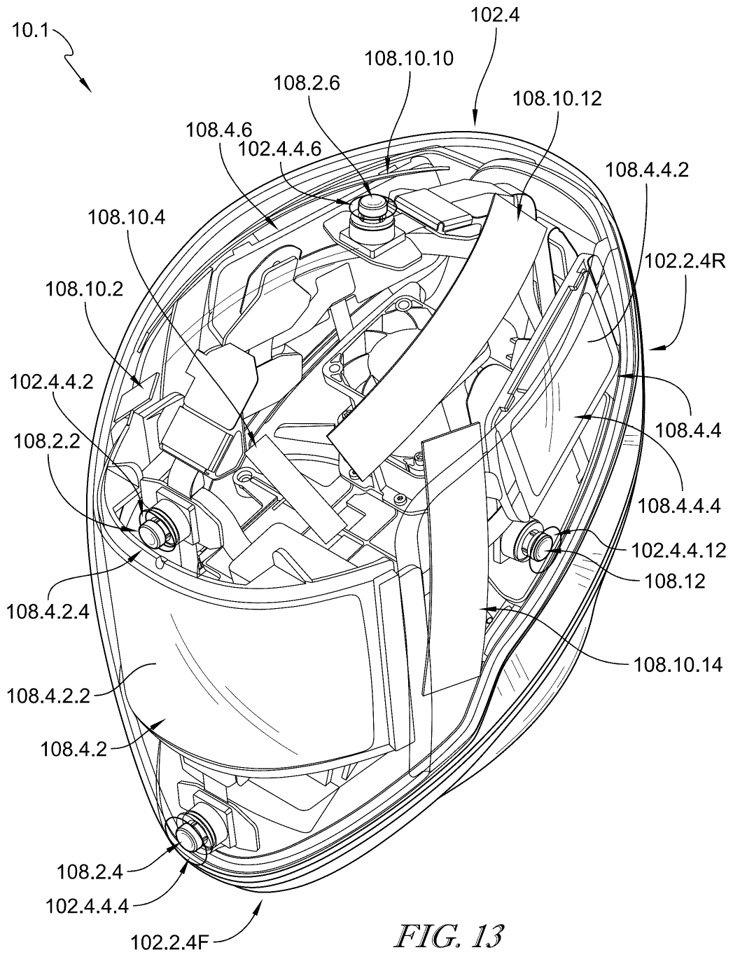

The displays 108.4.2, 108.4.4, 108.4.6 of the electronics assembly 108 may be mounted to the electronics mount 102.2.2 and positioned such that a display opening 102.2.2.6.2.2, 102.2.2.6.2.4, 102.2.2.6.2.6 of the electronics mount 102.2.2 surrounds each display 108.4.2, 108.4.4, 108.4.6. As shown in FIGS. 13-19 and 29-33, the front display 108.4.2 is mounted to the main section 102.2.2.12 of the electronics mount 102.2.2, and the side displays 108.4.4, 108.4.6 are mounted to the display housing sections 102.2.2.14, 102.2.2.16 of the electronics mount 102.2.2.

The displays 108.4.2, 108.4.4, 108.4.6 are operatively connected to at least one processor and are designed to display status messages and other information. For example, the displays 108.4.2, 108.4.4, 108.4.6 may display information: (i) related to the robot's state (e.g., working, error, moving, etc.), (ii) obtained from sensors contained within the head assembly 10 or on other portions of the robot 1, or (iii) received from other processors in communication with the display assembly 108.4 (e.g., other internal processors housed within the robot or external information transmitted and received by the robot). Said information may be displayed in the format of blocks, well-known shapes, logos, or other moving items (e.g., thought bubbles). However, said information may not be displayed in connection with human facial features (e.g., eyes, mouth, nose).

Each of the displays 108.4.2, 108.4.4, 108.4.6 may have a substantially rectangular display surface as shown in FIGS. 29-33. The display surface 108.4.2.2 of the front or main display 108.4.2 has a convex curvature that conforms with the curvature of the electronics mount 102.2.2 of the housing 102. The front display 108.4.2 may be slightly tilted downward to increase viewability and help eliminate reflections. The display surfaces 108.4.4.2, 108.4.6.2 of the left and right-side displays 108.4.4, 108.4.6 may be flat or planar. In other embodiments, said side displays 108.4.4, 108.4.6 may have a convex curvature that conforms with the curvature of the electronics mount 102.2.2 in some embodiments, and/or the display surface 108.4.2.2 of the front or main display 108.4.2 may be flat or planar.

The display housings 108.4.4.4, 108.4.6.4 of each display 108.4.4, 108.4.6 fit within the respective display opening 102.2.2.6.2.4, 102.2.2.6.2.6 of the electronics mount 102.2.2 such that the display surfaces are recessed relative to the outer surface of the electronics mount 102.2.2 as shown in FIGS. 16 and 19. The display housing 108.4.2.4 of the front display 108.4.2 matches the convex shape of its display surface 108.4.2.2. In the illustrative embodiment, the display opening 102.2.2.6.2.2 in the electronics mount 102.2.2 for the front display 108.4.2 is sized so that the display housing 108.4.2.4 engages the inside of the electronics mount 102.2.2.

In other embodiments, the display housings 108.4.4.4, 108.4.6.4 may be integral with the display housing sections 102.2.2.14, 102.2.2.16 of the electronics mount 102.2.2 instead of fitting within the respective display opening of the electronics mount. The display housing sections 102.2.2.14, 102.2.2.16 define a portion of the curvature of the head 10.1. The transparent front shield 102.4 allows the information displayed on the displays 108.4.2, 108.4.4, 108.4.6 to be viewed, but the position of the displays 108.4.2, 108.4.4, 108.4.6 relative to the shield 102.4 helps viewability and reduces or eliminates reflections.

It should be understood that this application contemplates the use of displays that have different sizes. Alternative display sizes may be used to: (i) reduce the surface area of fragile elements within the robot, (ii) because said robot is not designed to work near humans, (iii) additional area within the head is needed for sensors or other electronics, or (iv) any other reason known by one of skill in the art. The disclosed display may occupy the entire shield 102.4, between 100% and 75% of the shield, between 75% and 50% of the shield, between 50% and 25% of the shield, or less than 25% of the shield. In some examples, the display may utilize the full shield 102.4. The displays 108.4.2, 108.4.4, 108.4.6 may be curved in a single direction, in two directions (e.g., vertically and horizontally), or a freeform design that may include multiple curves. In certain embodiments, the shield 102.4 and the displays 108.4.2, 108.4.4, 108.4.6 may be integrated into a single unit. The size and shape of the displays 108.4.2, 108.4.4, 108.4.6 may adjust the position of the cameras 108.2.2, 108.2.4, 108.2.6, 108.2.8, 108.2.10, 108.2.12 depending on the available space. Other dimensions of said displays 108.4.2, 108.4.4, 108.4.6 are described in the figures and in the below tables. It should also be understood that additional embodiments or alterations to said display assembly 108.4 will be discussed below and said embodiments may be partially or fully combined with any of the above-described embodiments. The displays disclosed herein may meet the standards described in FDA CFR Title 21 part 1040.10, titled Performance Standards for Light-Emitting Products, and ANSI LIA Z136.1, titled Safe Use of Lasers.

### 3. Antenna Assembly

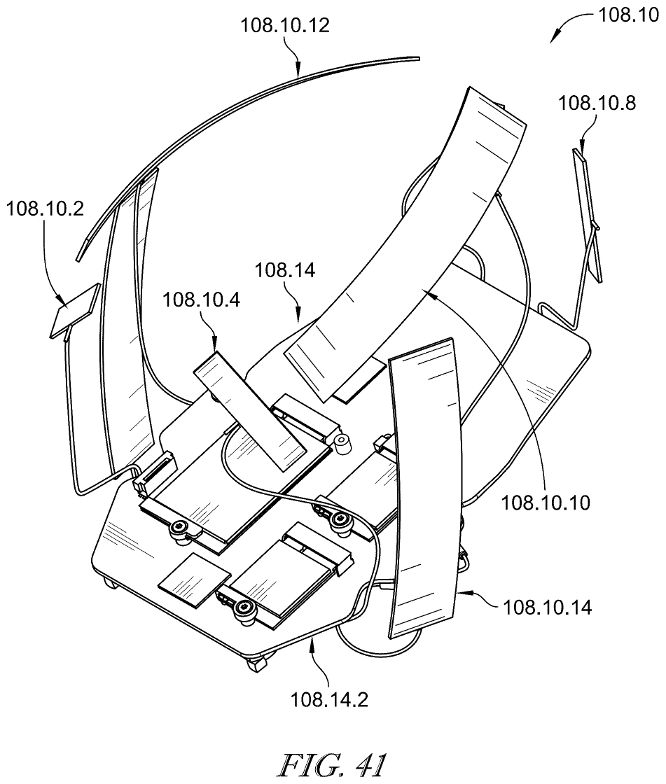

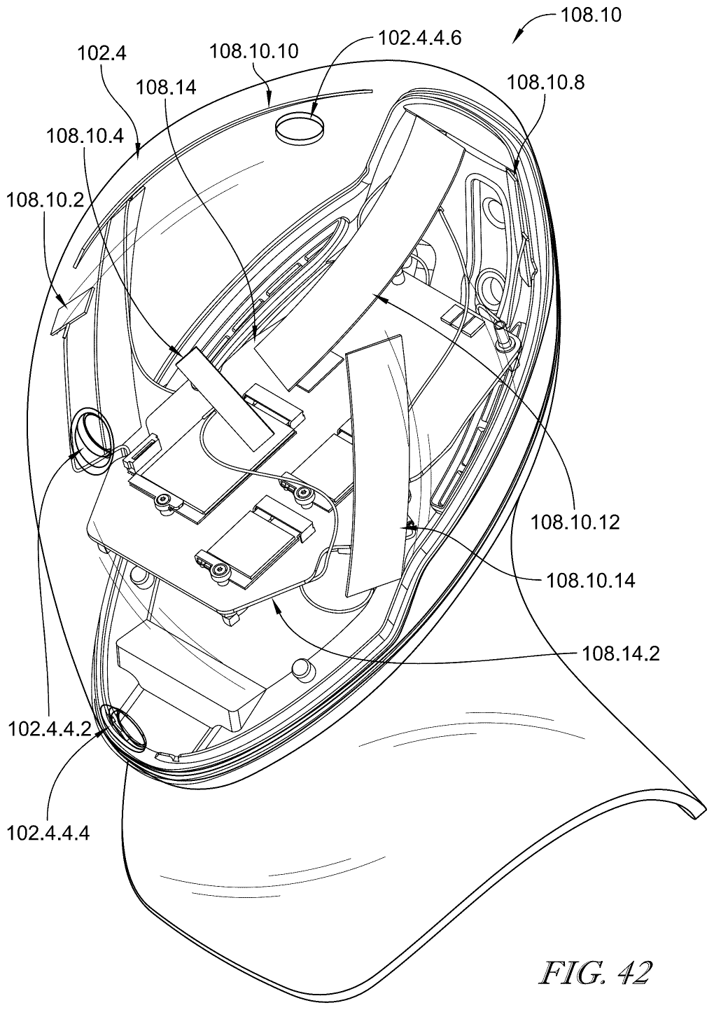

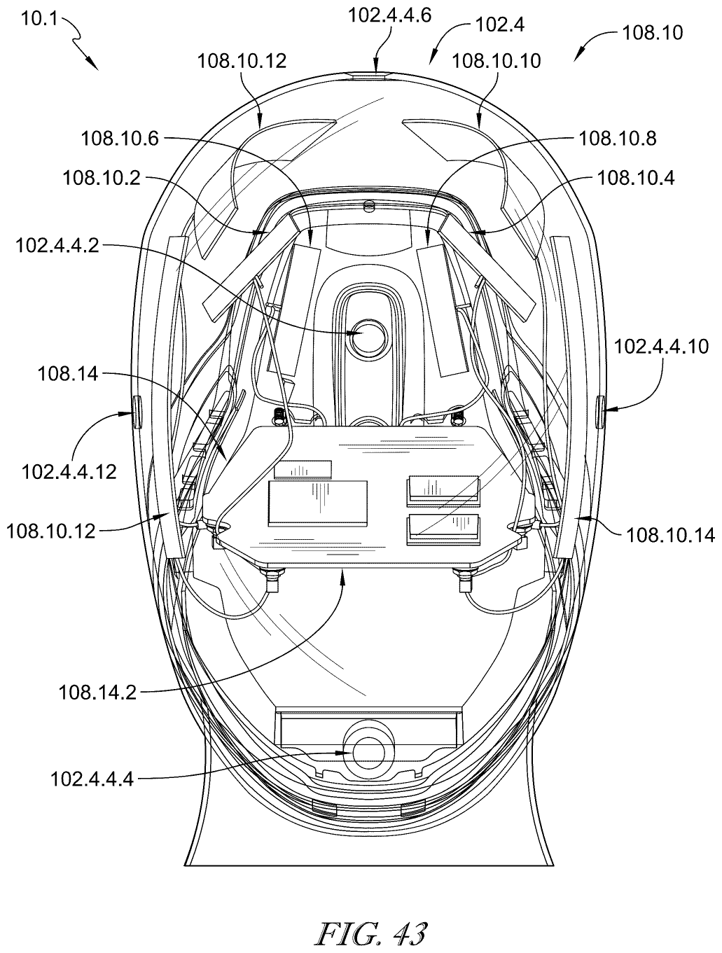

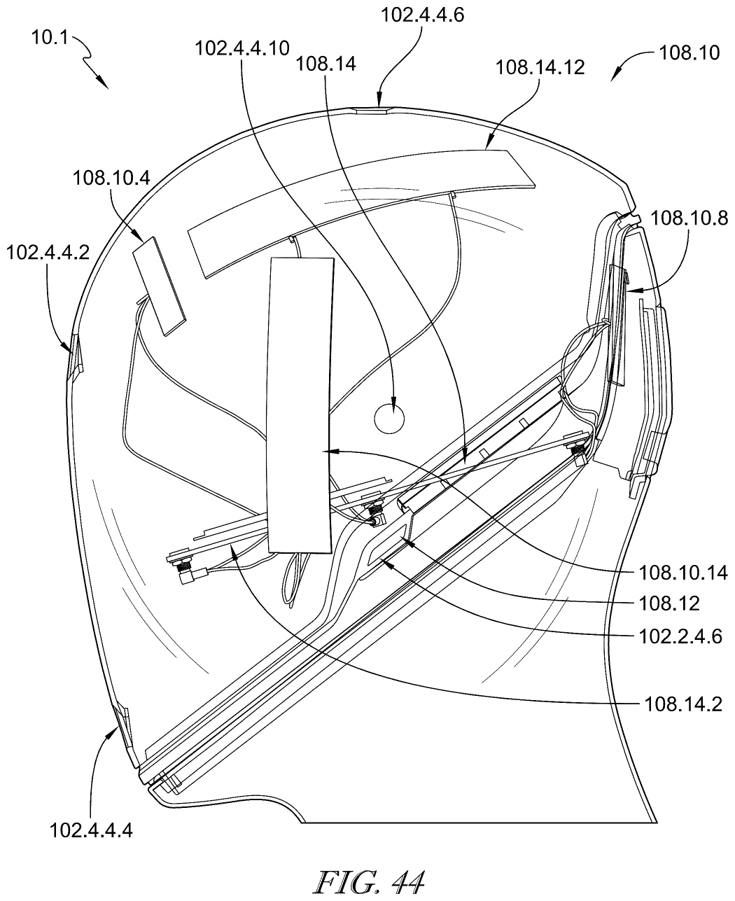

The antenna assembly 108.10 includes antennas configured to transmit and receive data wirelessly for data transfer into and out of the robot as shown in FIGS. 41-44. The robot can also include wireless communication modules (e.g., cellular, Wi-Fi, Bluetooth, WiMAX, HomeRF, Z-Wave, Zigbee, THREAD, RFID, NFC, and/or etc.) that are connected to said antennas. For example, the antenna assembly 108.10 may include a 5G cellular radio coupled to one or more of the antennas 108.10.10, 108.10.12, 108.10.14 and a Wi-Fi radio (e.g., 5 GHz or 2.4 GHz) coupled to the other antennas 108.10.2, 108.10.4, 108.10.6, 108.10.8. As shown in FIGS. 13-17 and 41-44, the antenna assembly 108.10 includes at least one wifi antenna (e.g., wifi antennas 108.10.2, 108.10.4, 108.10.6, 108.10.8) and at least one 5G antenna (e.g., 5G antennas 108.10.10, 108.10.12, 108.10.14) as shown in FIGS. 13-17 and 41-44. In the illustrative embodiment, the antenna assembly 108.10 includes a plurality of wifi antennas 108.10.2, 108.10.4, 108.10.6, 108.10.8 and a plurality of 5G antennas 108.10.10, 108.10.12, 108.10.14 to maximize bandwidth and help ensure connectivity. To save space within the head housing 102, the 5G cellular radios can be positioned in the torso 16 and wired via the neck to the antennas within the head 10.1.

The plurality of Wi-Fi antennas 108.10.2, 108.10.4, 108.10.6, 108.10.8 include two Wi-Fi antennas 108.10.2, 108.10.4 located toward the front of the head portion 10.1, or in the frontal region 10B1, 10B2, and two Wi-Fi antennas 108.10.6, 108.10.8 located toward the rear of the head portion 10.1, or in the parietal region 10A1, 10A2, as shown in FIGS. 13-17 and 41-44. The antennas 108.10.2, 108.10.4, 108.10.6, 108.10.8 may be mounted to the electronics mount 102.2.2 of the housing 102 in some embodiments. Alternatively, the Wi-Fi antennas 108.10.2, 108.10.4, 108.10.6, 108.10.8 may be mounted to the PCB mounting member 104.4 within the housing 102.

The plurality of 5G antennas 108.10.10, 108.10.12, 108.10.14 include different side antennas as shown in FIGS. 13-17 and 41-44. Two antennas 108.10.10, 108.10.12 may be located near the crown region of the head portion 10.1, or the frontal region 10B₁ and the parietal region 10A₁, on opposite sides of the head portion 10.1. One or two 5G antennas 108.10.14 may extend from the top to the bottom of the head portion 10.1 in the temporal region 10C, the zygomatic region 10G, the parotid or parotideomasseteric region 10J, and the buccal region 10K. Two 5G antennas 108.10.14 may be positioned on either end of the front display 108.4.2. The antennas 108.10.10, 108.10.12, 108.10.14 may be mounted to the electronics mount 102.2.2 of the housing 102 in some embodiments. Alternatively, the 5G antennas 108.10.10, 108.10.12, 108.10.14 may be mounted to the PCB mounting member 104.4 within the housing 102.

### 4. Illumination Assembly

The head illumination assembly 1.2.10 includes at least one, and preferably a plurality of light emitters 108.12 located on lateral sides of the head portion 10.1. In certain configurations, the illumination assembly may be designed to visually indicate robot statuses to users viewing the robot 1 from the side. The illumination assembly includes left and right light emitting assemblies 108.12 located in the auricular region 10F of the robot's head portion 10.1. In other embodiments, the light emitting assemblies 108.12 can be located all or partially in a parotid region, an auricular region, a zygomatic region, a parietal region, a frontal region, or a mastoid region so long as the light emitters 108.12 are positioned on a lateral side of the robot's head portion 10.1 so as to be visible to a person standing next to the robot 1. These positions of the light emitting assemblies 108.12 allow users to view the light emitted from said light emitting assemblies 108.12 from the side while the robot 1 is working on a task in an assembly line. Further, the light emitting assemblies 108.12 may face away from the main display 108.4.2 so as not to obstruct the information displayed by the main display 108.4.2 and face away from other sensors so as not to interfere with the sensors. Other regions of the head portion 10.1 where the light emitting assemblies 108.12 are not included are the chin or mental region 10M, orbital region 10D, nasal region 10N, and/or occipital region 10E.

The light emitting assemblies 108.12 in the head portion 10.1 may be configured to display a status of the robot 1, or a part thereof, to users. For example, the light emitting assemblies 108.12 can display a first color (i.e. green) when the robot is engaged in a task, such as assembling a part on an assembly line. The light emitting assemblies 108.12 can display a second color (i.e. yellow) when the robot 1 is not assigned to a task to indicate to users that the robot 1 is available for a task. The light emitting assemblies 108.12 can display a third color (i.e. red) when the robot 1 is low on battery life and should be recharged. The light emitting assemblies 108.12 and/or the main display 108.4.2 can also be used to indicate when a component in the head portion 10.1 and/or neck portion 10.2, such as an actuator, is malfunctioning and should be serviced.

The light emitting assemblies 108.12 can also include one or more display sequences in which the light emitting assemblies 108.12 are turned off and on, or the light emitted from said light emitting assemblies 108.12 is modulated in a pattern or sequence to indicate various statuses. For example, the light emitting assemblies 108.12 can blink repeatedly to indicate that the robot 1 has lost communication with a host server or external device or is attempting to pair or searching for a device or server to connect to. The light emitting assemblies 108.12 may coordinate their display with the information displayed on the main display 108.4.2. For example, the light emitting assemblies 108.12 can display a particular color that corresponds with the information displayed on the main display 108.4.2. If the robot 1 is running low on battery life, the light emitting assemblies 108.12 can display a red color while the display displays a message and/or icon that indicates that the battery is low. The light emitting assemblies 108.12 can also be synced with other devices included in the robot 1 as well. For example, the light emitting assemblies 108.12 can be operated with a speaker and may change colors or blink as the robot 1 outputs an audible message.

Each of the light emitting assemblies 108.12 in the head portion 10.1 includes: (i) a light source or light emitter, and (ii) a diffuser lens covering the light source. The light source and the diffuser lens form a unit that is inserted together into a light housing positioned within the lateral space that includes a “V-shaped” recess formed in the support frame 102.2.4. The light source or emitter can include any known light emitter, including any one or more of the following: laser, LCD, LED, e.g., COB LED, OLED, LPD, IMOD, QDLED, mLED, AMOLED, SED, FED, plasma, electronic paper or EPD, MicroLED, quantum dot display, LED backlit LCD, WLCD, OLCD, transparent OLED, PMOLED, capacitive touchdisplay, resistive touchdisplay, monochrome, color, or any combination of the above, or any other known technology or light feature. It should be understood that in other embodiments, the above disclosed light sources or emitters and/or additional light emitters may be formed in any desirable configuration or used with any other material, structure, or component to form the desirable light emitting assemblies 108.12. Examples of said light emitting assemblies 108.12 that may be formed include fiber optic cables, electroluminescent (EL) wire, laser diodes, neon tubes, cold cathode fluorescent lamps (CCFL), plasma tubes, phosphorescent strips, UV LED strips, infrared LED arrays, light guide panels (LGP), and edge-lit light panels.

The light source or light emitter may be made from a single emitter or a plurality of emitters (e.g., between 2 and 1000). Said light source or light emitter may be driven by an internal or external driver within another aspect of the electronics assembly. Each of the light emitters is positioned in an inner portion of each of the lateral spaces formed in the support frame 102.2.4, while the diffuser lens is positioned in front of the light emitter to reside between a frontal extent of the light emitter and an outermost edge of the support frame 102.2.4 and/or an outermost edge or surface of the head portion 10.1 or shield 102.4. In some embodiments, the diffuser lens can be omitted from the assemblies 108.12.

### 5. Other Electronics Components

As described above, the electronic components of the head may also include a data storage device and/or computing device comprising a processor and memory, and a printed circuit board assembly (PCBA) 108.14 for connecting said electronics. The data storage device may be a removable memory device or integrated in a computing device comprising a processor and a memory. In some examples, the data storage device may be housed in another portion of the robot 1, such as the torso 16. In some examples, the data storage device may be configured to store data collected from other components of the robot 1. The PCBA 108.14 connects the other electronic components in communication with each other. The PCBA may include (i) a printed circuit board 108.14.2, (ii) a Wi-Fi radio coupled to one or more of the antennas 108.10.2, 108.10.4, 108.10.6, 108.10.8 of the antenna assembly 108.10, (iii) a 5G cellular radio coupled to one or more of the antennas 108.10.10, 108.10.12, 108.10.14 of the antenna assembly 108.10, (iv) a sensor interface 108.14.4 for the sensor assembly 108.2, and (v) a display interface 108.14.6 for the display assembly 108.4 as shown in FIGS. 13-17, 34, and 41.

b. Neck Portion

As shown in at least FIGS. 6-11, 17, and 18, the neck portion 10.2 includes: (i) an upper securement member 102.2.6, (ii) a lower securement member 102.6, and (iii) a deformable cover or member 102.8 that is coupled to the upper and lower securement members 102.2.6, 102.6. The lower securement member 102.6 can be formed separate from or integrally with the torso 16, while the upper securement member 102.2.6 can be formed separate from or integrally with the head housing 102.

i. Upper Securement Member

The upper securement member 102.2.6 couples over the support frame 102.2.4 as shown in FIG. 19. The upper securement member 102.2.6 is shaped to complete a form that resembles a head and to mate with the lower edges of the electronics mount 102.2.2 and the support frame 102.2.4 to enclose a substantial portion of the electronics assembly 108. The upper securement member 102.2.6 includes a central opening 102.2.6.2 for the actuator J8.2 and an aperture 102.2.6.4 that aligns with the opening 102.2.4.4.2 in the support frame 102.2.4 for the rear camera 108.2.8 as shown in FIG. 9. The actuator J8.2 extends through the central opening 102.2.6.2 in the bottom cover 102.2.6. The aperture 102.2.6.4 is configured to align with the sensor opening 102.2.4.4.2 formed in the support frame 102.2.4 so that the lens of the support frame 102.2.4 is unobstructed. Thereby reducing potential distortion of the images captured by the camera 102.2.8, which reduces processing requirements, battery usage, and generation of heat.

ii. Lower Securement Member

The lower securement member 102.6 is coupled to an upper part of the torso 16 and includes an aperture formed therein to receive a speaker. The deformable cover or member 102.8 is configured to wrap around at least an edge portion of the housing 102 and particularly the support frame 102.2.4. In doing so, the deformable cover 102.8 obscures the actuators and other electronics contained in the neck. The neck cover 102.8 may be made from a material (e.g., fabric or deformable plastic) that allows the head to twist in both directions and pitch forward and back without bunching or pulling. It is designed to return to its original state when the head returns to its normal state. For example, said materials may include silicone rubber, thermoplastic elastomers (TPE), polyurethane elastomers, neoprene (polychloroprene), latex rubber, liquid silicone rubber (LSR), elastic fabrics (spandex, lycra), EPDM rubber, nitrile rubber (NBR), polyvinyl chloride (PVC) plastisols, thermoplastic polyurethane (TPU), foamed elastomers, hydrogels, fabric-reinforced elastomers, shape memory polymers, or elastomeric polyesters.

c. Manufacturing of Head and Neck Assembly

The manufacturing process for the humanoid robot's head begins with high-precision injection molding to create the core structural components, including the electronics mount, side members, and chin, typically using durable materials like polycarbonate. An acrylic front shell is then formed and securely bonded to this primary structure through an overmolding process, which is followed by an automated, robotic polishing procedure to achieve a high-quality, optical-grade finish. To enhance durability and functionality, this polished shell can receive various optional optical coatings, such as anti-reflective, scratch-resistant, or hydrophobic layers. Concurrently, the chin member is integrated with a flexible rear mounting projection via a separate overmolding process using a thermoplastic elastomer, a design that ensures a seamless interface with the neck fabric and facilitates natural, unrestricted head movement.

i. Manufacturing of the Electronics Mount

The electronics mount and side members of the humanoid robot head are manufactured using a high-precision injection molding process to ensure structural integrity, dimensional accuracy, and scalability. The mold cavity is first cleaned to remove any contaminants that may affect material flow or final part quality. Cleaning methods can include ultrasonic cleaning, solvent-based degreasing, or plasma treatment for improved material adhesion. A mold release agent is applied to aid in the easy removal of the part after formation, ensuring a smooth ejection process without defects. Once prepared, the mold is securely closed and heated to a controlled operating temperature ranging between 80-120° C. to facilitate uniform material flow and controlled cooling. Temperature control systems, such as conformal cooling channels or heat exchangers, may be integrated into the mold to optimize cycle time and reduce internal stresses. In some cases, high thermal conductivity mold alloys or graphite-based coatings may be applied to improve heat dissipation and further enhance cycle efficiency.

Polycarbonate resin pellets, optionally combined with colorant additives or reinforcing fillers such as glass fibers, carbon nanotubes, or aramid fibers, are introduced into the injection unit, where they are heated to a molten state at 280-320° C. The molten material is then injected into the mold cavity under high pressure (70-140 MPa) to ensure the formation of intricate geometries, structural ribs, and attachment features. The mold remains closed while the component cools and solidifies over a period of 30-60 seconds, allowing for stress relief and dimensional stability. To further optimize the cooling process, vacuum-assisted molding, gas-assisted injection molding, or rapid heat cycle molding (RHCM) can be employed, reducing cycle time, improving surface finish, and preventing shrinkage. Once sufficiently solidified, the mold is opened, and the formed electronics mount and side members are ejected using mechanical ejector pins or air-assisted ejection systems. To minimize defects, soft-touch ejection methods, such as pneumatic-assisted ejection or servo-controlled ejector systems, may be employed. Any excess material or flash is trimmed, and the parts undergo a thorough quality inspection using coordinate measuring machines (CMMs), optical scanning, X-ray analysis, or laser profilometry for detecting internal voids, surface anomalies, or structural weaknesses.

The components may be made from polycarbonate resin because of its high impact resistance, structural durability, and thermal stability. Alternative thermoplastics such as Trivex (offering superior optical clarity and impact resistance), high-impact polystyrene (HIPS) (a cost-effective option with moderate mechanical properties), or liquid crystal polymer (LCP) (for applications with high heat resistance and minimal warpage) may also be used depending on the specific application. In some embodiments, multi-material injection molding can be utilized to incorporate elastomeric inserts for vibration damping, thermally conductive polymers for improved heat dissipation, or conductive polymer layers to enable electromagnetic interference (EMI) shielding. Additionally, surface texturing can be applied directly within the mold using laser-etched mold cavities or nanoimprint lithography, allowing for microstructural modifications to enhance grip, reduce glare, improve wear resistance, or create functional surface properties such as hydrophobicity or self-cleaning behavior. In alternative embodiments, overmolded hybrid materials, such as polymer-metal composites, may be employed to create lightweight but structurally reinforced components.

The injection molding process for the humanoid robot head components may be further refined and optimized through advanced mold design methodologies and precision material handling systems. To substantially enhance structural integrity and minimize cycle times, conformal cooling channels are strategically integrated into the mold design. These conformal channels precisely trace the contours and intricacies of the part geometry, ensuring uniform, efficient heat transfer during the cooling phase, reducing thermal gradients and residual stress concentrations. Advanced fiber reinforcement strategies may enhance the mechanical properties of molded components. Short glass or carbon fibers are meticulously compounded with polycarbonate resin or alternative high-performance thermoplastics, forming a robust fiber-reinforced polymer (FRP) composite. Fiber orientation is precisely controlled during the injection molding process through specialized gate designs and computational flow analysis software, optimizing directional mechanical properties within the final molded structures. Additionally, hybrid fiber systems combining short and continuous fibers can be employed to deliver targeted structural reinforcement in various stress regions.

The mold design incorporates conformal cooling channels that precisely follow the part's geometry, enabling uniform and efficient heat transfer during the cooling phase. These conformal channels are fabricated through additive manufacturing techniques such as laser powder bed fusion (LPBF) or selective laser melting (SLM), which facilitate the creation of intricate internal channel geometries that conventional methods cannot achieve. Predictive simulation tools, such as Autodesk Moldflow and Moldex3D, are extensively utilized to model parameters, including shrinkage behavior, thermal gradients, cooling rates, and fiber orientation. These tools enable iterative mold design improvements, reducing the number of physical prototypes and accelerating development timelines.

Advanced surface treatment processes, including in-mold decoration (IMD) and in-mold labeling (IML), integrate graphics, texturing, and protective films directly into the molding process, enhancing durability, wear resistance, and aesthetic quality. Furthermore, biomimetic surface texturing techniques inspired by natural microstructures, such as lotus leaf surfaces for self-cleaning or shark skin textures for drag reduction, are incorporated into mold surfaces, imparting functional benefits to molded parts. Production efficiency is enhanced through multi-cavity mold designs, facilitating simultaneous production of multiple components within each injection cycle. Computationally optimized cavity layouts ensure balanced material flow, consistent thermal management, and uniform component quality across all cavities. Additionally, modular mold designs featuring interchangeable inserts or cores allow rapid adjustments to part geometries or surface features without extensive mold reconfiguration.

Post-molding operations are streamlined using fully automated robotic handling and trimming systems integrated with the injection molding machines, establishing an automated production cell that minimizes manual intervention and maximizes throughput efficiency. Robotic trimming stations utilize high-precision CNC or laser trimming methods for accurate, repeatable finishing. Additional refinements include adaptive rheological optimization techniques, micro-cellular foaming methods like MuCell technology for weight reduction and enhanced dimensional stability, hybrid molding strategies combining multiple materials or additive manufacturing inserts, and electromagnetic field-assisted fiber alignment to enhance targeted structural properties. Localized reinforcement injection systems selectively introduce high-strength fibers or nanoparticles into various regions, further customizing mechanical performance.

Advanced adaptive process control systems employing real-time sensors and machine learning algorithms continuously monitor and adjust injection parameters, such as temperature, pressure, and flow rate, to adaptively optimize part quality. Embedded sensors, including pressure transducers and thermocouples within mold cavities, provide immediate feedback for precise process adjustments, facilitating predictive and adaptive quality control. Energy efficiency improvements include integrating regenerative braking systems on injection units, capturing kinetic energy during deceleration phases for reuse, and waste heat recovery systems to preheat materials or maintain consistent mold temperatures, reducing overall energy consumption.

ii. Overmolding of the Front Shell onto the Internal Components

Once the electronics mount and side members of the humanoid robot are fabricated, an overmolding process is employed to form and integrate the front shell as a secondary component. This process ensures a strong bond between the front shell and the primary structure while maintaining optical clarity and mechanical resilience. The pre-molded electronics mount is precisely positioned within the overmolding tool, ensuring proper alignment to accommodate uniform material flow. The mold is then closed and heated to a temperature range of 40-100° C. to optimize adhesion between the injected front shell material and the base structure. In some embodiments, pre-heating the electronics mount surface or applying a plasma treatment may be used to enhance molecular bonding between the base and overmolded layers. Additional adhesion-enhancing methods may include chemical priming of the electronics mount surface using adhesion promoters or the application of UV-activated bonding agents that create covalent bonds between the electronics mount and front shell materials.

Acrylic resin pellets, optionally combined with UV stabilizers, anti-scratch agents, and optical additives, are melted in the injection unit at a controlled temperature of 200-300° C. The molten acrylic is injected into the mold cavity under 50-100 MPa of pressure to form the front shell shape, ensuring full material encapsulation and secure attachment to the electronics mount. In certain implementations, sequential or multi-shot overmolding may be employed, allowing for the deposition of multiple material layers in a single cycle to create a front shell with varying optical and mechanical properties. Advanced process variations, such as insert molding, may be used to embed transparent conductive films or reinforcement grids within the front shell for additional functionality, such as anti-static properties or integrated heads-up displays (HUDs). The mold remains closed while the acrylic cools and bonds with the polycarbonate base over a period of 45-90 seconds. Gas-assist and water-assist injection molding techniques may also be employed to create complex internal structures, allowing for the integration of cooling channels, weight reduction features, or embedded microelectronics.

The molding process can be refined by utilizing variothermal molding, where the mold temperature is dynamically controlled throughout the cycle. This method enhances flow characteristics, reduces residual stresses, and improves the surface finish by minimizing weld lines and optical distortions. Additionally, microcellular foam injection molding (MuCell) can be utilized to create a lightweight, high-strength front shell by introducing inert gas into the molten polymer before injection, resulting in a uniform microcellular structure that enhances impact resistance while reducing material consumption. Compression overmolding, which combines injection molding with compression molding, can further enhance uniform material distribution, minimize internal stresses, and improve the structural integrity of the final front shell component.

The selection of front shell materials can be adjusted to suit different application needs. In addition to acrylic, polycarbonate-based composites can be used for added impact resistance. In certain embodiments, thermoplastic polyurethane (TPU) or cyclic olefin copolymers (COC) may be incorporated to provide flexibility and enhanced optical clarity. Additional material choices may include siloxane-based hybrid polymers for increased thermal and chemical resistance or high-refractive-index polymers for optimized optical performance in augmented reality (AR) applications. Furthermore, multi-layer laminated front shells incorporating photochromic or electrochromic layers can be used to enable adaptive light transmission properties, further expanding the functional capabilities of the humanoid robot head. Additionally, advanced bonding agents or nanostructured adhesion promoters may be introduced at the interface between the electronics mount and the front shell, improving durability, preventing delamination, and enhancing resistance to environmental exposure, such as UV degradation or thermal cycling. In some cases, self-healing polymer coatings can be applied post-molding to enhance the longevity of the front shell surface, reducing the impact of minor scratches and abrasions over time.

To further enhance functionality, multi-material co-injection molding can be used to simultaneously inject two or more compatible polymers, creating a front shell with a gradient of properties such as a soft, impact-absorbing inner layer transitioning to a hard, scratch-resistant outer layer. The bond strength between the front shell and the electronics mount structure can also be improved using interpenetrating polymer networks (IPNs), which allow for molecular-level entanglement of the overmolded material with the base polymer, reducing the risk of delamination.

The overmolding process can also incorporate advanced optical elements, such as micro-lens arrays or waveguide structures, which can be directly molded into the front shell using precision-engineered mold inserts. These elements can enhance light transmission, reduce glare, or provide embedded display functionalities. Additionally, plasma-enhanced chemical vapor deposition (PECVD) can be applied immediately post-molding to create ultra-thin, conformal barrier coatings that improve chemical resistance, moisture ingress protection, and abrasion resistance without compromising optical clarity.

The front shell's mechanical and thermal properties can be further enhanced by embedding phase-change material (PCM) microcapsules within the polymer matrix, providing passive thermal regulation. These PCMs absorb excess heat during high-intensity operations and release it when temperatures drop, ensuring stable performance in varying environmental conditions. Additionally, incorporating self-healing mechanisms, such as microencapsulated healing agents or reversible cross-linking polymers, can extend the lifespan of the front shell by allowing minor scratches or cracks to autonomously repair over time.

Another refinement includes the integration of transparent conductive pathways using materials such as graphene or indium tin oxide (ITO). These pathways enable additional functionalities such as integrated touch-sensitive interfaces, defogging capabilities, or transparent antenna structures for improved communication. Further improvements in manufacturing precision can be achieved through the use of machine learning algorithms that optimize molding parameters in real time, ensuring defect-free production and enhanced quality control.

By integrating these cutting-edge technologies, the humanoid robot front shell transitions from a protective covering to an intelligent, adaptive interface capable of advanced sensing, computing, and environmental interaction. These innovations enhance the robot's cognitive and sensory abilities, enabling unparalleled adaptability across diverse applications, from extreme environments to high-precision tasks with real-time responsiveness and advanced perception.

iii. Polishing the Front Shell

The front shell polishing process utilizes robotic systems to achieve a high-quality optical finish on the overmolded front shell component. This automated approach ensures consistency and precision across large production volumes and minimizes defects associated with manual polishing techniques. The polishing process begins with the front shell being securely held in a custom-designed fixture that provides unrestricted access to all surfaces for treatment. The fixture may incorporate vacuum suction, magnetic retention, or mechanical clamping mechanisms to ensure stability without causing deformation or surface damage. In some embodiments, the fixture is mounted on a rotational stage to facilitate multi-angle access during polishing operations.

A multi-axis robotic arm equipped with a specialized end effector is employed to manipulate polishing tools. The end effector may include force feedback sensors to maintain consistent pressure and compensate for variations in front shell geometry. Additionally, compliance control mechanisms, such as pneumatically actuated or actively controlled tool mounts, may be integrated to accommodate slight surface variations. In alternative configurations, dual robotic arms may operate in synchrony to perform simultaneous polishing on multiple surfaces, increasing throughput and reducing cycle times.

Polishing compounds are dispensed precisely onto the pads using automated dosing systems. In certain implementations, the polishing pads are continuously cleaned and conditioned via integrated pad maintenance stations that employ ultrasonic cleaning, solvent rinsing, or mechanical scrubbing to maintain consistent performance. Environmental controls such as temperature and humidity regulation may be integrated into the polishing chamber to enhance process stability and prevent contamination. Dust and debris generated during polishing are managed using high-efficiency particulate air (HEPA) filtration and localized extraction systems to maintain a clean working environment.

Following the final polishing stage, the front shell undergoes an automated cleaning process to remove residual polishing compounds. This may involve immersion in ultrasonic cleaning baths, high-pressure air or liquid rinsing, or the application of specialized solvent-based cleaning agents designed to preserve the newly polished optical surface without introducing artifacts. Quality control measures are implemented using high-resolution optical inspection systems equipped with machine learning-based defect detection algorithms. These systems analyze images to identify surface inconsistencies, scratches, or other imperfections. In some configurations, profilometry or atomic force microscopy (AFM) techniques may be employed to quantitatively assess surface roughness and ensure compliance with stringent optical quality standards.

The entire polishing process is governed by an integrated control system that coordinates robotic arm movements, material dispensing, and process monitoring. This system utilizes closed-loop feedback control to adaptively refine polishing parameters based on real-time sensor data. In some embodiments, process analytics and predictive maintenance algorithms are employed to detect equipment wear, optimize consumable usage, and enhance overall efficiency. This automated front shell polishing system is designed to be scalable for high-volume manufacturing while maintaining the flexibility to accommodate variations in front shell geometry, material composition, and surface treatment. By leveraging robotic automation, real-time process monitoring, and advanced quality control methodologies, the system ensures consistent, defect-free production of optical-grade front shells across a range of applications.

iv. Application of Optional Optical Coatings

To further enhance the performance and longevity of the front shell, a variety of optical coatings may be applied post-overmolding. These coatings can be deposited using vacuum deposition techniques, dip coating, spray coating, or plasma-enhanced chemical vapor deposition (PECVD) to ensure uniform surface application and optimal adhesion. In some cases, coatings may be pre-integrated into the acrylic resin before injection molding to achieve consistent performance across the entire front shell surface.
Common optical coatings include:
   Anti-Reflective (AR) Coating: Applied to the inner and/or outer surfaces to minimize glare and improve visibility of internal displays. This is achieved through the deposition of thin-film dielectric layers, which reduce surface reflectivity.
   Scratch-Resistant Hard Coating: Enhances surface durability, protecting against abrasions and external wear. This coating is often applied via dip coating followed by UV or thermal curing to form a robust protective layer.
   Hydrophobic and Oleophobic Coatings: Provides water and oil repellency, reducing smudging and facilitating easier cleaning. These coatings, typically based on fluoropolymer compounds, create a non-stick surface that resists contamination and fingerprint accumulation.
   Anti-Fog Coating: Prevents moisture condensation on the front shell surface by modifying surface tension, ensuring clarity in high-humidity environments. This coating is commonly applied via spray deposition followed by thermal curing.
   UV-Blocking Coating: Reduces ultraviolet light penetration, protecting internal components and extending the lifespan of the front shell material. UV-resistant polymers can be incorporated into the acrylic before molding, or a post-mold UV coating can be applied using vacuum deposition methods.

The selection of coatings is optimized based on manufacturing efficiency, durability, and optical performance. By integrating these coatings, the front shell can maintain high clarity and remain resistant to environmental factors such as dust, scratches, and moisture accumulation. The method of application is determined based on adhesion strength, cost-effectiveness, and operational durability. Examples of such optical coatings include anti-reflection coatings, mirror coatings, hard coatings, anti-static coatings, and anti-fog coatings, some of which are described within U.S. patent application Ser. Nos. 16/896,016, 16/698,775, 16/417,311, 16/126,983, 15/359,317, 15/515,966, and U.S. Pat. Nos. 8,770,749; 9,134,547, 9,383,594; 9,575,335; 9,910,297, each of which are incorporated herein by reference. Further, the material composition, shape, number of layers, and composition of said layers of the shield 102.4 contained in one region of said shield 102.4 may be different from the material composition, shape, number of layers, and composition of the shield 102.4 contained in another region. In other words, the composition, shape, number of layers, and composition of said layers may vary across the surface of the shield 102.4.

v. Manufacturing a Support Frame

The chin member of the humanoid robot head is manufactured using an injection molding process similar to that used for the electronics mount and side members. The mold cavity for the chin member is designed to incorporate specific features that facilitate integration with other head components and allow for natural movement. The injection molding process for the chin member utilizes a high-performance thermoplastic polymer, such as glass-fiber reinforced polyamide or polycarbonate, to ensure structural integrity and impact resistance.

Prior to injection, the mold cavity is thoroughly cleaned and treated with a release agent to facilitate easy part removal. The mold is then heated to an optimal temperature range of 80-120° C. to ensure uniform material flow and controlled cooling. The polymer resin, potentially combined with additives for enhanced mechanical properties or color matching, is melted in the injection unit at temperatures ranging from 260-300° C. The molten material is injected into the mold cavity under high pressure (70-120 MPa) to form the intricate geometries and attachment features of the chin member.

The mold remains closed for a cooling period of 30-60 seconds, allowing the chin member to solidify and achieve dimensional stability. Once cooled, the part is ejected using a combination of mechanical ejector pins and air-assisted ejection systems to minimize the risk of deformation or surface defects. Any excess material or flash is carefully trimmed, and the chin member undergoes quality inspection using coordinate measuring machines (CMMs) or optical scanning systems to verify dimensional accuracy and surface quality.

The rear mounting projection, which serves as an interface between the head and the neck fabric, is produced through an overmolding process. This process begins with the positioning of the pre-molded chin member within a secondary mold cavity. The mold is designed to create a seamless integration between the chin member and the rear mounting projection while providing the features for attaching the neck fabric.

A thermoplastic elastomer (TPE) or a flexible polyurethane is typically used for the rear mounting projection to provide the desired combination of strength and flexibility. The overmolding material is heated to its melting point (typically 180-240° C., depending on the specific polymer used) and injected into the mold cavity under controlled pressure (40-80 MPa). This process ensures a strong bond between the chin member and the rear mounting projection while maintaining the flexibility for head movement.

The rear mounting projection is designed with a gradual transition from the rigid chin member to a more flexible outer edge. This design allows for a smooth interface with the deformable neck cover, enabling natural head movements without causing bunching or restriction of the fabric. In some cases, the rear mounting projection may incorporate multiple durometer zones, achieved through multi-shot overmolding or the use of gradient materials. This approach creates areas of varying flexibility within the projection, optimizing the balance between structural support and freedom of movement.

The overmolded rear mounting projection undergoes a controlled cooling process within the mold, typically lasting 45-90 seconds, to ensure proper bonding with the chin member and to achieve the desired mechanical properties. Once cooled, the assembled chin member with integrated rear mounting projection is carefully removed from the mold and inspected for quality. Quality control measures for the rear mounting projection include visual inspection for any molding defects, tactile evaluation of the surface texture and flexibility, and mechanical testing to ensure proper bonding between the chin member and the overmolded material. In some cases, non-destructive testing methods such as ultrasonic inspection or X-ray analysis may be employed to verify the internal structure and bonding integrity of the overmolded components.

The design of the rear mounting projection, in conjunction with the deformable neck cover, allows for a wide range of head movements without causing bunching or restriction of the fabric. The flexible nature of the overmolded material enables it to deform and flex in response to head rotations and tilting motions. This flexibility, combined with the strategic placement of attachment points and the gradual transition in material properties, ensures that the neck fabric maintains a smooth appearance and unrestricted movement during operation of the humanoid robot.

The combination of the injection-molded chin member and the overmolded rear mounting projection creates a robust and flexible interface between the head and neck regions of the humanoid robot. This design approach enables natural head movements while providing a secure and adaptable attachment point for the deformable neck cover, contributing to the overall functionality and aesthetic appeal of the robot's head assembly.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| | | | Actuator | Informal Actuator | |
|---|---|---|---|---|---|
| Actuator | | Qty | Name | Name(s) | Axis |
| (J1) | 190 | 2 | arm | primary arm | A₁ |
| (J2) | 280 | 2 | shoulder | (none) | A₂ |
| (J3) | 320 | 2 | upper arm twist | upper arm x, upper | A₃ |
| | | | | arm roll | |
| (J4) | 374 | 2 | elbow | arm z, arm yaw, | A₄ |
| | | | | lower humerus | |
| (J5) | 468 | 2 | lower arm twist | lower arm x, lower | A₅ |
| | | | | arm roll | |
| (J6) | 484 | 2 | wrist flex | wrist/hand y, wrist/hand | A₆ |
| | | | | pitch, flick | |
| (J7) | 520 | 2 | wrist pivot | wrist/hand z, wrist/hand | A₇ |
| | | | | yaw, wave | |
| (J8.1) | 120 | 1 | head twist | head no | A_{8.1} |
| (J8.2) | 140 | 1 | head nod | head yes | A_{8.2} |
| (J9) | 680 | 1 | torso lean | spine x, torso/spine | A₉ |
| | | | | roll | |
| (J10) | 620 | 1 | torso twist | spine z, torso/spine | A₁₀ |
| | | | | yaw | |
| (J11) | 720 | 2 | hip flex | hip y, hip/leg pitch, | A₁₁ |
| | | | | forward kick | |
| (J12) | 768 | 2 | hip roll | hip x, hip/leg roll, | A₁₂ |
| | | | | sideways kick | |
| (J13) | 782 | 2 | leg twist | hip z, hip/leg yaw | A₁₃ |
| (J14) | 820 | 2 | knee | lower thigh, lower | A₁₄ |
| | | | | leg y, | |
| | | | | lower leg pitch, rear | |
| | | | | kick | |
| (J15) | 860 | 2 | foot flex | foot y, foot pitch, | A₁₅ |
| | | | | or first ankle | |
| (J16) | 900 | 2 | foot roll | talus, foot roll, foot | A₁₆ |
| | | | | x, second ankle | |

It should be understood that in other embodiments, some of these systems, assemblies, components, and/or parts may be omitted, combined, or replaced with alternative systems, assemblies, components, and/or parts. The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.
ii. Cover System

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The characteristics of the housings 1.2.2 can vary in shape and form based on the individual structural or material specifications for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load conditions. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the cover system 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D30®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and an end effector cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior covering materials of the cover system 1.2.16 can be made from one or more textiles and can be customized or selected to reduce wrinkling and to allow for the twisting or movement of the underlying components without restriction or substantial distortion. For example, the exterior covering materials may be designed to allow the lower arm to twist and rotate from about-120 degrees to about 180 degrees. Additionally, the exterior covering materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior covering materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior covering material can include reflective yarn or night-luminous yarn that changes its appearance when light is shining on its surface. In other embodiments, a shiny, reflective, iridescent, matte, or textured polyurethane film can be applied to the surface of the exterior covering material (e.g., a textile) in certain areas to provide an additional reflective effect or for another purpose, such as displaying a logo, pattern, or labels.

The exterior covering material can also include features to accommodate the thermal considerations of the robot 1. In various examples, the exterior covering material can be a custom textile that utilizes different weaves in different locations to allow for ventilation in specific areas. Additionally, the exterior coverings material can include textiles or threads that are heat-sensitive and change color with a change in temperature. In summary, the exterior covering may additionally be made from, include, or specifically omit any one or any combination of the following material types: durable materials, flame-resistant materials, waterproof materials, hazard materials, chemical-resistant materials.

Alternatively or additionally, the cover system 1.2.16 may include features such as closures (e.g., a zipper that runs a partial or full length of the cover system 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The cover system 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

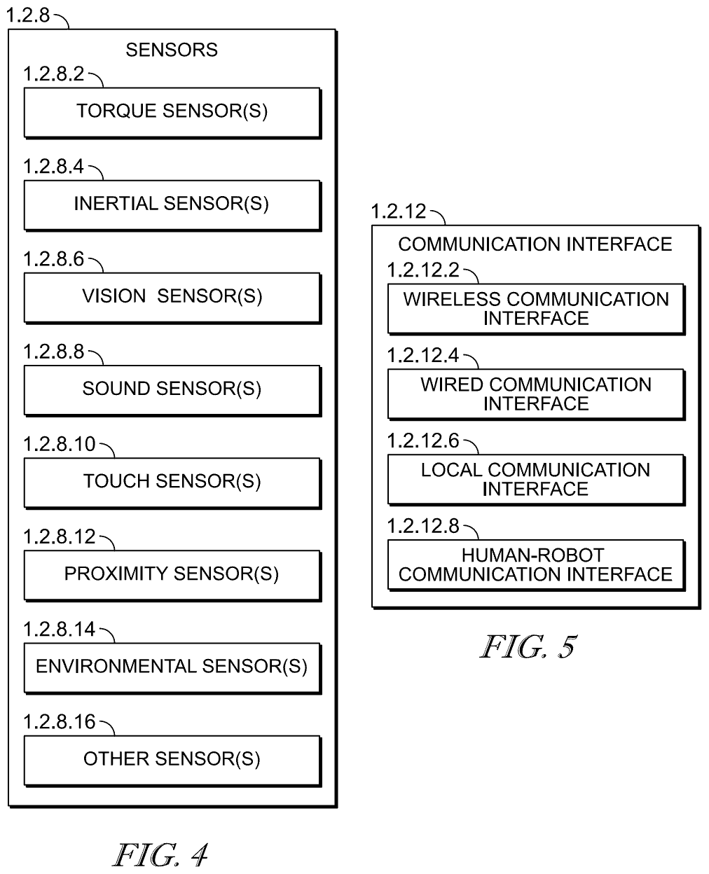

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### E. DISTANCES AND ANGLES

TABLE 2

| | | | Preferred | Preferred |
|---|---|---|---|---|
| Angle | Lower | Upper | Lower | Upper |
| (Degrees) | Bound | Bound | Bound | Bound |
| A5 | 65.408 | 98.112 | 73.584 | 89.936 |
| A6 | 30.088 | 45.132 | 33.849 | 41.371 |
| A7 | 62.136 | 93.204 | 69.903 | 85.437 |
| A8 | 77.016 | 115.524 | 86.643 | 105.897 |
| A9 | 29.072 | 43.608 | 32.706 | 39.974 |
| A10 | 80.568 | 120.852 | 90.639 | 110.781 |
| A11 | 81.848 | 122.772 | 92.079 | 112.541 |
| A12 | 4.48 | 6.72 | 5.04 | 6.16 |
| A13 | 31.4 | 47.1 | 35.325 | 43.175 |
| A14 | 31.52 | 47.28 | 35.46 | 43.34 |

### F. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 18/922,334, 19/000,626, 19/006,191, 19/033,973, 19/038,657, 19/064,596, 19/066,122, 19/180,106, 19/223,945, 19/224,252, 19/249,517, 19/286,240, 19/319,712, 19/324,392, 19/323,751, 19/325,486, 19/325,415, 19/324,342, 19/329,008, 19/329,485, 19/329,559, 19/337,845, 19/337,852, 19/337,899, 19355786, 19/347,690, 19/321,022, 19/321,159, 19/347,994, and 19/351,294; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/026,981; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, 63/841,314 and 63/691,035, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A robot having a transverse plane and a sagittal plane, wherein the robot comprises:
an upper region including: (i) a torso, (ii) a pair of arm assemblies coupled to the torso, wherein each arm assembly includes an end effector, and (iii) a head and neck assembly coupled to the torso and having a neck portion and a head portion coupled to the neck portion, wherein, while the upper region of the robot is in a neutral state and the head portion is in a forward-facing orientation, the head portion includes:
a head housing with a front shell, wherein the front shell includes an outer surface,
a forward-facing display positioned within the head housing behind the front shell,
a first sensor positioned above the display, wherein the first sensor includes: (i) a first extent positioned rearward of the outer surface of the front shell, and (ii) a first lens, and
a second sensor positioned below the display, wherein the second sensor includes: (i) a second extent positioned rearward of the outer surface of the front shell, and (ii) a second lens,
wherein the first lens and the second lens are aligned along the sagittal plane.

2. The robot of the preceding claim, wherein the front shell includes: (i) a first forward-facing aperture aligned with the first lens, and (ii) a second forward-facing aperture aligned with the second lens.

3. The robot of claim 1, wherein the first sensor and the second sensor are not mounted to a common printed circuit board and are not mounted to the front shell.

4. The robot of claim 1, wherein the head portion further includes an electronics frame positioned under the front shell and to which the first sensor and the second sensor are each mounted, wherein the electronics frame is arranged to obscure a majority of the first sensor and the second sensor from external view.

5. The robot of claim 1, wherein the head portion further includes an electronics frame, wherein a portion of the front shell is overmolded onto the electronics frame, and wherein the electronics frame underlies less than an entirety of the front shell.

6. The robot of the preceding claim, wherein at least one sensor of a group consisting of the first sensor and the second sensor is mounted to the electronics frame.

7. The robot of claim 1, wherein the head portion further includes:
an electronics frame to which at least one sensor of a group consisting of the first sensor and the second sensor is mounted, wherein the electronics frame includes a respective front portion and a respective rear portion; and
a lower support frame distinct from the electronics frame and including: (i) a respective front portion, (ii) a respective rear portion, and (iii) an extent forming an external surface of the head portion on a lateral side of the head,
wherein the front portion of the lower support frame is arranged below the front portion of the electronics frame and the rear portion of the lower support frame is arranged below the rear portion of the electronics frame, and wherein the extent of the lower support frame includes a recessed portion.

8. The robot of the preceding claim, wherein the recessed portion includes an indicator light at least partially positioned in an auricular region of the head portion.

9. The robot of claim 1, wherein the head portion further includes: (i) a side sensor on a lateral side of the head portion, and (ii) an indicator light positioned on the lateral side in a recess and below the third sensor.

10. The robot of claim 1, wherein the head portion further includes a top sensor oriented in an upward-facing direction and positioned above the first sensor.

11. The robot of claim 1, wherein the first sensor has a first sensor axis extending through a respective center of the first lens and the second sensor has a second sensor axis extending through a respective center of the second lens, and wherein at least one sensor axis of a group consisting of the first line of sight axis and the second line of sight axis further extends through a surface of the front shell.

12. The robot of claim 1, wherein the front shield includes a first extent comprising an upper portion of the front shield and positioned rearward of a coronal plane of the robot, and wherein the front shield includes a second extent comprising a lateral side portion of the front shield and positioned rearward of the coronal plane of the robot.

13. The robot of claim 1, wherein the head portion further includes a plurality of antennas which are obscured within the head portion from external view.

14. The robot of claim 1, wherein the head portion further includes a plurality of antennas wherein each antenna of the plurality of antennas is not directly coupled to an inner surface of the head housing.

15. The robot of claim 1, wherein the head portion further includes a side-facing display positioned inwards from an adjacent outer surface of the front shell.

16. The robot of claim 1, wherein the head and neck portion includes a speaker.

17. A robot having a transverse plane, a coronal plane, and a sagittal plane, wherein the robot comprises:
an upper region including: (i) a torso, (ii) a pair of arm assemblies coupled to the torso, wherein each arm assembly includes an end effector, and (iii) a head and neck assembly coupled to the torso and having a neck portion and a head portion coupled to the neck portion, wherein, while the upper region of the robot is in a neutral state and the head portion is in a forward-facing orientation, the head portion includes:
a head housing with a front shell wherein the front shell includes an outer surface,
a front display visible from a front viewing position that is along the sagittal plane forward of the robot and at a height corresponding to the front display, wherein the front display is positioned within the head housing and rearward of an extent of the front shell,
a first sensor positioned above the first display and at least partially within the head housing,
a left side display visible from a left-side viewing position that is along the coronal plane leftward of the robot and at a height corresponding to the left side display, wherein the left side display is positioned at least partially within the head housing, and
a right side display visible from a right-side viewing position that is along the coronal plane rightward of the robot and at a height corresponding to the right side display, wherein the right side display is positioned at least partially within the head housing.

18. The robot of the preceding claim, wherein the front display is curvilinear, the left side display is planar, and the right side display is planar.

19. The robot of claim 17, wherein the left side display and the right side display are arranged symmetrically to each other across the sagittal plane and not parallel to the sagittal plane.

20. The robot of claim 17, wherein a majority of the left side display is positioned higher than the front display and a majority of the right side display is positioned higher than the front display.

21. The robot of claim 17, wherein the head portion further includes an electronics frame underlying at least a portion of the front shell and to which the front display and the first sensor are coupled, wherein the left side display and the right side display are not directly coupled to the electronics frame.

22. The robot of claim 17, wherein the head portion further includes:
an electronics frame underlying at least a portion of the front shell and to which the front display and the first sensor are coupled,
a curvilinear antennae mounted to the electronics frame, and
a radio contained within the head portion and communicatively coupled to the curvilinear antennae.

23. The robot of claim 17, wherein the head portion further includes:
an electronics frame underlying at least a portion of the front shell and to which the front display and the first sensor are coupled,
a lower support frame distinct from the electronics frame and including an extent forming an external surface of the head portion, wherein the extent includes an air intake vent, and
a heat management system configured to draw external air through the air intake vent into an interior of the head portion.

24. The robot of claim 17, wherein the head portion further includes an indicator light positioned on the lateral side of the head portion and configured to visually indicate a robot status.

25. The robot of claim 17, wherein the head portion further includes a top sensor oriented in an upward-facing direction and positioned above the first sensor.

26. A robot having a transverse plane and a sagittal plane, wherein the robot comprises:
an upper region including: (i) a torso, (ii) a pair of arm assemblies coupled to the torso, wherein each arm assembly includes an end effector, and (iii) a head and neck assembly coupled to the torso and having a neck portion and a head portion coupled to the neck portion, wherein, while the upper region of the robot is in a neutral state and the head portion is in a forward-facing orientation, the head and neck portion includes:
a front shell that includes a portion with a curvilinear exterior surface,
a first forward-facing sensor including: (i) a respective extent positioned within the head portion, and (ii) a respective sensor axis oriented at a non-zero angle to a first horizontal plane parallel to the transverse plane, and
a rearward-facing sensor including: (i) a respective extent positioned within the head and neck assembly, and (ii) a respective sensor axis oriented at a non-zero angle to a second horizontal plane parallel to the transverse plane,
wherein the respective sensor axis of the first forward-facing sensor extends forward through the curvilinear exterior surface of the front shell portion, and the respective sensor axis of the rearward-facing sensor extends rearward and the rearward extension of the respective sensor axis of the rearward-facing sensor does not extend through the front shell.

27. The robot of the preceding claim, wherein the head and neck portion further includes a second forward-facing sensor including: (i) a respective extent positioned within the head portion, and (ii) a respective sensor axis oriented at a non-zero angle to a third horizontal plane parallel to the transverse plane, wherein the respective sensor axis of the first forward-facing sensor extends forward and downward and the respective sensor axis of the second forward-facing sensor extends forward and downward.

28. The robot of claim 26, wherein the rearward-facing sensor is identical to the forward-facing sensor.

29. The robot of claim 26, wherein the head and neck portion further includes a top sensor oriented in an upward-facing direction and positioned above the first forward-facing sensor.
